(19) United States
(12) Patent Application Publication
(10) Pub. No.: US 2026/0349222 A1
(43) Pub. Date: Nov. 5, 2026

(54) OPTICAL SYSTEM AND CAMERA MODULE

(71) Applicant: LG INNOTEK CO., LTD., Seoul (KR)

(72) Inventors: Ju Yong SHIM, Seoul (KR); Chang Gyun SON, Seoul (KR)

(21) Appl. No.: 19/108,000

(22) PCT Filed: Sep. 4, 2023
(86) PCT No.: PCT/KR2023/013178

§ 371 Date: Feb. 28, 2025

(30) Foreign Application Priority Data
Sep. 2, 2022 (KR) 10-2022-0111566

(51) Int. Cl. G02B 13/00

(52) U.S. Cl. CPC G02B 13/0045

(57) ABSTRACT

An optical system disclosed in the embodiment of the invention includes first to seventh lenses aligned along an optical axis from an object side toward a sensor side, wherein a refractive power of the first lens is negative, a composite refractive power of the third to seventh lenses is positive, the first lens has a meniscus shape convex from the optical axis toward the sensor side, a center distance between the first lens and the second lens is larger than a center thickness of each of the first to seventh lenses, and the first to seventh lenses include a plurality of spherical lenses and a plurality of aspherical lenses, wherein the spherical lens is a lens whose object-side surfaces and sensor-side surfaces are spherical on the optical axis, and the aspherical lens is a lens whose object-side surfaces and sensor-side surfaces are aspherical on the optical axis, and at least one of the plurality of aspherical lenses may be made of a different material from the spherical lens.

### TECHNICAL FIELD

An embodiment of the invention relates to an optical system for improved optical performance and a camera module including the same.

### BACKGROUND ART

ADAS (Advanced driving assistance system) is an advanced driver assistance system for assisting the driver to drive and is composed of sensing the situation in front, determining the situation based on the sensed result, and controlling the behavior of the vehicle based on the situation determination. For example, the ADAS sensor device detects a vehicle ahead and recognizes a lane. Then, when the target lane or target speed and the target in front are determined, the vehicle's ESC (Electrical stability control), EMS (Engine management system), MDPS (Motor driven power steering), etc. are controlled. Typically, ADAS may be implemented as an automatic parking system, a low-speed city driving assistance system, a blind spot warning system, and the like.

The sensor devices for sensing the forward situation in ADAS are a GPS sensor, a laser scanner, a front radar, and a lidar, and the most representative ones are cameras for filming the front, rear, and sides of a vehicle. These cameras may be disposed outside or inside the vehicle to detect the surroundings of the vehicle. In addition, the cameras may be disposed inside the vehicle to detect the situations of the driver and passengers. For example, the camera can photograph the driver at a location adjacent to the driver and detect the driver's health status, whether he or she is drowsy, whether he or she is drinking, etc. In addition, the camera can photograph the passenger at a location adjacent to the passenger and detect the passenger's sleep status, health status, etc., and provide the driver with information about the passenger.

In particular, the most important element for obtaining an image from a camera is the imaging lens that forms the image. Recently, interest in high-definition and high-resolution, etc., has been increasing, and research on an optical system including multiple lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics. Therefore, new optical systems and cameras that can solve the above-described problems are required.

### DISCLOSURE

### Technical Problem

An embodiment may provide an optical system and a camera module in which glass lenses and plastic lenses are mixed. The embodiment may provide an optical system and a camera module in which spherical lenses and aspherical lenses are mixed. An embodiment provides an optical system and a camera module having improved optical characteristics. An embodiment provides an optical system and a camera module having excellent optical performance in low-temperature to high-temperature environments. An embodiment provides an optical system and a camera module capable of preventing or minimizing changes in optical characteristics in various temperature ranges.

### Technical Solution

An optical system according to an embodiment of the invention comprises: first to seventh lenses aligned along an optical axis from an object side toward a sensor side, wherein a refractive power of the first lens is negative, and a composite refractive power of the third to seventh lenses is positive, the first lens has a meniscus shape convex toward the sensor side on the optical axis, a center distance between the first lens and the second lens is larger than a center thickness of each of the first to seventh lenses, the first to seventh lenses include a plurality of spherical lenses and a plurality of aspherical lenses, wherein the spherical lenses are lenses whose object-side and sensor-side surfaces are spherical on the optical axis, the aspherical lenses are lenses whose object-side and sensor-side surfaces are aspherical on the optical axis, and at least one of the plurality of aspherical lenses may be made of a different material from the spherical lenses.

According to an embodiment of the invention, a number of the spherical lenses may be at least twice a number of the aspherical lenses. At least one of the plurality of aspherical lenses may be made of the same glass material as the spherical lens, and at least one other may be made of a plastic material.

According to an embodiment of the invention, the first to sixth lenses may be made of glass, and the seventh lens may be made of a plastic material. The second to sixth lenses may be spherical lenses, and the first and seventh lenses may be aspherical lenses. An effective diameter of the first lens may be larger than an effective diameter of each of the fourth to seventh lenses. An aperture stop is included that is arranged on a periphery between the second lens and the third lens, and the first lens may have a shape in which both sides are concave on the optical axis.

According to an embodiment of the invention, a sensor-side surface of the fourth lens and an object-side surface of the fifth lens may be bonded. According to an embodiment of the invention, a center distance between an i-th lens and an i+1 lens is CGi, a center thickness of the i-th lens is CTi, and a value of CTi/CGi may be minimum when i is 1, and the value of CTi/CGi may be maximum when i is 3.

According to an embodiment of the invention, the center distance between the first and second lenses may be greater than a sum of the center thicknesses of two adjacent lenses among the first to seventh lenses. An Abbe number of each of the first to fourth lenses may be 50 or greater, and a lens having the maximum refractive index among the first to seventh lenses may be the fifth lens.

An optical system according to an embodiment of the invention comprises: a first lens group having lenses of a first material aligned along an optical axis from an object side toward a sensor side; a second lens group having lenses of a second material arranged on a sensor side of the lenses of the first material and aligned along the optical axis, wherein a number of lenses of the first material is at least twice that of lenses of the second material, the first lens closest to the object in the first lens group has a convex object-side surface and a concave sensor-side surface, and the first lens has positive refractive power, a last lens closest to an image sensor in the second lens group has a convex object-side surface and a concave sensor-side surface, and the last lens has negative refractive power, and the first material and the second material may be different materials.

According to an embodiment of the invention, the first material is a glass material, the second material is a plastic material, the object-side surface and the sensor-side surface of the first lens have aspherical surfaces, and object-side surface and the sensor-side surface of each of the lenses of the second material may have aspherical surfaces.

According to an embodiment of the invention, a refractive index of the first lens is greater than 1.75, an optical axis distance from a center of the object-side surface of the first lens to an image surface of the image sensor is TTL, and an optical axis distance from the center of the object-side surface of a last lens to the image surface of the image sensor is BFL, and the following Equation may satisfy: 4<TTL/BFL<10.

According to an embodiment of the invention, the optical axis distance from the center of the object-side surface of the last lens to the image surface of the image sensor is BFL, and 1/2 of a diagonal length of the image sensor is ImgH, and the following Equation may satisfy: 1<BFL/ImgH<1.5.

According to an embodiment of the invention, an effective focal length of the optical system is F, the optical axis distance from a center of the object-side surface of the first lens to the image surface of the image sensor is TTL, the optical axis distance from the center of the object-side surface of the last lens to the image surface of the image sensor is BFL, and the following Equation 1 may satisfy: 2≤TTL/F≤3 and the following Equation 2 may satisfy: 1<F/BFL<3.

According to an embodiment of the invention, the first lens group includes the first to fifth lenses, the second lens group includes the sixth to seventh lenses, the seventh lens is the last lens, and the focal length of the first lens may be greater than a composite focal length of the second to seventh lenses.

According to an embodiment of the invention, a center thickness of the second lens is the largest among center thicknesses of the first to seventh lenses, and a center distance between the first lens and the second lens is the largest among center distances between adjacent lenses and may be greater than the center thickness of the second lens.

A camera module according to an embodiment of the invention comprises: an image sensor; first to seventh lenses aligned along an optical axis from an object side toward a sensor side; an aperture stop arranged between spherical lenses among the first to seventh lenses; an optical filter between the seventh lens and the image sensor, wherein the first lens and the seventh lens are made of the same material, materials of a lens disposed on an object side of the aperture stop and a lens disposed on a sensor side of the aperture stop are different, the seventh lens has negative refractive power, a cemented lens arranged between the aperture stop and the image sensor among the first to seventh lenses, wherein at least one of the lenses between the cemented lens and the image sensor may be an aspherical lens.

### Advantageous Effects

The optical system and camera module according to the embodiment may have improved optical characteristics. Specifically, in the optical system according to the embodiment, a plurality of lenses may have set thicknesses, refractive powers, and distances with adjacent lenses. Accordingly, the optical system and camera module according to the embodiment may have improved MTF characteristics, aberration control characteristics, resolution characteristics, etc. in a set field of view range, and may have good optical performance in the periphery portion of the field of view.

In addition, the optical system and camera module according to the embodiment may have good optical performance in a temperature range of low temperature (about −20 °C to −40 °C) to high temperature (85 °C to 105 °C). Specifically, a plurality of lenses included in the optical system may have set materials, refractive powers, and refractive indices. Accordingly, even when the focal length of each lens changes due to a change in refractive index according to a change in temperature, the lenses may mutually compensate for each other. That is, the optical system may effectively perform distribution of refractive power in a temperature range of low temperature to high temperature, and prevent or minimize changes in optical characteristics in a temperature range of low temperature to high temperature. Therefore, the optical system and camera module according to the embodiment can maintain improved optical characteristics in various temperature ranges.

In addition, the optical system and camera module according to the embodiment may satisfy the set field of view by mixing an aspherical lens and a spherical lens and implement excellent optical characteristics. As a result, the optical system can provide a slimmer vehicle camera module. Therefore, the optical system and camera module may be provided to various applications and devices, and may have excellent optical characteristics even in harsh temperature environments, such as when exposed to the outside of a vehicle or inside a vehicle at high temperatures in the summer.

### DESCRIPTION OF DRAWINGS

FIG. 1 is a side cross-sectional view of an optical system according to the first embodiment and a camera module having the same.

FIG. 2 is a side cross-sectional view for explaining the relationship between the n-th and n−1th lenses according to FIG. 1.

FIG. 3 is a table showing lens characteristics of the optical system of FIG. 1.

FIG. 4 is a table showing aspherical coefficients of lenses in the optical system of FIG. 1.

FIG. 5 is a table showing thicknesses of each lens and spacing between adjacent lenses in the optical system of FIG. 1.

FIG. 6 is a table showing CRA (Chief ray angle) data at room temperature, low temperature, and high temperature according to the position of the image sensor in the optical system of FIG. 1.

FIG. 7 is a graph showing data on the diffraction MTF (Modulation transfer function) of the optical system of FIG. 1 at room temperature.

FIG. 8 is a graph showing data on the diffraction MTF of the optical system of FIG. 1 at low temperature.

FIG. 9 is a graph showing data on the diffraction MTF of the optical system of FIG. 1 at high temperature.

FIG. 10 is a graph showing data on the aberration characteristics of the optical system of FIG. 1 at room temperature.

FIG. 11 is a graph showing data on the aberration characteristics of the optical system of FIG. 1 at low temperature.

FIG. 12 is a graph showing data on the aberration characteristics of the optical system of FIG. 1 at high temperature.

FIG. 13 is a cross-sectional side view of an optical system according to the second embodiment and a camera module having the same.

FIG. 14 is a table showing lens characteristics of the optical system of FIG. 13.

FIG. 15 is a table showing aspherical coefficients of lenses in the optical system of FIG. 13.

FIG. 16 is a table showing the thickness of each lens of the optical system of FIG. 13 and the spacing between adjacent lenses.

FIG. 17 is a table showing CRA data at room temperature, low temperature, and high temperature according to the position of the image sensor in the optical system of FIG. 13.

FIG. 18 is a graph showing data on the diffraction MTF of the optical system of FIG. 13 at room temperature.

FIG. 19 is a graph showing data on the aberration characteristics of the optical system of FIG. 13 at room temperature.

FIG. 20 is a graph showing relative illuminance according to the height of the image sensor according to the first and second embodiments.

FIG. 21 is a side cross-sectional view of an optical system according to the third embodiment and a camera module having the same.

FIG. 22 is a side cross-sectional view for explaining the relationship between the n-th and n−1th lenses according to FIG. 21.

FIG. 23 is a table showing lens characteristics of the optical system of FIG. 21.

FIG. 24 is a table showing aspherical coefficients of lenses in the optical system of FIG. 21.

FIG. 25 is a table showing the thickness of each lens of the optical system of FIG. 21 and the spacing between adjacent lenses.

FIG. 26 is a table showing Sag values for the object-side surface and the sensor-side surface of the lenses of the optical system of FIG. 21.

FIG. 27 is a table showing CRA data at room temperature, low temperature, and high temperature according to the position of the image sensor in the optical system of FIG. 21.

FIG. 28 is a graph showing data on diffraction MTF at room temperature of the optical system of FIG. 21.

FIG. 29 is a graph showing data on diffraction MTF at low temperature of the optical system of FIG. 21.

FIG. 30 is a graph showing data on diffraction MTF at high temperature of the optical system of FIG. 21.

FIG. 31 is a graph showing data on aberration characteristics at room temperature of the optical system of FIG. 21.

FIG. 32 is a graph showing data on aberration characteristics at low temperature of the optical system of FIG. 21.

FIG. 33 is a graph showing data on aberration characteristics at high temperature of the optical system of FIG. 21.

FIG. 34 is a graph showing relative illuminance according to the height of the image sensor according to the third embodiment.

FIG. 35 is a graph showing the Sag values of the object side and sensor side of the sixth and seventh lenses of FIG. 22.

FIG. 36 is an example of a vehicle having an optical system according to an embodiment of the invention.

### BEST MODE

Hereinafter, preferred embodiments of the invention will be described in detail with reference to the accompanying drawings. A technical spirit of the invention is not limited to some embodiments to be described, and may be implemented in various other forms, and one or more of the components may be selectively combined and substituted for use within the scope of the technical spirit of the invention. In addition, the terms (including technical and scientific terms) used in the embodiments of the invention, unless specifically defined and described explicitly, may be interpreted in a meaning that may be generally understood by those having ordinary skill in the art to which the invention pertains, and terms that are commonly used such as terms defined in a dictionary should be able to interpret their meanings in consideration of the contextual meaning of the relevant technology.

The terms used in the embodiments of the invention are for explaining the embodiments and are not intended to limit the invention. In this specification, the singular forms also may include plural forms unless otherwise specifically stated in a phrase, and in the case in which at least one (or one or more) of A and (and) B, C is stated, it may include one or more of all combinations that may be combined with A, B, and C. In describing the components of the embodiments of the invention, terms such as first, second, A, B, (a), and (b) may be used. Such terms are only for distinguishing the component from other component, and may not be determined by the term by the nature, sequence or procedure etc. of the corresponding constituent element. And when it is described that a component is “connected”, “coupled” or “joined” to another component, the description may include not only being directly connected, coupled or joined to the other component but also being “connected”, “coupled” or “joined” by another component between the component and the other component. In addition, in the case of being described as being formed or disposed “above (on)” or “below (under)” of each component, the description includes not only when two components are in direct contact with each other, but also when one or more other components are formed or disposed between the two components. In addition, when expressed as “above (on)” or “below (under)”, it may refer to a downward direction as well as an upward direction with respect to one element. Several embodiments described below may be combined with each other, unless it is specifically stated that they cannot be combined with each other. In addition, the description of other embodiments may be applied to parts omitted from the description of any one of several embodiments unless otherwise specified.

In the description of the invention, “object-side surface” may refer to a surface of the lens facing the object side with respect to the optical axis OA, and “sensor-side surface” may refer to a surface of the lens facing the imaging surface (image sensor) with respect to the optical axis. A convex surface of the lens may mean a convex shape on the optical axis or paraxial region, and a concave surface of the lens may mean a concave shape on the optical axis or paraxial region. A curvature radius, center thickness, and distance between lenses described in the table for lens data may mean values on the optical axis, and the unit is mm. The vertical direction may mean a direction perpendicular to the optical axis, and an end of the lens or the lens surface may mean the end or edge of the effective region of the lens through which the incident light passes. The size of the effective diameter on the lens surface may have a measurement error of up to =0.4 mm depending on the measurement method. The paraxial region refers to a very narrow region near the optical axis, and is a region where the distance a light ray falls from the optical axis OA is almost 0. Hereinafter, the optical axis may include the center of each lens or a very narrow region near the optical axis.

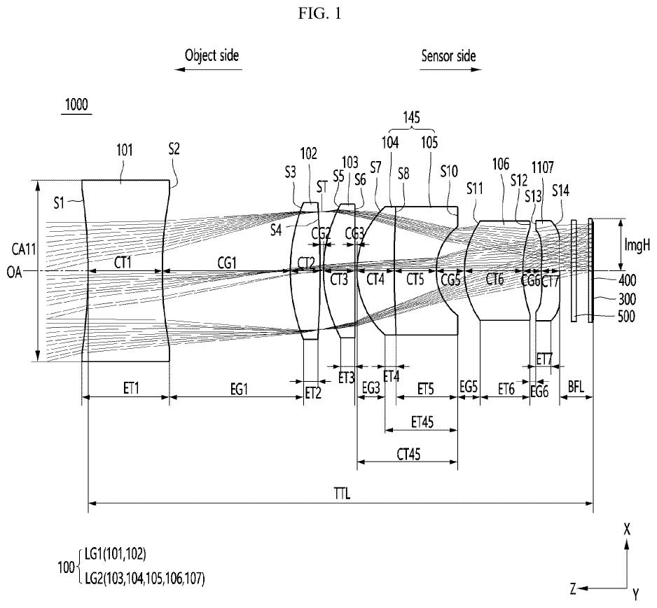

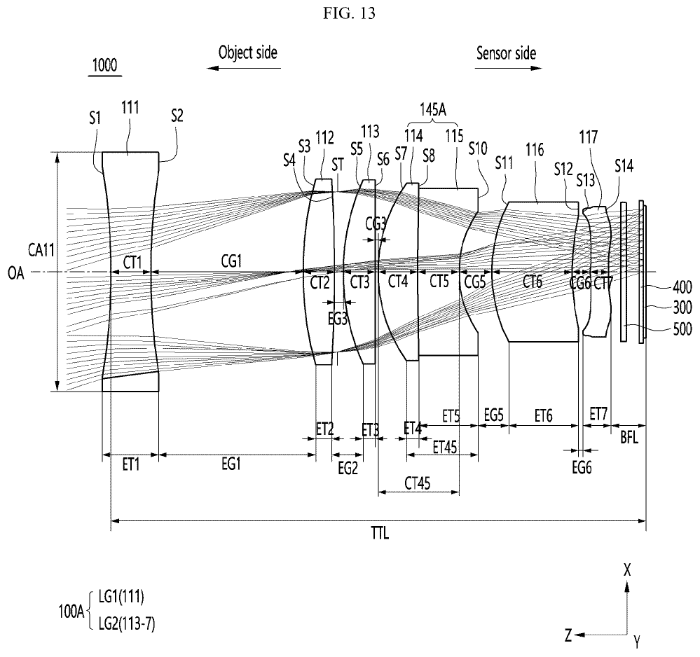

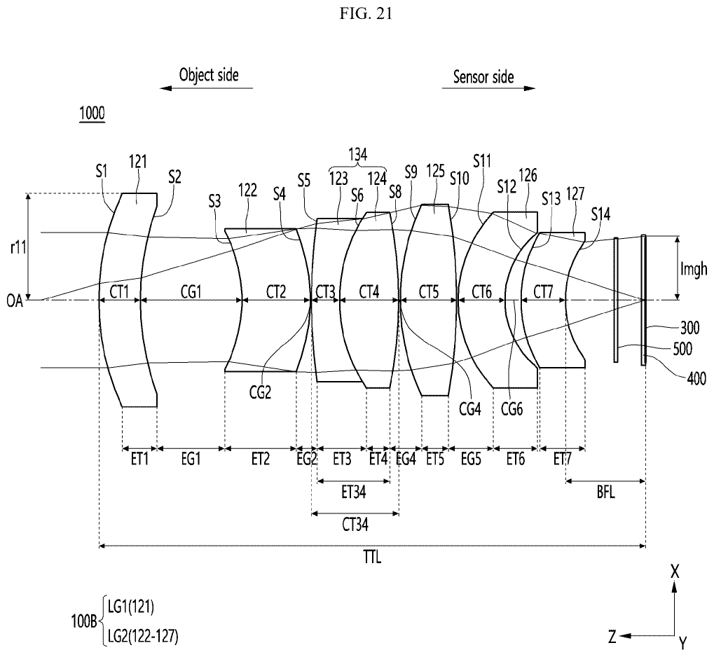

FIG. 1 is a side cross-sectional view of an optical system and a camera module according to a first embodiment. FIG. 13 is a side cross-sectional view of an optical system and a camera module according to a second embodiment. FIG. 21 is a side cross-sectional view of an optical system and a camera module according to a third embodiment. Referring to FIGS. 1, 13, and 21, an optical system 1000 may include a plurality of lens groups LG1 and LG2. In detail, each of the plurality of lens groups LG1 and LG2 includes at least one lens. For example, the optical system 1000 may include a first lens group LG1 and a second lens group LG2 that are sequentially arranged along an optical axis OA from an object side toward an image sensor 300. The optical system 1000 may include n lenses, where the n-th lens may be the last lens, and the n−1th lens may be the lens closest to the last lens. The n is an integer greater than or equal to 5, for example, 5 to 9. The number of lenses of each of the first lens group LG1 and the second lens group LG2 may be different from each other. The number of lenses of the second lens group LG2 may be greater than the number of lenses of the first lens group LG1, for example, may be more than 2 times or more than 3 times the number of lenses of the first lens group LG1. In the first and third embodiments, the number of lenses of the second lens group LG2 may be more than 4 times or more than 5 times the number of lenses of the first lens group LG1.

The first lens group LG1 may include at least one lens. The first lens group LG1 may have 3 or less lenses. The first lens group LG1 may preferably have 1 or 2 lenses. The second lens group LG2 may include three or more or four lenses, and preferably, five or six lenses.

The composite focal length of the first lens group LG1 may be defined as F_LG1, and the composite focal length of the second lens group LG2 may be defined as F_LG2, and the following condition may satisfy: F_LG2<F_LG1. In the first embodiment, the first lens group LG1 may be two lenses adjacent to the object, and the second lens group LG2 may be lenses excluding the lenses of the first lens group LG1. In the second and third embodiments, the first lens group LG1 may be one lens adjacent to the object, and the second lens group LG2 may be lenses excluding the lenses of the first lens group LG1.

The first lens group LG1 may include an aspherical lens and a spherical lens. The second lens group LG2 may include a plurality of spherical lenses and at least one aspherical lens. The first lens group LG1 may include a glass lens. The first lens group LG1 may provide a lens closest to an object as a glass lens. Such a glass material has a smaller amount of expansion and contraction change due to external temperature change than a plastic material, and its surface is less easily scratched, thereby preventing surface damage. The second lens group LG2 may include at least one glass lens and at least one plastic lens. The second lens group LG2 may include three or more glass lenses and at least one plastic lens, for example, four glass lenses and one plastic lens. The lens closest to the image sensor 300 in the optical system 1000 may be made of plastic. As another example, the second lens group LG2 may include two or more plastic lenses, for example, two or three plastic lenses. In addition, lenses made of plastic are effective in improving thinness and optical characteristics. The lens closest to the object in the first lens group LG1 may be provided as an aspherical lens made of glass. Accordingly, a lens close to the outside in the lens barrel may be arranged as a glass lens. Among the lenses in the second lens group LG2, one or two lenses closest to the image sensor 300 may be provided as a plastic lens or as an aspherical lens. The aspherical lens is a lens whose object-side surface and the sensor-side surface are aspherical, and the spherical lens is a lens whose object-side surface and the sensor-side surface are spherical. That is, at least one aspherical lens close to the image sensor 300 may compensate for various aberrations. The aspherical lenses can prevent spherical aberration within the optical system 1000, and since aberration does not occur even when the effective diameter is increased, miniaturization and weight reduction of the camera module may be possible. The aspherical lenses may be made of glass mold or plastic mold material. For example, the second lens group LG2 can include a lens made of glass material and a plastic mold lens.

In the first and second embodiments, among the lenses of the optical system 1000, the lens having the maximum Abbe number may be located in the first lens group LG1, the lens having the maximum refractive index may be located in the second lens group LG2, the maximum Abbe number may be 60 or more, and the maximum refractive index may be greater than 1.7. In the third embodiment, the lens having the maximum Abbe number may be positioned in the second lens group LG2, the lens having the maximum refractive index may be positioned in the first lens group LG1, the maximum Abbe number may be 65 or more, and the maximum refractive index may be 1.75 or more. The lens having the maximum Abbe number may reduce chromatic dispersion, and the lens having the maximum refractive index may increase chromatic dispersion of incident light. In addition, the lens having the maximum refractive index may be positioned closer to the image sensor or the sensor side than the lens having the maximum Abbe number.

In the optical system 1000, the lens having the maximum effective diameter may be a lens close to the object side, or one of the lenses between the two lenses on the object side and the two lenses on the sensor side. The lens having the maximum effective diameter is a glass lens, and may be positioned closest to the object. The effective diameter of each lens may be the diameter of the effective region where effective light is incident from each lens, and is the average of the effective diameter of the object-side surface and the effective diameter of the sensor-side surface. An embodiment of the invention can reduce the weight of the camera module, provide a lower manufacturing cost, and suppress the deterioration of optical characteristics due to temperature change by further mixing an aspherical lens in the optical system 1000. Various types of plastic lenses can replace glass lenses in the optical system, and the polishing and processing of lens surfaces such as aspherical or free-form surfaces may be easily performed.

Each of the lenses may include an effective region and an non-effective region. The effective region may be a region where light incident on each of the lenses passes. In other words, the effective region may be defined as an effective region or an effective diameter where the incident light is refracted to implement optical characteristics. The non-effective region may be disposed around the effective region. The non-effective region may be a region where effective light is not incident from the plurality of lenses. That is, the non-effective region may be a region unrelated to the optical characteristics. In addition, an end of the non-effective region may be a region fixed to a lens barrel (not shown) that accommodates the lens. The lens barrel contacts lenses of a first material, or contacts lenses of different first and second materials, and may be made of a plastic material or a metal material. The lenses of the first material are sequentially aligned along the optical axis OA from the object, and three or fewer or fewer lenses of the second material may be arranged along the optical axis on the sensor side of the lenses of the first material. The first material is a glass material, and the second material is a plastic material.

Within the optical system 1000, the TTL (Total track length or total top length) may be more than twice as long as the ImgH, for example, more than twice and less than 15 times. Preferably, the following condition may satisfy: 4<TTL/ImgH≤10. The TTL is a distance from the center of the object-side surface of the first lens to a surface of the image sensor 300 in the optical axis OA. The ImgH is half of the maximum diagonal length of the image sensor 300. Within the optical system 1000, the effective focal length (EFL) is provided to be 10 mm or more and the diagonal FOV is provided to be less than 45 degrees, so that the optical system may be provided as a standard optical system in a vehicle camera module. For example, the optical system and the camera module according to the embodiment may be applied to a camera module for an ADAS (Advanced driving assistance system) provided inside or outside a vehicle.

In the optical system 1000, the following condition: TTL/(2*ImgH) may be 2.5 or more or 2.7 or more, for example, a range of 2.5 to 5, 2.5 to 4.7, or 3 to 5. By setting the value of TTL/(2*ImgH) to 2.5 or more, the optical system 1000 may provide a vehicle lens optical system. The total number of lenses of the first and second lens groups LG1 and LG2 is 9 or less or 8 or less. Accordingly, the optical system 1000 may provide an image without exaggeration or distortion for the image being formed.

In the first and second embodiments, the number of lenses having an effective diameter greater than the length of the image sensor 300 in the optical system 1000 may exceed 50% of the total number of lenses. Preferably, the number of lenses having an effective diameter smaller than the length of the image sensor 300 may be 40% or less of the total number of lenses, for example, in the range of 10% to 40%. In the third embodiment, the number of lenses having an effective diameter larger than the length of the image sensor 300 in the optical system 1000 may be 70% or more of the total number of lenses, and the number of lenses having an effective diameter smaller than the length of the image sensor 300 may be less than 30% of the total number of lenses. At least one or all of the aspherical lenses in the optical system 1000 may have an effective diameter smaller than the length of the image sensor 300. The length of the image sensor 300 is the maximum length of the diagonal in the direction orthogonal to the optical axis OA.

The effective diameter of the lens closest to the object side in the lens portion 100, 100A, and 100B may be larger than the effective diameter of the lens closest to the image sensor 300. In addition, the effective diameter of the lens arranged on the object side of the aperture stop ST and the lens arranged on the sensor side of the aperture stop ST may be larger than the diagonal length of the image sensor 300. In the lens portion 100, 100A, and 100B, the object-side aspherical lens may have an effective diameter larger than the diagonal length of the image sensor 300, and the sensor-side aspherical lens may have an effective diameter smaller than the diagonal length of the image sensor 300. Accordingly, the brightness of the optical system may be controlled. By controlling the effective diameter size of each of the lenses, the optical system 1000 can control the incident light to compensate for the deterioration of the resolution and optical characteristics due to temperature changes, improve the chromatic aberration control characteristics, and improve the vignetting characteristics of the optical system 1000.

The optical system 1000 may include at least one cemented lens 145, 145A, and 134 therein. The cemented lens 145, 145A, and 134 may be a lens in which two lenses having different focal lengths are bonded. The cemented lens 145, 145A, and 134 has a bonded object-side lens and a sensor-side lens, and the effective diameter of the object-side lens of the cemented lens 145, 145A, and 134 may be larger or smaller than the effective diameter of the sensor-side lens. For example, in the first and second embodiments, the effective diameter of the object-side lens of the cemented lens 145 and 145A may be larger than the effective diameter of the sensor-side lens, the effective diameter of the object-side lens of the cemented lens 145 and 145A may be larger than the length of the image sensor 300, and the effective diameter of the sensor-side lens may be disposed within a range of ±110% of the diagonal length of the image sensor 300. In the third embodiment, the effective diameter of the lenses arranged on the object side based on the cemented lens 134 may be larger than the length of the image sensor 300. The object-side lens 104 and the sensor-side lens 105 of the cemented lens 134 may be larger than the length of the image sensor 300.

The cemented lenses 145, 145A, and 134 may be spherical lenses. The cemented lenses may be bonded using a transparent resin material. The effective diameter of the lenses arranged closer to the object based on the cemented lens 145, 145A, and 134 may be larger than the length of the image sensor 300. At least one lens surface among the lenses arranged closer to the sensor based on the cemented lens 145, 145A, and 134 may have an effective diameter smaller than the length of the image sensor 300. The cemented lens 145, 145A, and 134 may be disposed between spherical lenses in the optical system.

The first lens group LG1 and the second lens group LG2 in the optical axis OA may have a set distance. The c between the first lens group LG1 and the second lens group LG2 in the optical axis OA may be the optical axis distance between the sensor-side surface of the lens closest to the sensor side among the lenses in the first lens group LG1 and the object-side surface of the lens closest to the object side among the lenses in the second lens group LG2. In the first and second embodiments, the optical axis distance between the first lens group LG1 and the second lens group LG2 may be 0.5 times or less of the optical axis distance of the first lens group LG1, for example, may be in a range of 0.01 to 0.5 times the optical axis distance of the first lens group LG1. In the first and second embodiments, the optical axis distance between the first lens group LG1 and the second lens group LG2 may be 0.3 times or less of the optical axis distance of the second lens group LG2, and may be, for example, in the range of 0.01 to 0.3 times. In the third embodiment, the optical axis distance between the first and second lens groups LG1 and LG2 may be 0.5 times or less of the optical axis distance of the second lens group LG2, and may be, for example, in the range of 0.1 to 0.5 times. The optical axis distance of the second lens group LG2 is an optical axis distance between the object-side surface of the lens closest to the object side of the second lens group LG2 and the sensor-side surface of the lens closest to the image sensor 300. In the first and second embodiments, the two lens surfaces facing each other in the region between the first and second lens groups LG1 and LG2 may have a shape in which the sensor-side surface of the object-side lens is concave and the object-side surface of the sensor-side lens is convex. Differently, the two surfaces facing each other may have a shape in which the sensor-side surface of the object-side lens is convex and the object-side surface of the sensor-side lens is concave in the optical axis. In the third embodiment, the two lens surfaces facing each other in the region between the first and second lens groups LG1 and LG2, for example, the sensor-side surface of the object-side lens may be concave and the object-side surface of the sensor-side lens may be concave. The first lens group LG1 may refract light incident through the object side to gather, and the second lens group LG2 may refract light emitted through the first lens group LG1 to the image sensor 300.

The first lens group LG1 may have positive (+) refractive power, and the second lens group LG2 may have positive (+) refractive power. In the first and second embodiments, the first lens 101 and 111 closest to the object in the first lens group LG1 may have negative (−) refractive power, and in the third embodiment, the first lens 121 may have positive refractive power. Among the lenses in the second lens group LG2, the lens closest to the image sensor may have negative (−) refractive power. In addition, the composite focal length F27 of the second to seventh lenses may have a positive (+) value.

When the focal length is expressed as an absolute value, in the first and second embodiments, the focal length of the first lens group LG1 may be 1.5 times or more, for example, 1.5 times to 5 times, of the focal length of the second lens group LG2. In the third embodiment, the focal length of the first lens group LG1 may be 5 times or more, for example, 5 to 15 times, of the focal length of the second lens group LG2. The EFL of the optical system 1000 may be smaller than the focal length of the first lens group LG1, and the difference from the focal length of the second lens group LG2 may be less than 5. In the first to third embodiments, the EFL may be smaller than the absolute value of the focal length of the first lens group LG1. The EFL of the optical system 1000 may be smaller than the absolute value of the focal length of the second lens group LG2.

The lens portion 100, 100A, and 100B may be a mixture of spherical lenses and aspherical lenses. The number of lenses of the aspherical lens may be less than 50% of the total number of lenses, and may be in the range of 10% to 40%. The number of lenses having negative (−) refractive power in the lens portion (100, 100A) of the first and second embodiments may be smaller than the number of lenses having positive (+) refractive power, for example, the number of lenses having negative (−) refractive power may be less than 50% of the total number of lenses, and may be in the range of 20% to 45%. In the lens 100B of the third embodiment, the number of lenses having negative (−) refractive power on the optical system 1000 may be greater than the number of lenses having positive (+) refractive power. The number of lenses having negative (−) refractive power may be 50% or more of the total number of lenses, and may be in the range of 50% to 70% or 50% to 65%.

In the first and second embodiments, when the absolute value of the focal length is expressed, the average of the focal lengths of the spherical lenses may be smaller than the average of the focal lengths of the aspherical lenses. The average of the refractive indices of the aspherical lenses may be smaller than the average of the refractive indices of the spherical lenses. In addition, the average of the effective diameters of the spherical lenses may be larger than the average of the effective diameters of the aspherical lenses. Accordingly, when two or more aspherical lenses are arranged in the camera module, the weight of the camera module may be reduced and the optical characteristics may be improved. Since the first lens 101 and 111 closest to the object is arranged to have a higher Abbe number and lower refractive index than the second lens 102 and 112, the distance between the first and second lenses may be increased. In addition, since the n-th lens adjacent to the image sensor 300 is arranged to have a lower Abbe number and higher refractive index than the n−1th lens, color dispersion may be improved at a location adjacent to the image sensor 300.

In the lens portion 100B of the third embodiment, when the focal length is an absolute value, the focal length of the lens closest to the object may be smaller than the focal length of the last lens. The absolute value of the focal length of the last lens may be the largest in the optical system and may be larger than the focal length F_LG1 of the first lens group LG1. When the focal length of the last lens is F7, the following condition may satisfy: F_LG1<F7.

The lens portion 100B may include lenses of a first material and lenses of a second material different from the first material. The first material may be a glass material, and the second material may be a plastic material. The lenses of the first material may be adjacent to the object and aligned along the optical axis, and the lenses of the second material may be adjacent to the image sensor 300 and aligned along the optical axis. The lenses of the first material may be defined as a first material group, and the lenses of the second material may be defined as a second material group. The number of lenses of the first material group may be 1.5 times or more, for example, 2 times or more, than the number of lenses of the second material group. The lenses of the first material may have an average center thickness greater than the average center thickness of the lenses of the second material. The lenses of the first material may have an average refractive index greater than the average refractive index of the lenses of the second material. In addition, the lenses of the first material may have an average effective diameter greater than the average effective diameter of the lenses of the second material. The lenses of the first material may include lenses having a spherical surface and lenses having an aspherical surface. The lenses of the second material may include lenses having an aspherical surface. The optical system 1000 may correct various aberrations according to temperature changes by mixing lenses of glass and plastic materials, and may reduce the weight of the camera module.

In the first to third embodiments of the invention, the sum of the refractive indices of the lenses of the lens portions 100, 100A, and 100B is 8 or more, for example, in the range of 8 to 15, and the average of the refractive indices may be in the range of 1.60 to 1.70 or in the range of 1.60 to 1.72. The sum of the Abbe numbers of each of the lenses may be 220 or more, for example, in the range of 220 to 400 or 270 to 390, and the average of the Abbe numbers may be 55 or less, for example, in the range of 31 to 55. The sum of the center thicknesses of the entire lenses may be 15 mm or more, for example, in the range of 15 mm to 35 mm, 15 mm to 30 mm, or 20 mm to 30 mm. The average of the center thicknesses of the entire lenses may be 5 mm or less, for example, in the range of 2.8 mm to 4 mm or 2.8 mm to 5 mm. The sum of the center distances between the lenses in the optical axis OA may be 4 mm or more, for example, in the range of 4.5 mm to 10 mm or in the range of 4 mm to 20 mm, and may be less than the sum of the center thicknesses of the lenses. In addition, the average value of the effective diameter of each lens surface of the lens portion 100, 100A, and 100B may be provided as 8 mm or more, for example, in the range of 8 mm to 15 mm.

The F number of the optical system or camera module according to the first to third embodiments of the invention may be 2.4 or less, for example, in the range of 1.4 to 2.4 or in the range of 1.5 to 1.8. The maximum field of view (diagonal angle) in the optical system according to the embodiments of the invention may be 50 degrees or less, for example, in the range of 20 to 50 degrees, 20 to 55 degrees, or 25 to 40 degrees. The vehicle optical system may have a horizontal field of view FOV_H in the Y-axis direction that is greater than 20 degrees and less than 40 degrees, for example, in the range of 25 degrees to 35 degrees. In addition, the vertical field of view is provided at an angle smaller than the horizontal field of view, and may be less than 20 degrees, for example, in the range of 10 degrees to 20 degrees. At this time, the sensor length in the horizontal direction Y may be 8.064 mm±0.5 mm, and the sensor height in the vertical direction X may be 4.54 mm±0.5 mm. The horizontal field of view FOV_H is an angle based on the horizontal length of the sensor. Accordingly, it is possible to suppress the change in the focus focusing position due to temperature change, and provide a vehicle camera in which various aberrations are well corrected.

The optical system 1000 or the camera module may include an image sensor 300. The image sensor 300 may detect light and convert it into an electrical signal. The image sensor 300 can detect light that has sequentially passed through the lens portion 100, 100A, and 100B. The image sensor 300 can include a device capable of detecting incident light, such as a CCD (Charge coupled device) or a CMOS (Complementary metal oxide semiconductor). Here, the number of lenses having an effective diameter larger than the length of the image sensor 300 is 5 to 6, and the number of lenses having an effective diameter smaller than the length of the image sensor 300 may be 1 or 2.

The optical system 1000 or the camera module can include an optical filter 500. The optical filter 500 may be disposed between the second lens group LG2 and the image sensor 300. The optical filter 500 may be disposed between the lens closest to the sensor side among the lenses of the lens portion 100, 100A, and 100B and the image sensor 300. For example, the optical system 100, 100A, and 100B may be disposed between the last lens and the image sensor 300.

The cover glass 400 is disposed between the optical filter 500 and the image sensor 300, and may protect the upper part of the image sensor 300 and prevent the reliability of the image sensor 300 from being deteriorated. The cover glass 400 may be removed. The optical filter 500 may include an infrared filter or an infrared cut-off filter (IR cut-off). The optical filter 500 may allow light of a set wavelength band to pass through and filter light of a different wavelength band. When the optical filter 500 includes an infrared filter, it can block radiant heat emitted from external light from being transmitted to the image sensor 300. In addition, the optical filter 500 can transmit visible light and reflect infrared light.

The optical system 1000 according to the embodiments may include an aperture stop ST. The aperture stop ST can adjust the amount of light incident on the optical system 1000. The aperture stop ST may be disposed between any two lenses in the lens portion 100, 100A, and 100B. In the lenses arranged between the object and the aperture stop ST, the effective diameter of the lenses tends to decrease as they go from the object side to the aperture stop ST. In the lenses arranged between the aperture stop ST and the image sensor 300, the effective diameter of the lenses tends to decrease as they go from the aperture stop ST to the sensor side. ‘The effective diameter of the lenses tends to decrease as it goes from the aperture stop ST to the sensor side’ means that, for the lenses arranged between the aperture stop ST and the image sensor 300, the effective diameter of the lenses decreases as it goes from the aperture stop ST to the sensor side, and at least one lens surface may be larger than the object-side lens surface. As in the embodiment of the invention, for the lenses arranged between the aperture stop ST and the image sensor, the effective diameter of the lenses increases and then decreases as it goes from the aperture stop ST to the sensor side.

A first lens 101, 111, and 121 and a second lens 102, 112, and 122 may be disposed on the object side of the aperture stop ST, and a third lens 103, 113, and 123 and a fourth lens 104, 114, and 124 may be disposed on the sensor side of the aperture stop ST. When the above aperture stop ST is arranged on the sensor-side surface of the second lens 102, 112, and 122, the following condition satisfies: effective diameter of the object-side surface of the first lens>effective diameter of the sensor-side surface of the first lens>effective diameter of the object-side surface of the second lens. The following condition satisfies: effective diameter of the sensor-side surface of the second lens 102 and 112>effective diameter of the object-side surface of the third lens>effective diameter of the sensor-side surface of the fourth lens.

The aperture stop ST may be disposed at a set position. The aperture stop ST may be disposed on the periphery of the object-side surface or the sensor-side surface of any one of the lenses of the first lens group LG1. For example, the aperture stop ST may be disposed on the periphery of the sensor-side surface of the sensor-side lens of the first lens group LG1, that is, on the periphery of the sensor-side surface of the second lens 102. As another example, the aperture stop ST may be disposed around the object-side surface or sensor-side surface of the lens closest to the object side among the lenses of the second lens group LG2. Alternatively, the aperture stop ST may be disposed around the object-side surface or sensor-side surface of the object-side lens of the first lens group LG1. Alternatively, at least one lens selected from the plurality of lenses may function as an aperture. In detail, the object-side surface or sensor-side surface of one lens selected from the lenses of the optical system 1000 may function as an aperture for controlling the amount of light.

Since the embodiment is an optical system applied to a vehicle camera, an aspherical lens and a spherical lens may be used together, and the first lens closest to the object side may be provided with a glass material. This has the advantage that the glass material is resistant to scratches and is not sensitive to external temperature compared to a plastic material. In order to more effectively prevent scratches caused by foreign substances or placed inside a vehicle, the first lens may be made of glass, and the object-side surface of the first lens may have a concave shape so as not to come into contact with external structures. If the object-side surface of the first lens is designed to have a convex shape, scratches may occur due to contact with external structures. In order to monitor the driver while driving, take pictures of the front/rear of the vehicle, or detect lanes and objects around the vehicle, the field of view may be more than 20 degrees and less than 40 degrees, for example, in the range of 25 degrees to 35 degrees. This horizontal field of view may be a preset angle for an advanced driver assistance system.

The optical system 1000 according to the embodiment may further include a reflective member (not shown) for changing the path of light. The reflective member may be implemented as a prism that reflects the incident light of the first lens group LG1 toward the lenses. Hereinafter, the optical system according to the embodiment will be described in detail.

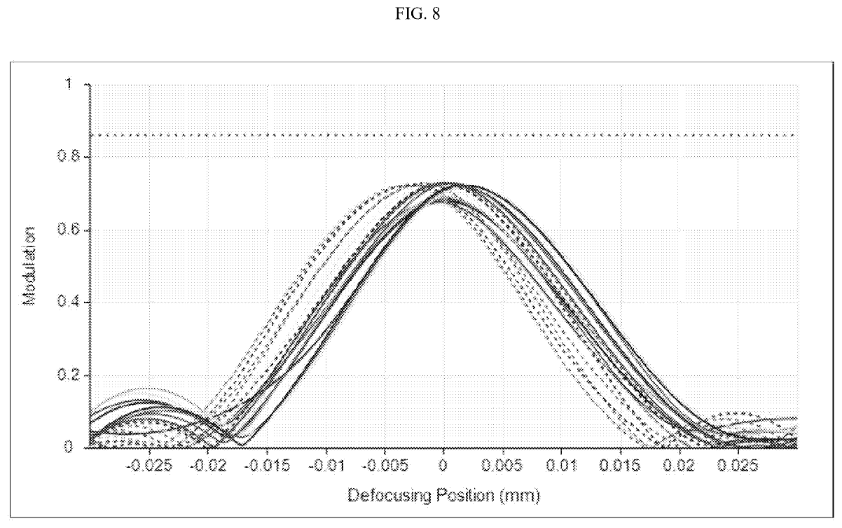

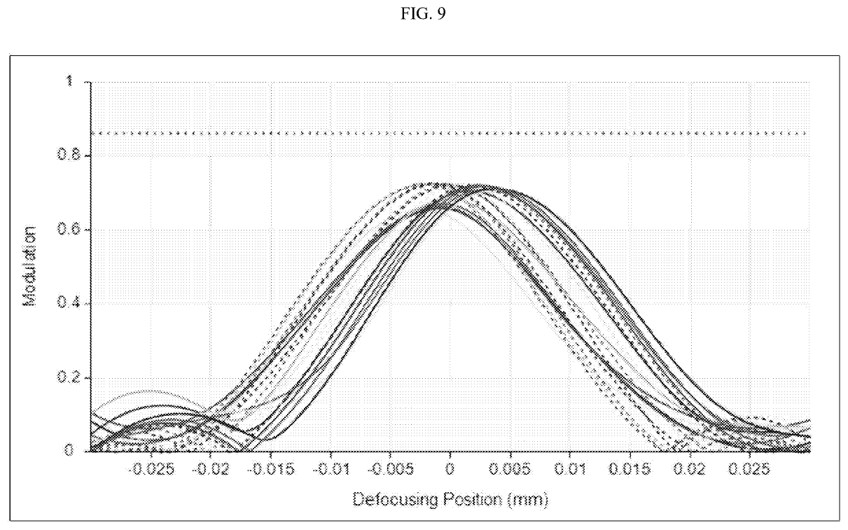

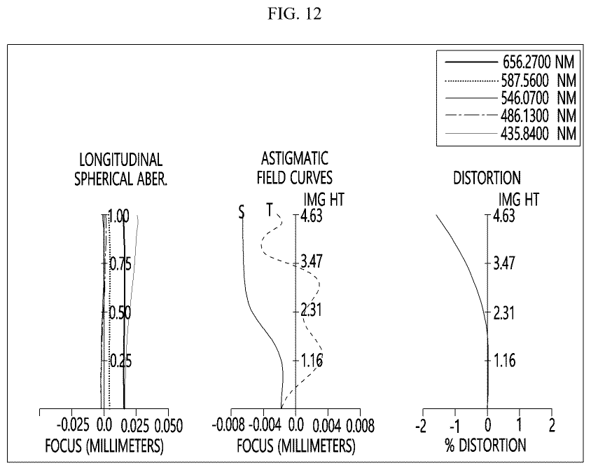

An optical system according to the first embodiment of the invention will be described with reference to FIGS. 1 to 12. Referring to FIGS. 1 to 3, the optical system 1000 according to the first embodiment includes a lens portion 100, and the lens portion 100 may include a first lens 101 to a seventh lens 107. The first to seventh lenses 101-107 may be sequentially arranged along an optical axis OA. Light corresponding to information about an object may pass through the first lens 101 to the seventh lens 107 and the optical filter 500 and be incident on an image sensor 300. The first and second lenses 101 and 102 may be a first lens group LG1, and the third to seventh lenses 103, 104, 105, 106, and 107 may be a second lens group LG2. The first lens 101 is the lens closest to the object. The seventh lens 107 is the lens closest to the image sensor 107.

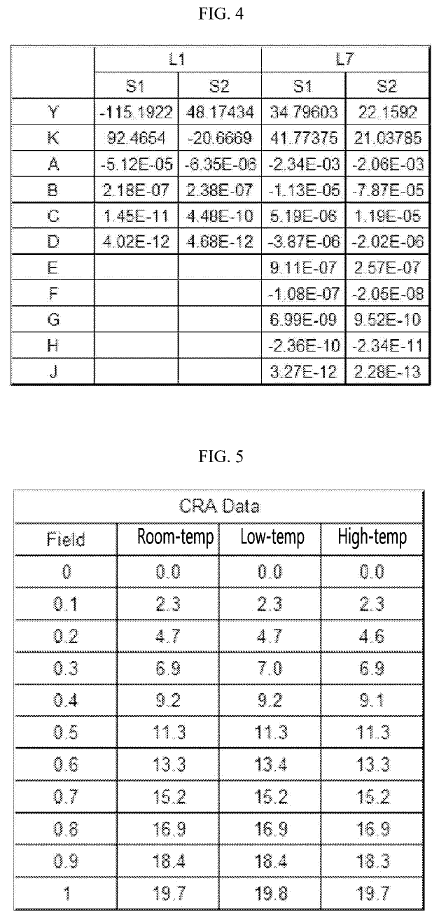

The first lens 101 may have positive (+) or negative (−) refractive power on the optical axis OA. The first lens 101 may have negative (−) refractive power. The first lens 101 may include a plastic material or a glass material, and may be, for example, a glass material. The first lens 101 made of a glass material may reduce changes in the center position and the radius of curvature due to temperature changes according to the surrounding environment, and may protect the incident side surface of the optical system 1000. On the optical axis, the object-side first surface S1 of the first lens 101 may have a concave shape, and the sensor-side second surface S2 may have a concave shape. The first lens 101 may have a shape in which both sides are concave on the optical axis. Alternatively, the first surface S1 may have a convex shape on the optical axis OA, and the second surface S2 may have a concave shape. Alternatively, the first lens 101 may have a convex meniscus shape on the sensor side on the optical axis OA. This first lens 101 may be provided as an aspherical lens made of glass. The aspherical coefficients of the first and second surfaces S1 and S2 may be provided as L1S1 and L1S2 of FIG. 4. The effective radius of the first surface S1 of the first lens 101 may be larger than the effective radii of the object-side surface and the sensor-side surface of the second to seventh lenses 102-107. Since the first surface S1 is concave and the second surface S2 has a concave shape, the incident light is refracted in a direction close to the optical axis OA, and the distance between the first lens 101 and the second lens 102 may be set farther apart. The first surface S1 of the first lens 101 may be provided without a critical point from the optical axis OA to the end of the effective region, i.e., the edge. The second surface S2 of the first lens 101 may be provided without a critical point.

The second lens 102 may be disposed between the first lens 101 and the third lens 103. The second lens 102 may have positive (+) or negative (−) refractive power on the optical axis OA. The second lens 102 may have positive (+) refractive power. The second lens 102 may include a plastic or glass material. For example, the second lens 102 may be made of glass. The object-side third surface S3 of the second lens 102 on the optical axis OA may be convex, and the sensor-side fourth surface S4 may have a convex shape. The second lens 102 may have a shape in which both sides are convex on the optical axis. Alternatively, the second lens 102 may have a meniscus shape that is convex toward the object side. Alternatively, the third surface S3 may be concave, and the fourth surface S4 may have a convex shape. In contrast, the second lens 102 may have a concave shape on both sides. The second lens 102 may be provided as a spherical lens made of glass. The third surface S3 and the fourth surface S4 may be spherical. At least one or both of the third surface S3 and the fourth surface S4 may be provided without a critical point from the optical axis OA to the end of the effective region.

The third lens 103 may have positive (+) or negative (−) refractive power on the optical axis OA. The third lens 103 may have positive (+) refractive power. The third lens 103 may include a plastic or glass material. For example, the third lens 103 may be made of glass. The object-side fifth surface S5 of the third lens 103 based on the optical axis may have a convex shape, and the sensor-side sixth surface S6 may have a convex shape. The third lens 103 may have a shape in which both sides are convex on the optical axis. Alternatively, the third lens 103 may have a meniscus shape convex toward the sensor side or toward the object side. Alternatively, the third lens 103 may have a shape in which both sides are concave on the optical axis. The third lens 103 may be provided as a spherical lens made of glass. The fifth surface S5 and the sixth surface S6 may be spherical. At least one or both of the fifth surface S5 and the sixth surface S6 may be provided without a critical point from the optical axis OA to the end of the effective region.

The aperture stop ST may be disposed around the sensor-side surface of the second lens 102. Alternatively, the aperture stop ST may be disposed around the periphery of the object-side or sensor-side surface of the first lens 101, or around the object-side surface of the second lens 102. The composite focal length of the second to seventh lenses 102-107 may have a positive value, and may reduce the TTL within the field of view range. The object-side second lens 102 and the sensor-side third lens 103 of the aperture stop ST may have a shape in which both sides are convex on the optical axis. Accordingly, the center distance between the second and third lenses 102 and 103 may be reduced. In addition, the center distance between the third and fourth lenses 103 and 104 may also be reduced due to the shape of the third lens 103. Since the third lens 103 adjacent to the sensor side of the above aperture stop ST has positive refractive power (F3>0), the third lens 103 can refract incident light in the direction of the optical axis, and can suppress the increase in the effective diameter of the sensor-side or rear-side lenses of the third lens 103. Accordingly, the yield by weight of the optical system may be prevented from decreasing by the third lens 103, and the production efficiency may be improved. Here, the composite focal length of the third to seventh lenses 103-107 arranged on the sensor side of the aperture stop ST may have a positive value, and the TTL may be reduced within the field of view range.

The fourth lens 104 may have positive (+) or negative (−) refractive power on the optical axis OA. The fourth lens 104 may have positive (+) refractive power. The fourth lens 104 may include a plastic or glass material. For example, the fourth lens 104 may be provided as a glass material. The object-side seventh surface S7 of the fourth lens 104 may have a convex shape on the optical axis, and the sensor-side eighth surface S8 may have a concave shape. The fourth lens 104 may have a meniscus shape that is convex toward the object side. Alternatively, the fourth lens 104 may have a shape in which both sides are convex on the optical axis OA or a meniscus shape that is convex toward the sensor side. Alternatively, the seventh surface S7 may have a concave shape, and the eighth surface S8 may have a concave shape on the optical axis OA. Alternatively, the fourth lens 104 may have a meniscus shape that is convex toward the object side. The fourth lens 104 may be provided as a spherical lens made of glass. The seventh surface S7 and the eighth surface S8 may be spherical. The seventh surface S7 and the eighth surface S8 may be provided without a critical point from the optical axis OA to the end of the effective region.

The fifth lens 105 may have positive (+) or negative (−) refractive power on the optical axis OA. The fifth lens 105 may have negative (−) refractive power. The fifth lens 105 may include a plastic or glass material. For example, the fifth lens 105 may be made of glass. With respect to the optical axis OA, the object-side ninth surface of the fifth lens 105 may have a convex shape, and the sensor-side tenth surface S10 may have a concave shape. The fifth lens 105 may have a meniscus shape that is convex toward the object side on the optical axis OA. Alternatively, the fifth lens 105 may have a meniscus shape that is convex toward the sensor side. Alternatively, the ninth surface on the optical axis OA may have a convex shape on both sides. In contrast, the fifth lens 105 may have a shape in which both sides are concave on the optical axis. The ninth surface and the tenth surface S10 of the fifth lens 105 may be spherical. At least one or both of the ninth surface and the tenth surface S10 may be provided without a critical point from the optical axis OA to the end of the effective region.

The fourth lens 104 and the fifth lens 105 may be bonded and may be defined as a cemented lens 145. The bonded surface between the fourth lens 104 and the fifth lens 105 may be defined as the eighth surface S8. The eighth surface S8 may be the same surface as the ninth surface of the fifth lens 105. When the distance between the fourth and fifth lenses 104 and 105 is G4, G4 may be less than 0.01 mm. The distance G4 between the fourth and fifth lenses 104 and 105 may be less than 0.01 mm from the optical axis OA to the end of the effective region. The fourth and fifth lenses 104 and 105 may have opposite refractive powers. The composite refractive power of the fourth and fifth lenses 104 and 105 may have negative (−) refractive power.

When the composite refractive power of the cemented lens 145 is F45, the composite refractive power of the first and second lenses 101 and 102 is F12, and the composite refractive power of the second to seventh lenses 102-107 is F27, the following condition in absolute value may satisfy: F27<F45<F12. The product of the refractive power of the fourth lens 104 and the refractive power of the fifth lens 105 of the cemented lens 145 may be less than 0. The product of the focal length of the fourth lens 104 of the cemented lens 145 and the focal length of the fifth lens 105 may be less than 0. Accordingly, the aberration characteristics of the optical system may be improved. If the refractive powers of the two lenses of the cemented lens 145 are the same, there is a limit to the improvement of aberration. The composite refractive power of the cemented lens 145 may have negative refractive power, and the third lens 103 close to the object side and the sixth lens 106 close to the sensor side based on the cemented lens 145 may have positive refractive power. Accordingly, the third lens 103, the cemented lens 145, and the sixth lens 106 may refract some of the incident light in the direction of the optical axis, and compensate for various aberrations.

The effective diameter of the fourth lens 104 may be larger than the effective diameter of the fifth lens 105 and may be larger than the diagonal length of the image sensor 300. The effective diameter of the fourth lens 104 is the average of the effective diameters of the seventh surface S7 and the eighth surface S8. The effective diameter of the fifth lens 105 may be smaller than that of the fourth lens 104 and may have a length within a range of ±110% or ±105% of the diagonal length of the image sensor 300. Preferably, the effective diameter of the fifth lens 105 may be larger than the diagonal length of the image sensor 300, for example, may be 110% or less or 105% or less of the diagonal length of the image sensor 300.

The effective diameter of the eighth surface S8 of the fifth lens 105 may be larger than the diagonal length of the image sensor 300, and the effective diameter of the tenth surface S10 may be smaller than the diagonal length of the image sensor 300.

When the fifth and sixth lenses 105 and 106 are spherical lenses, the difference between the effective diameter of the object-side seventh surface S7 of the cemented lens 145 and the effective diameter of the sensor-side tenth surface S10 may be provided as large as possible within the lens portion 100. When the effective diameter of the ninth surface of the fifth lens 105 and the effective diameter of the sensor-side tenth surface S10 are set to CA51 and CA52, the following condition satisfies: CA51>CA52, and the difference between CA51 and CA52 may be the largest among the effective diameter differences between the object-side surfaces and the sensor-side surfaces of each lens. In addition, when the effective diameter of the seventh surface S7 and the effective diameter of the sensor-side eighth surface S8 of the fourth lens 104 are set to CA41 and CA42, the following condition may satisfy: CA41>CA42. Accordingly, the increase in the effective diameter of the sixth and seventh lenses 106 and 107 may be prevented by the fifth lens 105 having a relatively small effective diameter and a concave sensor-side surface.

Since the cemented lens 145 is bonded with spherical glass lenses having different refractive indices, and at least one lens positioned on the sensor side relative to the cemented lens 145 is positioned as an aspherical lens, spherical aberration may be compensated for by the aspherical lens. In addition, since at least one or two or more of the lenses positioned on the sensor side relative to the cemented lens 145 are aspherical lenses and have small effective diameters, light may be refracted to the entire region of the image sensor 300 through the aspherical lens. When the refractive index of the fourth lens 104 is Nd4, the refractive index of the fifth lens 105 is Nd5, the Abbe number of the fourth lens 104 is Vd4, and the Abbe number of the fifth lens 105 is Vd5, the following condition may satisfy: Nd5*Vd5<Nd4*Vd4.

When the radius of curvature of the object-side seventh surface S7 of the cemented lens 145 is L4R1, and the radius of curvature of the sensor-side tenth surface S10 of the cemented lens 145 is L5R2, the following condition may satisfy: |L4R1−L5R2|<10 mm, and preferably, satisfy: |L4R1−L5R2|≤6 mm. The shape of the object-side surface and the sensor-side surface of the cemented lens 145 has a meniscus shape that is convex toward the object side on the optical axis, and by setting the difference in the radius of curvature of the object-side surface and the sensor-side surface to be small, the amount of incident light may be increased and the emitted light may be guided to the effective region of the sixth lens 106 with a small effective diameter. When the refractive index of the fifth lens 105 is Nd5 and the Abbe number is Vd5, and the refractive index of the first lens 101 is Nd1 and the Abbe number is Vd1, the following conditions may satisfy: Nd1<Nd5, and Nd5*Vd5<Nd1*Vd1.

The sixth lens 106 may have positive (+) or negative (−) refractive power on the optical axis OA. The sixth lens 106 may have positive (+) refractive power. The sixth lens 106 may include a plastic or glass material. For example, the sixth lens 106 may be provided as a glass material. With respect to the optical axis OA, the object-side eleventh surface S11 of the sixth lens 106 may be convex, and the sensor-side twelfth surface S12 may be concave. The sixth lens 106 may have a meniscus shape convex toward the object side on the optical axis OA. Alternatively, the sixth lens 106 may have a meniscus shape convex toward the sensor side, or a double-sided convex shape. Alternatively, the sixth lens 106 may have a double-sided concave shape. The eleventh surface S11 and the twelfth surface S12 may be spherical. The eleventh and twelfth surfaces S11 and S12 of the sixth lens 106 may be provided without critical points from the optical axis OA to the ends of the effective regions. Since the object-side surface and the sensor-side surface of the sixth lens 106 are provided without critical points, the effective diameter of the seventh lens 107 may not be increased. In addition, the difference between the effective diameter of the seventh lens 107 and the diagonal length of the image sensor 300 may not be large due to the sixth lens 106. When the effective diameter of the object-side eleventh surface S11 of the sixth lens 106 is CA61 and the effective diameter of the sensor-side twelfth surface S12 of the sixth lens 106 is CA62, the following condition may satisfy: CA62<CA61. If the radius of curvature of the object-side eleventh surface S11 of the sixth lens 106 is L6R1 and the radius of curvature of the sensor-side twelfth surface S12 of the sixth lens 106 is L6R2, the following condition may satisfy: CA61*L6R1<CA62*L6R2. The center thickness of the sixth lens 106 may be larger than the center thickness of the seventh lens 107 and the refractive index may be lowered to suppress color dispersion.

The seventh lens 107 may have positive (+) or negative (−) refractive power on the optical axis OA. The seventh lens 107 may have negative (−) refractive power. The seventh lens 107 may include a plastic or glass material. For example, the seventh lens 107 may be made of a plastic material. The object-side thirteenth surface S13 of the seventh lens 107 on the optical axis may have a convex shape, and the sensor-side fourteenth surface S14 may have a concave shape. The seventh lens 107 may have a meniscus shape that is convex toward the object side on the optical axis. Alternatively, the thirteenth surface S13 on the optical axis OA may have a concave shape, and the fourteenth surface S14 may have a convex shape. Alternatively, the seventh lens 107 may have concave shapes on both sides. The seventh lens 107 may be made of a plastic material and may have aspherical surfaces on both sides. The thirteenth surface S13 and the fourteenth surface S14 have aspherical surfaces, and aspherical coefficients may be provided as L7S1 and L7S2 of FIG. 4. The seventh lens 107 may be an aspherical lens closest to the image sensor 300. By arranging the aspherical lens closest to the image sensor 300, it is possible to prevent a decrease in optical performance, improve aberration characteristics, and control the influence on resolution. In addition, by arranging the aspherical lens as the lens closest to the image sensor 300, it may be insensitive to assembly tolerances compared to spherical lenses. In other words, being insensitive to assembly tolerances means that even if the assembly is slightly different from the design during assembly, it may not significantly affect the optical performance.

In the sixth lens 106, if the maximum Sag value of the object-side surface is Sag61 and the maximum Sag value of the sensor-side surface is Sag62, the following condition may satisfy: 0<Sag61−Sag62<0.7 mm. Accordingly, the difference in thickness between the center and edge of the sixth lens 106 is not large, and the influence on the optical characteristics may be suppressed. In the case where the maximum Sag value of the object-side surface of the seventh lens 107 is Sag71 and the maximum Sag value of the sensor-side surface is Sag72, the following condition may satisfy: 0<|Sag71|−|Sag72|<0.4 mm. Accordingly, since the thickness difference between the center and edge of the seventh lens 107 is not large and the radius of curvature is not large, the influence on the optical characteristics may be suppressed. Since the first and seventh lenses 101 and 107 are arranged as aspherical lenses, the deterioration of optical performance may be prevented, the number of lenses may be reduced, and the TTL of the optical system may be reduced.

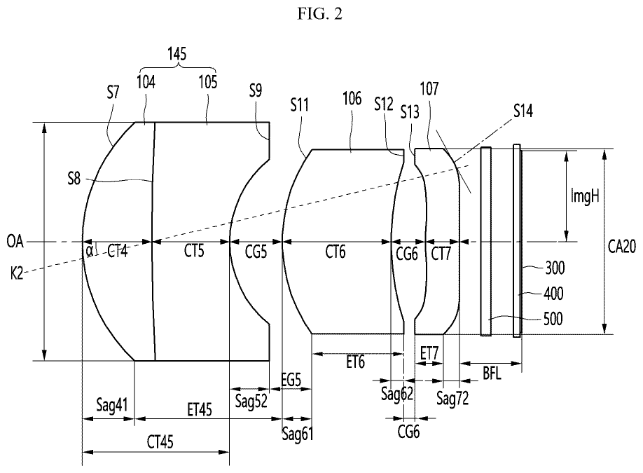

Referring to FIG. 2, at least one or both of the thirteenth surface S13 and the fourteenth surface S14 of the seventh lens 107 may have a critical point. The thirteenth surface S13 of the seventh lens 107 may have at least one critical point from the optical axis OA to the end of the effective region. Since the thirteenth surface S13 and the fourteenth surface S14 of the seventh lens 107 have critical points, light may be provided to the entire region of the image sensor 300. The critical point of the thirteenth surface S13 may be located at a position of 2.2 mm or less from the optical axis OA, for example, in the range of 1.5 mm to 2.2 mm. As another example, the thirteenth surface S13 may be provided without a critical point. The fourteenth surface S14 of the seventh lens 107 may have at least one critical point from the optical axis OA to the end of the effective region. The critical point of the fourteenth surface S14 may be located at a position of 2 mm or more from the optical axis OA, for example, in the range of 2 mm to 2.8 mm. Since the critical point of the fourteenth surface S14 is located closer to the edge than the critical point of the thirteenth surface S13 with respect to the optical axis, the fourteenth surface S14 may refract light to the periphery of the image sensor 300.

The BFL (Back focal length) is the optical axis distance from the surface of the image sensor 300 to the center of the sensor-side surface of the last lens. The tangent line K1 passing through an arbitrary point of the fourteenth surface S14 of the seventh lens 107 and the normal line K2 perpendicular to the tangent line K1 may have a predetermined angle θ1 with the optical axis OA. The maximum tangent angle θ1 on the fourteenth surface S14 in the first direction X may be 45 degrees or less, for example, in a range of 5 degrees to 45 degrees or in a range of 15 degrees to 35 degrees. CT7 is the center thickness of the seventh lens 107, and ET7 is the edge thickness of the seventh lens 107. CT6 is the center thickness of the sixth lens 106, and ET6 is the edge thickness of the sixth lens 106. The edge thickness is the distance in the optical axis direction between the object-side surface and the sensor-side surface at the end of the effective region of each lens. CG6 is the optical axis distance (i.e., center distance) from the center of the sixth lens 106 to the center of the seventh lens 107. That is, CG6 is the distance from the center of the twelfth surface S12 to the center of the thirteenth surface S13. EG6 is the distance in the optical axis direction from the edge of the sixth lens 106 to the edge of the seventh lens 107 (i.e., edge distance). The center thickness of the cemented lens 145 is CT45, which is the optical axis distance from the center of the object-side surface of the fourth lens 104 to the center of the sensor-side surface of the fifth lens 105. The edge thickness of the cemented lens 145 is ET45, which is the optical axis distance from the edge of the object-side surface of the fourth lens 104 to the edge of the sensor-side surface of the fifth lens 105.

If the Sag value of the object-side surface of the fourth lens 104 is Sag41, the Sag value of the sensor-side surface of the fifth lens 105 is Sag51, the Sag value of the object-side surface of the sixth lens 106 is Sag61, the Sag value of the sensor-side surface of the sixth lens 106 is Sag62, the Sag value of the object-side surface of the seventh lens 107 is Sag71, and the Sag value of the sensor-side surface of the seventh lens 107 is Sag72, the following condition in absolute values satisfies: Max_Sag52<Max_Sag41, the following condition satisfies: Max_Sag61<Max_Sag52, and the following condition may satisfy: Max_Sag72<Max_Sag 71<Max_Sag52<Sag41. In this way, by adjusting the lens surface from the center to the edge of the fifth to seventh lenses 105-107, the incident light may be guided to the entire region of the image sensor 300. Here, the Max_Sag value is the maximum distance in the direction of the optical axis from a straight line perpendicular to the center of the object-side surface or the sensor-side surface of each lens to the lens surface, and the Sag value may have a negative value when it is located on the object-side surface more than the center, and may have a positive value when it is located on the sensor-side surface more than the center.

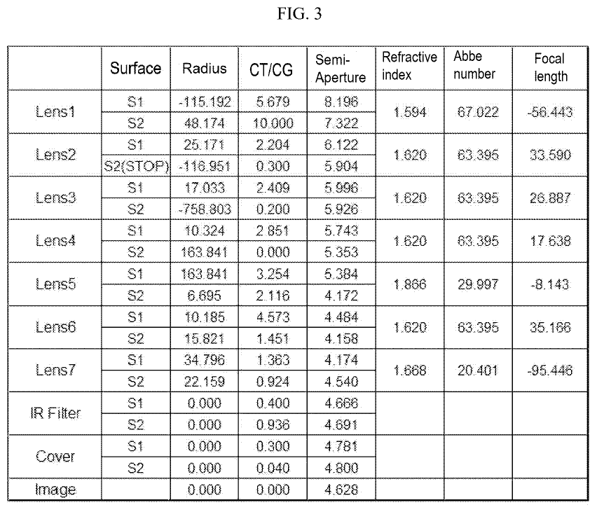

FIG. 3 is an example of lens data of the optical system of the embodiment of FIG. 1. As shown in FIG. 3, the radius of curvature on the optical axis OA of the first to seventh lenses 101-107, the center thickness CT of each lens, the center distance CG between adjacent lenses, the refractive index in the d-line, the Abbe number, and the size of the effective radius (Semi-aperture) may be set. When the radius of curvature of each lens is expressed as an absolute value on the optical axis, the radius of curvature of the eighth surface S4 of the fourth lens 104 on the optical axis OA may be the largest among the lenses, and the radius of curvature of the tenth surface S10 of the fifth lens 105 may be the smallest among the lenses. The difference between the maximum radius of curvature and the minimum radius of curvature may be 10 times or more, for example, 15 times or more.

When the radius of curvature of each lens on the optical axis is expressed as an absolute value, the radius of curvature of the first lens 101 on the optical axis may be smaller than the radius of curvature of the second lens 102 arranged on the sensor side of the aperture stop ST and the radius of curvature of the third lens 103 arranged on the object side. Here, the radius of curvature is an average of the absolute values of the radii of curvature of the object-side surface and the sensor-side surface of each lens. The absolute value of the radius of curvature of the object-side surface of the i-th lens is Roi, the absolute value of the radius of curvature of the sensor-side surface is Rsi, and the absolute value of the average of the object-side surface and the sensor-side surface is Ri, and the value of (Roi−Rsi)/Ri may be minimum when i is 6 and maximum when i is 3. Here, when i is 6 or 7, the value of (Roi−Rsi)/Ri may be 0.5 or less. Accordingly, the difference in the curvature radius of the object-side surface and the sensor-side surface of the plastic seventh lens 107 may be smaller than the difference in the curvature radius of the object-side surface and the sensor-side surface of the first to fifth lenses 101-105.

The curvature radius of the sixth lens 106 in the optical axis may be smaller than the curvature radius of the first lens 101. Since the sixth lens 106 is spherical and the curvature radius is provided smaller than the curvature radius of the first lens 101, the entire region may be provided with a uniform light distribution. The curvature radius of the seventh lens 107 in the optical axis may be smaller than the curvature radius of the first lens 101. Since the seventh lens 107 is aspherical and the curvature radius is provided smaller than the curvature radius of the first lens 101, the entire region may be provided with a uniform light distribution.

The absolute value of the curvature radius of the object-side surface of the i-th lens is Roi, the absolute value of the curvature radius of the sensor-side surface is Rsi, and the absolute value of the average of the object-side surface and the sensor-side surface means Ri, and the value of Roi/Rsi may be the largest when i is 5 and the smallest when i is 3.

The curvature radii of the first and second surfaces S1 and S2 of the first lens 101 are defined as L1R1 and L1R2, the curvature radii of the thirteenth and fourteenth surfaces S13 and S14 of the seventh lens 107 are defined as L7R1 and L7R2, and the curvature radii of the respective lens surfaces of the second to sixth lenses 102-106 may be defined as L2R1, L2R2, L3R1, L3R2, L4R1, L4R2 (L5R1), L5R2, L6R1, and L6R2. The ratio of the curvature radius of the object-side surface of each lens to the curvature radius of the sensor-side surface may satisfy the following conditions:
Condition 1:1.5<|L1R1/L1R2|<3, Condition 2:0<|L2R1/L2R2|<0.5
Condition 3: 0<L3R1/L3R2<0.2, Condition 4: 0<L4R1/L4R2<0.3
Condition 5: 10<L5R1/L5R2<30, Condition 6: 0<L6R1/L6R2<1
Condition 7: 1<L7R1/L7R2<2.2

If the center thickness of the first to seventh lenses 101-107 is defined as CT1-CT7, and the edge thickness of the first to seventh lenses 101-107 is defined as ET1-ET7, the sum of the center thicknesses of the first to seventh lenses 101-107 may be defined as ΣCT, and the sum of the edge thicknesses of the first to seventh lenses 101-107 may be defined as ΣET. When explaining the thickness of the lenses, the center thickness CT1 of the first lens 101 may be greater than the center thicknesses CT2-CT7 of the second to seventh lenses 102-107, and may have the maximum thickness within the lens portion 100. The center thickness CT7 of the seventh lens 107 may be the smallest within the lens portion 100, and may satisfy the condition: CT7<CT4<CT6<CT1. The ratio of the center thickness and the edge thickness of each lens may satisfy the following conditions.
Condition 1:0.6<CT1/ET1<1.2, Condition 2: 1<CT2/ET2<2
Condition 3:1.2<CT3/ET3<2.5, Condition 4:1.5<CT4/ET4<3
Condition 5:0<CT5/ET5<1.2, Condition 6:0.6<CT6/ET6<2
Condition 7:0.4<CT7/ET7<1.2, Condition 8:0.5<ΣCT/ΣET<1.2 or 1<ΣCT/ΣET<1.2

By the above conditions, the difference between the center thickness and the edge thickness of each lens may be effectively guided without increasing. In addition, the difference between the maximum center thickness and the minimum center thickness in the lenses may be 3 mm or more, for example, in the range of 3 mm to 5 mm. That is, even if the center thickness of the last aspherical lens is provided thinly, the optical performance may not deteriorate, and the thickness of the camera module may be provided slimly.

The relationship between the center of each lens and the TTL may satisfy the following conditions.
Condition 1:0.10<CT1/TTL<0.3, preferably, Condition 1 may satisfy: 0.10≤CT1/TTL≤0.2.
Condition 2:0<CT2/TTL<0.1, Condition 3: 0<CT3/TTL<0.09
Condition 4:0<CT4/TTL<0.1, Condition 5: 0<CT5/TTL<0.1
Condition 6:0.05<CT6/TTL<0.2, Condition 7: 0<CT7/TTL<0.07

The ratio of CT1/TTL of Condition 1 may be greater than the values of Conditions 2 to 7. The center thickness CT1 of the first lens 101 may be greater than the sum of the center thicknesses of the adjacent second and third lenses.

The relationship between the cemented lens 145 and the first and sixth lenses 101 and 106 may satisfy the following conditions. Condition 1:0.4<CT1/CT45<1.2 or 0.4<CT1/CT45<1
Condition 2:1<CT1/CT6<1.8, Condition 3:0.1<CT1/ΣCT<0.4
Condition 4:0.10<CT45/ΣCT<0.3, Condition 5:0.15<CT6/CT<0.35

ΣCT is the sum of the center thicknesses of the lenses, and CT45 is the sum of the center thicknesses of the fourth and fifth lenses. By setting the center thickness and edge thickness of the first to seventh lenses 101-107 to the above-mentioned conditions, light may be guided to an optimal path according to the refractive index, Abbe number, and radius of curvature of each lens within the optical system 1000.

The center distance between the first to seventh lenses 101-107 is defined as CG1-CG6, and the sum of the center distances between the first to seventh lenses 101-107 may be defined as ΣCG. Here, the center distance between the lenses is described excluding the distance between two lenses in the cemented lens. The center distance CG1 between the first and second lenses 101 and 102 is maximum, and the center distance CG3 between the third and fourth lenses 103 and 104 is minimum. The center distance between the spherical lenses and the aspherical lenses is larger than the center distance between the spherical lenses. The center thickness of each lens and the center distance between adjacent lenses may satisfy the following conditions. Condition 1:0<CT1/CG1<1, Condition 2: 2<CT2/CG2<10, Condition 3: 5<CT3/CG3<20, Condition 4:4<CT45/CG5<12, Condition 5:0.5<CG1/2CG<1

By providing the maximum center thickness between lenses to be smaller than the maximum center distance, a camera module applying an aspherical lens to the output side of the optical system may be provided without increasing the center distance of other lenses. The center distance CG1 between the first and second lenses 101 and 102 may be larger than the sum of the center thicknesses of the two adjacent lenses. In addition, the center distance CG1 between the first and second lenses 101 and 102 may satisfy the conditions: CT2+CT3+CT4<CG1, CT3+CT4+CT5<CG1, CT4+CT5+CT6<CG1, and CT5+CT6+CT7<CG1. The center distance CG1 between the first and second lenses 101 and 102 may be 1.5 times or more the center thickness of the cemented lens 145. Since the center distance CG1 between the first and second lenses 101 and 102 satisfies the conditions, the optical characteristics of the second to seventh lenses 102-107 may be easily controlled. Here, if the i-th center distance between adjacent two lenses is defined as CGi, and the center thickness of the i-th lens positioned closer to the object than CGi is defined as CTi, the following conditions may be satisfied (here, the center thickness of the cemented lens and the distance between the cemented lenses are excluded). CGi is the center distance between the i-th lens and the i+1 lens. The ratio of CTi/CGi may be minimum when i is 1 and maximum when i is 3.

Regarding the effective diameter, the lens having the maximum effective diameter may be the first lens 101 closest to the object. The first lens 101 having the maximum effective diameter may be a spherical lens. The lens having the minimum effective diameter may be the lens closest to the image sensor 300, for example, the seventh lens 107. The effective diameters of the first lens 101 to the seventh lens 107 may be defined as CA1, CA2, CA3, CA4, CA5, CA6, and CA7, the effective diameters of the first and second surfaces S1 and S2 of the first lens 101 may be defined as CA11 and CA12, the effective diameters of the thirteenth and fourteenth surfaces S13 and S14 of the seventh lens 107 may be defined as CA71 and CA72, and the effective diameters of the object-side surface and the sensor-side surface of the second to sixth lenses may be defined as CA21, CA22, CA31, CA32, CA41, CA42, CA51, CA52, CA61 and CA62. The effective diameters may satisfy the following conditions.
Condition 1: CA22<CA12, Condition 2: CA71<CA72, Condition 3: CA31<CA22, and
Condition 4: CA61<CA51<CA41

If the refractive index is explained, the refractive index of the fifth lens 105 is the largest among the lenses and may be greater than 1.70, for example, 1.75 or more. The refractive index of the first lens 101 is the smallest among the lenses. The difference between the maximum refractive index and the minimum refractive index may be greater than 0.20, for example, 0.25 or more. By adjusting the refractive indices of the spherical lens and the aspherical lens, the incident efficiency may be increased and the incident light may be guided to the image sensor 300.

If the Abbe number is explained, the Abbe number of the first lens 101 is the largest among the lenses and may be 55 or more. The Abbe numbers of the first lens 111 to the fourth lens 114 are 50 or more, and the difference between them may be 10 or less. The Abbe number of the seventh lens 107 is the smallest among the lenses. The difference between the maximum Abbe number and the minimum Abbe number may be 30 or more. The Abbe number of the third and fourth lenses 103 and 104 adjacent to the aperture stop ST is made larger than the Abbe number of the fifth lens 105, and the Abbe number of the seventh aspherical lens 107 closest to the image sensor 300 is made the smallest, thereby controlling the color dispersion of light traveling between the glass lenses and increasing the color dispersion between the spherical lens and the aspherical lens to guide it to the image sensor 300.

If the average effective diameter of the spherical lens is SSL_CA_Aver and the average effective diameter of the aspherical lens is ASL_CA_Aver, the following condition may satisfy: ASL_CA_Aver<SSL_CA_Aver. The average of the center thickness of the spherical lens is SSL_CT_Aver, and if the average of the center thickness of the aspherical lens is ASL_CT_Aver, the following condition may satisfy: SSL_CT_Aver<ASL_CT_Aver.

The average of the refractive index of the spherical lens is SSL_Nd_Aver, and if the average of the refractive index of the aspherical lens is ASL_Nd_Aver, the following condition may satisfy: ASL_Nd_Aver<SSL_Nd_Aver.

The average of the Abbe number of the spherical lens is SSL_Ad_Aver, and if the average of the Abbe number of the aspherical lens is ASL_Ad_Aver, the following condition may satisfy: ASL_Ad_Aver<SSL_Ad_Aver.

The focal lengths F1, F5, and F7 of the first, fifth, and seventh lenses 101, 105, and 107 may have negative refractive power, and the focal lengths F2, F3, F4, and F6 of the second, third, fourth, and sixth lenses 102, 103, 104, and 106 may have positive refractive power. In addition, the sixth and seventh lenses 106 and 107, which are adjacently arranged lenses, may satisfy the following conditions.
Condition 1: Refractive index of lens with positive refractive power<Refractive index of lens with negative refractive power
Condition 2: Dispersion value of lens with positive refractive power>Dispersion value of lens with negative refractive power

Here, since the sixth lens 106 has positive refractive power and the seventh lens 107 has negative refractive power, according to the conditions 1 and 2, the refractive index of the sixth lens 106 is smaller than the refractive index of the seventh lens 107, and the dispersion value of the sixth lens 106 is larger than the dispersion value of the seventh lens 107. The chromatic aberration occurring in the fourth and fifth lenses may be corrected by the seventh lens having an aspherical surface. In addition, by satisfying the refractive index difference between the sixth and seventh lenses 106 and 107 arranged sequentially to be 0.2 or less and the Abbe number difference to be 20 or more and 60 or less, the chromatic aberration occurring in the spherical lens may be compensated for by the aspherical lens.

The optical system 1000 generates chromatic aberration and corrects the chromatic aberration by using a cemented lens 145 or two lenses arranged in series. The lens contracts and expands repeatedly as the temperature changes from low to high. Since the lens characteristics of lenses of the same material change in accordance with the temperature change in the same amount, it is effective to correct the chromatic aberration between lenses of the same material even when the temperature changes. The chromatic aberration between the spherical lens and the aspherical lens may be mutually corrected by using the fourth, fifth, and sixth lenses 104, 105, and 106 and the seventh lens 107. The refractive index difference between the fourth lens 104 and the fifth lens 105, which are cemented lenses, satisfies 0.01 or more and 0.30 or less, and the Abbe number difference satisfies 20 or more and 45 or less, and the chromatic aberration generated in the spherical lenses may be compensated for by the spherical lens. The refractive index difference is rounded off to the third decimal place, and the Abbe number difference is rounded off to the first decimal place, and the values are compared. In addition, by arranging glass lenses with relatively high Abbe numbers on the object side of the seventh lens 107 having an aspherical surface, color dispersion may be reduced by the glass lenses, and color dispersion may be increased by the last aspherical lens.

When the focal length is expressed as an absolute value, the focal length of the first lens 101 may be 40 or more. The focal length of the fifth lens 105 is the minimum among the lenses. The focal length of the seventh lens 107 is the maximum among the lenses, and is 65 or more. The difference between the maximum focal length and the minimum focal length may be 55 or more. By making the focal length of the lens closest to the sensor the largest and providing the focal length of the bonded fifth lens 105 the smallest, improved MTF characteristics, aberration control characteristics, resolution characteristics, etc. may be achieved in the set field of view range in the optical system, and good optical performance may be achieved in the periphery portion of the field of view. The sensor side surface of the seventh lens 107 has a Sag value that increases from the optical axis to a point of 2.4 mm±0.4 mm in a direction perpendicular to the optical axis, and then decreases toward the edge from a point of 2.4 mm±0.4 mm. If a critical point exists on the sensor side surface of the seventh lens 107, that is, the sensor side of the last lens, that is, the lens surface closest to the sensor, TTL may be reduced, making it easy to miniaturize and lighten the optical system.

As shown in FIG. 4, among the lenses of the lens portion 100 in the first embodiment, the lens surfaces of the first and seventh lenses 101 and 107 may include aspherical surfaces having a 30th-order aspherical coefficient. For example, the first and seventh lenses 101 and 107 may include lens surfaces having a 30th-order aspherical coefficient. As described above, since the aspherical surface having a 30th-order aspherical coefficient (a value other than “0”) can significantly change the aspherical shape of the periphery, the optical performance of the periphery portion of the field of view (FOV) may be well corrected. As shown in FIG. 5, the thickness T1-T7 of the first to seventh lenses 101-107 and the distance G1-G6 between two adjacent lenses may be set. As shown in FIG. 5, the thickness T1-T7 of each lens in the Y-axis direction perpendicular to the optical axis may be expressed at intervals of 0.1 mm or 0.2 mm or more from the optical axis, and the interval G1-G6 between each lens may be expressed at intervals of 0.1 mm or 0.2 mm or more from the optical axis.

The center thickness CT45 of the cemented lens 145 may be greater than the edge thickness ET45. The center thickness CT45 of the cemented lens 145 is the distance in the optical axis direction from the center of the object-side seventh surface S7 of the fourth lens 104 to the center of the tenth surface S10 of the fifth lens 105, and the edge thickness ET45 is the distance in the optical axis direction from the end of the effective region of the seventh surface S7 to the tenth surface S10. The maximum thickness of the bonding lens 145 is at the center, the minimum thickness is at the edge, and the maximum thickness may be at least 1 time of the minimum thickness, for example, in the range of 1 to 1.5 times. The maximum thickness of the sixth lens 106 is at the center, the minimum thickness is at the edge, and the maximum thickness may be at most 1.5 times of the minimum thickness. The maximum thickness of the seventh lens 107 is at the edge, the minimum thickness is at the center, and the maximum thickness may be at most 1.5 times of the minimum thickness.

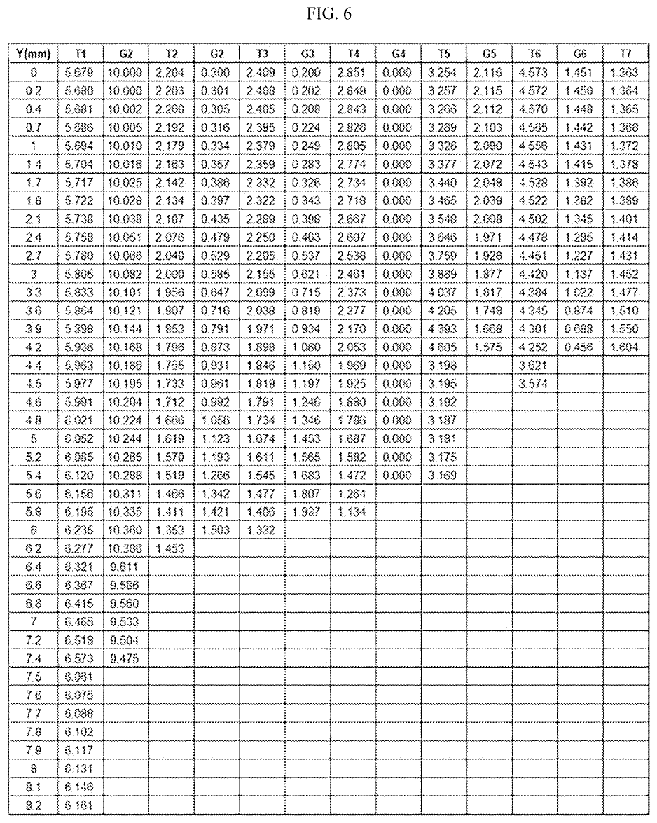

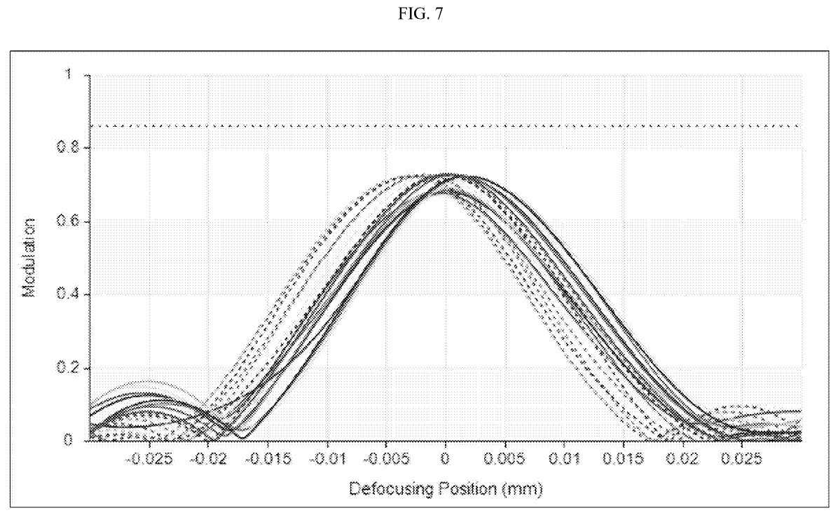

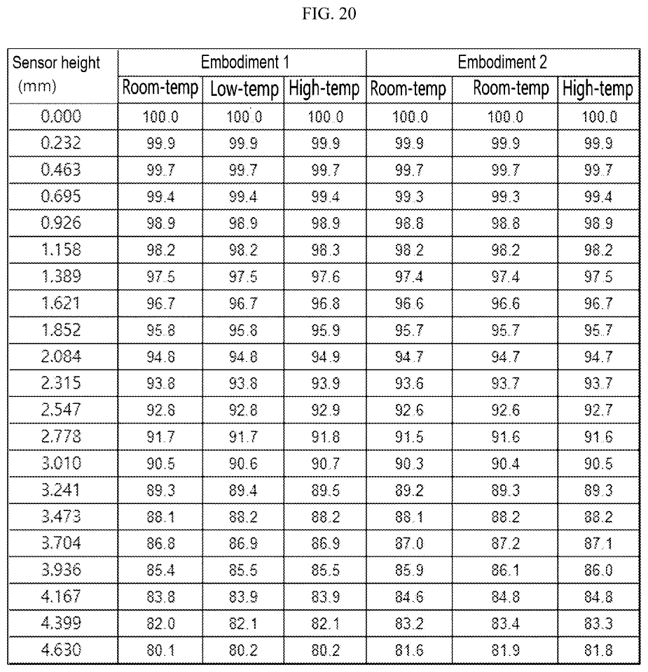

As shown in FIG. 6, in the optical system and camera module of FIG. 1, the chief ray angle (CRA) may be at least 10 degrees, for example, in the range of 10 to 35 degrees or in the range of 10 to 25 degrees. As shown in FIG. 20, a graph showing the relative illumination according to the image height in the optical system according to the embodiment shows that the relative illumination is 80% or more, for example, 84% or more, from the center of the image sensor to the diagonal end according to the temperature changes of room temperature (Room_temp), low temperature (Low_temp), and high temperature (High_tmep). That is, it may be seen that the difference in the relative illumination according to the temperature change is almost the same up to 4.6 mm from the optical axis.

FIGS. 7 to 9 are graphs showing the diffraction MTF (Modulation Transfer Function) at room temperature, low temperature, and high temperature in the optical system of FIG. 1, and are graphs showing the modulation according to the spatial frequency. As shown in FIGS. 7 to 9, in the first embodiment of the invention, the deviation of the MTF between the low temperature and the high temperature based on the room temperature may be less than 10%, that is, 7% or less.

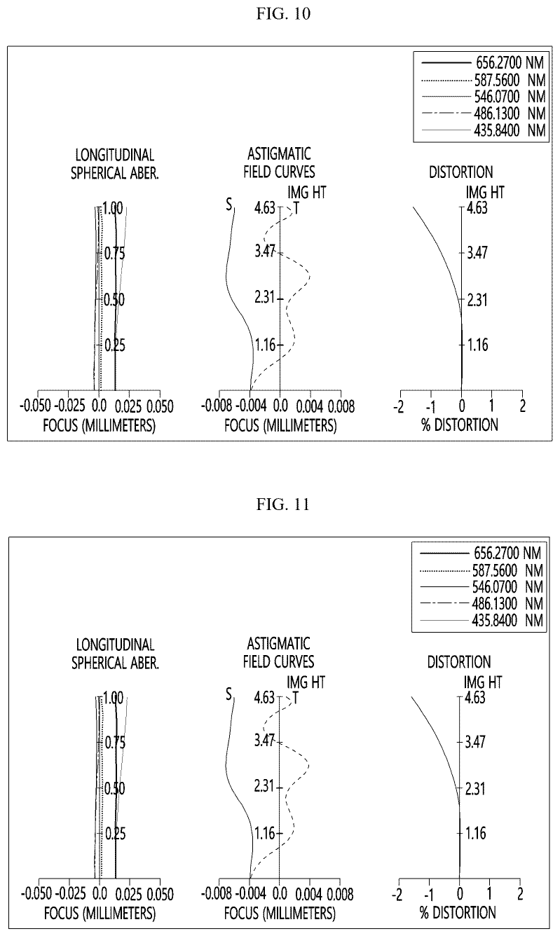

FIGS. 10 to 12 are graphs showing aberration characteristics at room temperature, low temperature, and high temperature in the optical system of FIG. 1. In the aberration graphs of FIGS. 10 to 12, spherical aberration (longitudinal spherical aberration), astigmatic field curves, and distortion are measured from left to right. In FIGS. 10 to 12, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagrams of FIGS. 10 to 12, the closer each curve at room temperature, low temperature, and high temperature is to the Y-axis, the better the aberration correction function may be interpreted. It may be seen that the optical system 1000 according to the embodiment has measurement values close to the Y-axis in almost all regions. That is, the optical system 1000 according to the embodiment has improved resolution and may have good optical performance not only in the center of the FOV but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature may be in the range of 85 degrees or higher, for example, in the range of 85 degrees to 105 degrees. Accordingly, it may be seen that the decrease in the luminance ratio (modulation) from the low temperature to the high temperature of FIGS. 10 to 12 is less than 10%, for example, 5% or lower, or is almost unchanged.

Table 1 compares the changes in optical characteristics such as EFL, BFL, F number, TTL, and diagonal FOV at room temperature, low temperature, and high temperature in the optical system according to the first embodiment, and it may be seen that the change rate of optical characteristics at low temperature is 5% or less, for example, 3% or less, based on room temperature, and it may be seen that the change rate of optical characteristics at low temperature is 5% or less, for example, 3% or less, based on room temperature.

TABLE 1

| | | | | Low temperature/ | High temperature/ |
|---|---|---|---|---|---|
| | Room | Low | High | Room temperature | Room temperature |
| | temperature | temperature | temperature | (%) | (%) |
| EFL | 15.2 | 15.2 | 15.2 | 99.87% | 100.18% |
| BFL | 2.6 | 2.6 | 2.6 | 99.88% | 100.14% |
| F# | 1.6 | 1.6 | 1.6 | 100.00% | 100.00% |
| TTL | 39 | 39 | 39 | 99.90% | 100.12% |
| FOV | 24.1 | 24.2 | 24.1 | 100.11% | 99.86% |

Therefore, as shown in Table 1, the change in optical characteristics according to the temperature change from low temperature to high temperature, for example, the change rate of the effective focal length (EFL), TTL, BFL, F number (F #), and diagonal FOV is 10% or less, that is, 5% or less, for example, in the range of 0 to 5%. This means that even if at least one or two or more aspherical lenses are used, the temperature compensation for the aspherical lens may be designed to prevent the reliability of the optical characteristics from deteriorating. In addition, it may be seen that even if the temperature changes from room temperature to low or high temperature, the effective focal length, TTL, BFL, F number (F #), and diagonal FOV hardly change. The optical system of the embodiment disclosed above can effectively control aberration characteristics such as chromatic aberration and distortion aberration, and may have good optical performance not only in the center portion but also in the periphery portion of the FOV.

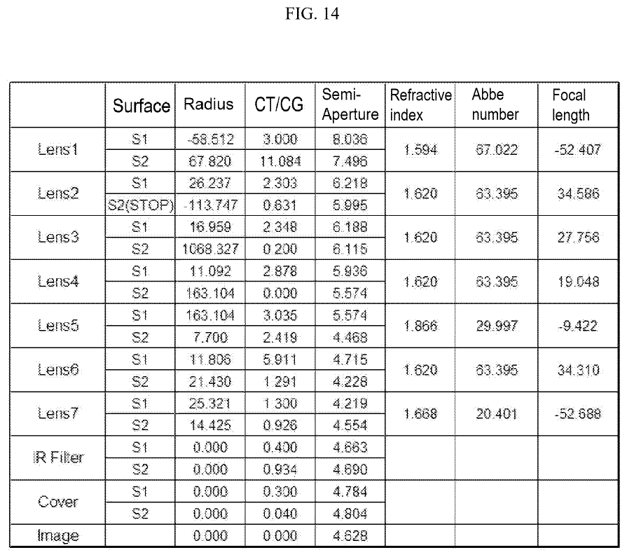

The optical system according to the second embodiment of the invention will be described with reference to FIGS. 13 to 18. The configuration of the second embodiment will be described with reference to the first embodiment, and the configurations different from the first embodiment will be described. Referring to FIGS. 13 and 14, the optical system 1000 according to the second embodiment includes a lens portion 100A, and the lens portion 100A may include a first lens 111 to a seventh lens 117. The first and second lenses 111 and 112 may be a first lens group LG1, and the third to seventh lenses 113, 114, 115, 116, and 117 may be a second lens group LG2.

The first lens 111 may have negative (−) refractive power and may be made of glass. The first surface S1 on the object side of the first lens 111 based on the optical axis may be concave, and the second surface S2 on the sensor side may have a concave shape. The first lens 111 is made of an aspherical glass material, has high transmittance and refractive index, and is provided with a thick thickness, thereby preventing deterioration of the optical characteristics of the incident lens and protecting the surface.

The second lens 112 may have positive (+) refractive power on the optical axis OA and may be made of a spherical glass material. The third surface S3 of the second lens 112 based on the optical axis OA may be convex, and the fourth surface S4 may have a convex shape. The aperture stop ST may be disposed around the sensor-side surface of the second lens 112. The third lens 113 may have positive (+) refractive power on the optical axis OA and may include a glass material. The object-side fifth surface S5 of the third lens 113 based on the optical axis may have a convex shape, and the sensor-side sixth surface S6 may have a concave shape. The third lens 113 may be provided as a spherical lens made of glass.

The fourth lens 114 may have positive (+) refractive power on the optical axis OA and may include a spherical glass material. The object-side seventh surface S7 of the fourth lens 114 based on the optical axis may be convex, and the sensor-side eighth surface S8 may have a concave shape. The fifth lens 115 may have negative (−) refractive power on the optical axis OA and may be provided as a spherical glass material. The object-side ninth surface of the fifth lens 115 based on the optical axis OA may be convex, and the sensor-side tenth surface S10 may have a concave shape. The fourth lens 114 and the fifth lens 115 may be joined and defined as a cemented lens 145A. The fourth and fifth lenses 114 and 115 may have opposite refractive powers. The composite refractive power of the fourth and fifth lenses 114 and 115 may have positive refractive power. When the composite refractive power of the cemented lens 145A is F45, the composite refractive power of the first and second lenses 101 and 102 is F12, and the composite refractive power of the third to seventh lenses 103-107 is F37, the following condition in absolute value may satisfy: F37<F45<F12.

The effective diameter of the fourth lens 114 may be larger than the diagonal length of the image sensor 300. The effective diameter of the fifth lens 115 may be smaller than that of the fourth lens 114 and may have a length within a range of ±110% of the diagonal length of the image sensor 300. For example, the effective diameter of the tenth surface S10 of the fifth lens 115 may be smaller than the diagonal length of the image sensor 300. Since the position of the cemented lens 145A is located between spherical lenses, chromatic aberration correction may be more efficient by the seventh lens 117.

The sixth lens 116 may have positive (+) refractive power on the optical axis OA and may be provided with a glass material. With respect to the optical axis OA, the eleventh surface S11 of the sixth lens 116 on the object side may be convex, and the twelfth surface S12 on the sensor side may be concave. The sixth lens 116 may be made of glass and may have spherical surfaces on both sides. Since the eleventh surface S11 and the twelfth surface S12 are made of spherical glass, the light refractive efficiency may be improved, and the thickness may be increased to improve the assemblability. In addition, the sixth lens 116 made of glass with a thick thickness can prevent deterioration of optical characteristics by performing heat compensation according to temperature change. Since the sixth lens 116 is arranged between the spherical lens and the aspherical lens, it can prevent deterioration of optical performance, and control the influence on the improvement of aberration characteristics and resolution. The seventh lens 117 may have negative (−) refractive power on the optical axis and may be provided as an aspherical plastic lens. The object-side thirteenth surface S13 of the seventh lens 117 on the optical axis may have a convex shape, and the sensor-side fourteenth surface S14 may have a concave shape. The above seventh lens 117 may be made of plastic material and may have aspherical surfaces on both sides.

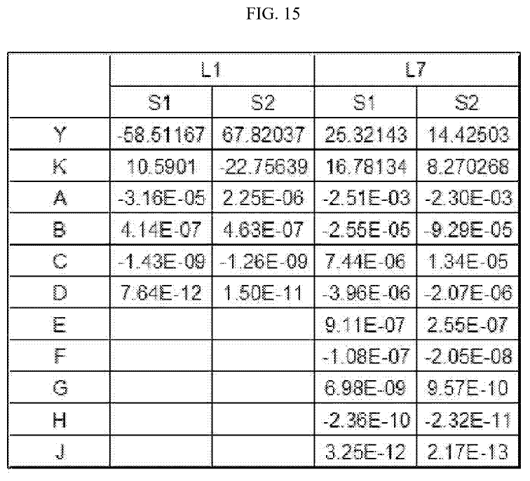

The first and second surfaces S1 and S2 of the first lens 111, and the thirteenth surface S13 and the fourteenth surface S14 of the seventh lens 117 have aspherical surfaces, and the aspherical coefficients may be provided as S1, S2 of L1, L7 of FIG. 15.

The thirteenth surface S13 of the seventh lens 117 may have at least one critical point from the optical axis OA to the end of the effective region. The critical point of the thirteenth surface S13 may be located at a position less than or equal to 2.5 mm from the optical axis OA, for example, in a range of 1.7 mm to 2.5 mm. As another example, the thirteenth surface S13 may be provided without a critical point. The fourteenth surface S14 of the seventh lens 117 may have at least one critical point from the optical axis OA to the end of the effective region. The critical point of the fourteenth surface S14 may be located closer to the edge than the critical point of the thirteenth surface S13 and may be located at a position more than or equal to 2.5 mm from the optical axis OA, for example, in a range of 2.5 mm to 3.3 mm. Since the above fourteenth surface S14 and the above thirteenth surface S13 have critical points, they can refract the incident light to the periphery of the image sensor 300. When the maximum Sag value of the object-side surface of the above seventh lens 117 is Sag71 and the maximum Sag value of the sensor-side surface is Sag72, the following condition may satisfy: 0<|Sag71|-|Sag72|<0.4 mm. Accordingly, since the thickness difference between the center and edge of the seventh lens 117 is not large and the radius of curvature is not large, the influence on the optical characteristics may be suppressed. Since the above seventh lens 117 is arranged as a spherical lens, it is resistant to temperature changes, can reduce the number of lenses, and can reduce the TTL of the optical system.

FIG. 14 is an example of lens data of the optical system of the embodiment of FIG. 13. As shown in FIG. 14, the curvature radius on the optical axis OA of the first to seventh lenses 111-117, the center thickness CT of the lenses, the center distance CG between adjacent lenses, the refractive index in the d-line, the Abbe number, and the size of the clear aperture CA may be set. The absolute value of the curvature radius of the first lens 111 on the optical axis may be smaller than the absolute value of the curvature radius of the second lens 112 arranged on the object side of the aperture stop ST. The absolute value of the curvature radius of the object-side surface of the i-th lens is Roi, the absolute value of the curvature radius of the sensor-side surface is Rsi, and the absolute value of the average of the object-side surface and the sensor-side surface means Ri, and the value of (Roi-Rsi)/Ri may be minimum when i is 7 and maximum when i is 3. Here, when i is 6,7, the value of (Roi-Rsi)/Ri may be less than 1, for example, 0.8 or less. Accordingly, each of the plurality of aspherical lenses may have a difference in the curvature radius of the object-side surface and the sensor-side surface from the average of the curvature radii of each aspherical lens smaller than that of the spherical lenses. Since the first lens 111 is provided as an aspherical lens having a thick thickness, the curvature radius of the first lens 111 on the optical axis may be increased more than that of the sixth and seventh lenses 116 and 117, and the difference in the curvature radii of the object-side surface and the sensor-side surface may not be large, and the assemblability may be improved.

The curvature radius of the seventh lens 117 in the optical axis may be smaller than that of the aspherical first lens 111. Accordingly, the aspherical seventh lens 117 can guide the light incident through the first to fifth lenses 111-115 to the entire region of the image sensor 300. The ratio of the radius of curvature of each lens may satisfy the following conditions.
Condition 1:0<|L1R1/L1R2|<1.2, Condition 2:0<|L2R1/L2R2|<0.5
Condition 3: 0<L3R1/L3R2<0.2, Condition 4: 0<L4R1/L4R2<0.3
Condition 5: 10<L5R1/L5R2<30, Condition 6: 0<L6R1/L6R2<1
Condition 7: 1<L7R1/L7R2<2.2

If we describe the thickness of the lenses, the center thickness CT6 of the sixth lens 116 may have the maximum thickness within the lens portion 100A. The center thickness CT1 of the first lens 111 may be greater than the center thicknesses of the second to fourth lenses 112-114 and greater than the center thickness of the seventh lens 117. The center thickness CT7 of the seventh lens 117 may have the minimum thickness within the lens portion 100A. The center thickness CT1 of the first lens 111 may be smaller than the center thickness CT45 of the cemented lens 145A. The edge thickness ET1 of the first lens 111 may be smaller than the edge thickness ET45 of the cemented lens 145A. The center thickness and edge thickness of each lens may satisfy the following conditions.
Condition 1:0.6<CT1/ET1<1.2, Condition 2: 1<CT2/ET2<3
Condition 3:1.3<CT3/ET3<3, Condition 4:1.5<CT4/ET4<3
Condition 5:0<CT5/ET5<1, Condition 6:0.6<CT6/ET6<1.5
Condition 7:0.3<CT7/ET7<1.2, Condition 8:0.8<ΣCT/ΣET<1.5 or 1<ΣCT/ΣET<1.5

The center distance CG1 between the first and second lenses 111 and 112 is the maximum, and may be the center distance between the object-side aspherical lens and the sensor-side spherical lens. The center distance CG1 between the first and second lenses 111 and 112 may be larger than the center distance between the spherical lenses and may be larger than the center distance between the object-side spherical lens and the sensor-side aspherical lens. The center distance CG6 between the sixth lens 116 and the seventh lens 117 may satisfy the following condition: CG6<CG5<CG1. The center thickness of each lens and the center distance between adjacent lenses may satisfy the following condition.
Condition 1:0<CT1/CG1<0.5, Condition 2:2≤CT2/CG2<5
Condition 3:5<CT3/CG3<15, Condition 4: 4<CT45/CG5<12
Condition 5:0.5<CG1/2CG<1

By providing the maximum center thickness between the lenses to be smaller than the maximum center distance, a camera module applying an aspherical lens to the output side of the optical system may be provided without increasing the center distance of other lenses. The center distance CG1 between the first and second lenses 111 and 112 may be larger than the sum of the center thicknesses of the two adjacent lenses. In addition, the center distance CG1 between the first and second lenses (111, 112) may satisfy the following conditions: CT2+CT3+CT4<CG1, CT3+CT4+CT5<CG1, CT4+CT5+CT6<CG1, and CT5+CT6+CT7<CG1. The center distance CG1 between the first and second lenses 111 and 112 may be 1.5 times or more the center thickness of the cemented lens 145. Since the center distance CG1 between the first and second lenses 111 and 112 satisfies the above condition, the optical characteristics of the second to seventh lenses 112-117 may be easily controlled. Here, when the i-th center distance among the center distances of two adjacent lenses is defined as CGi, and the center thickness of the i-th lens arranged on the object side more than CGi is defined as CTi, the following condition may be satisfied. (Here, the thickness of the cemented lens and the distance between the cemented lenses are excluded)

The ratio of CTi/CGi is minimum when i is 1, and may be minimum when i is 3.

The relationship between the center thickness of each lens and the TTL may satisfy the following conditions.
Condition 1:0.01<CT1/TTL<0.1, Condition 2: 0<CT2/TTL<0.1
Condition 3:0<CT3/TTL<0.1, Condition 4: 0<CT4/TTL<0.1
Condition 5:0<CT5/TTL<0.1, Condition 6:0.1<CT6/TTL<0.2
Condition 7:0<CT7/TTL<0.07

The ratio of CT1/TTL of the above condition 6 may be larger than the values of the other conditions.

In terms of the effective diameter, the lens having the maximum effective diameter may be the first lens 111. The first lens 111 having the maximum effective diameter may be a spherical lens. The lens having the minimum effective diameter may be the lens closest to the image sensor 300, for example, the seventh lens 117. The effective diameters of each lens may satisfy the following conditions.
Condition 1: CA22<CA12, Condition 2: CA71<CA72, Condition 3: CA22<CA31
Condition 4: CA61<CA51<CA41, Condition 5: CA4<CA2<CA1, Condition 6: CA5<CA4<CA3

In terms of the refractive index, the refractive index of the fifth lens 115 is the maximum among the lenses, and may be greater than 1.70, for example, greater than 1.80. The refractive index of the first lens 111 is the minimum among the lenses. The difference between the maximum refractive index and the minimum refractive index may be greater than 0.20, for example, greater than 0.25. By adjusting the refractive indices of the spherical lens and the aspherical lens, the incident efficiency may be increased, and the incident light may be guided to the image sensor 300. In explaining the Abbe number, the Abbe number of the first lens 111 is the largest among the lenses and may be 55 or more. The difference between the Abbe numbers of the first lens 111 to the fourth lens 114 may be 10 or less. The Abbe number of the seventh lens 117 is the smallest among the lenses. The difference between the maximum Abbe number and the minimum Abbe number may be 30 or more.

The optical system 1000 causes chromatic aberration and corrects the chromatic aberration by using a cemented lens 145A or two lenses laminated in series. The lens repeatedly contracts and expands as the temperature changes from low to high. Since the lens characteristics of lenses of the same material change the same amount according to the temperature change, it is effective to correct the chromatic aberration between lenses of the same material even when the temperature changes.

If the focal length is expressed as an absolute value, the focal length of the first lens 101 may be 40 or more. The focal length of the seventh lens 117 is the maximum among the lenses and may be 40 or more. The focal length of the fifth lens 115 is the minimum among the lenses. The focal length difference between the first and seventh lenses 111 and 117 may be 10 or less. The difference between the maximum focal length and the minimum focal length may be 35 or more. By increasing the focal length of the first lens 111 closest to the object and the seventh lens 117 closest to the sensor, and providing the focal lengths of the other lenses small, the optical system may have improved MTF characteristics, aberration control characteristics, resolution characteristics, etc. in the set field of view range, and may have good optical performance in the periphery portion of the field of view. The critical points and Sag values of the object-side and sensor-side surfaces of the sixth and seventh lenses 116 and 117 may include the description of the first embodiment.

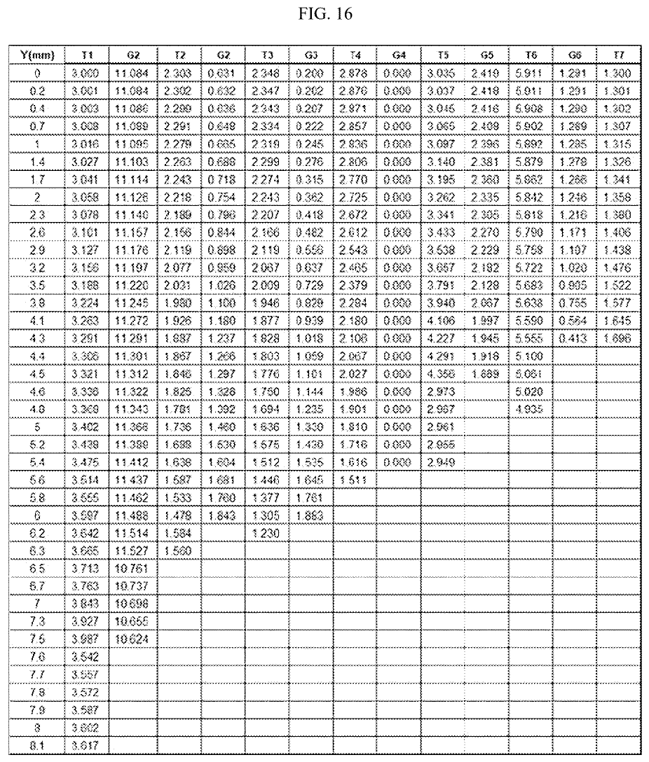

As shown in FIG. 15, among the lenses of the lens portion 100A in the second embodiment, the lens surfaces of the sixth and seventh lenses 116 and 117 may include aspherical surfaces having a 30th aspherical coefficient. As shown in FIG. 16, the thicknesses T1-T7 of the first to seventh lenses 111-117 and the distances G1-G6 between adjacent two lenses may be set. The center thickness CT45 of the cemented lens 145 may be larger than the edge thickness ET45. The center thickness CT45 of the cemented lens 145 is the distance from the center of the object-side seventh surface S7 of the fourth lens 114 to the center of the tenth surface S10 of the fifth lens 115, and the edge thickness ET45 is the distance from the end of the effective region of the seventh surface S7 to the tenth surface S10 in the optical axis direction. The maximum thickness of the cemented lens 145A is at the center, the minimum thickness is at the edge, and the maximum thickness may be 1.1 times or more of the minimum thickness, for example, in the range of 1.1 to 2.5 times.

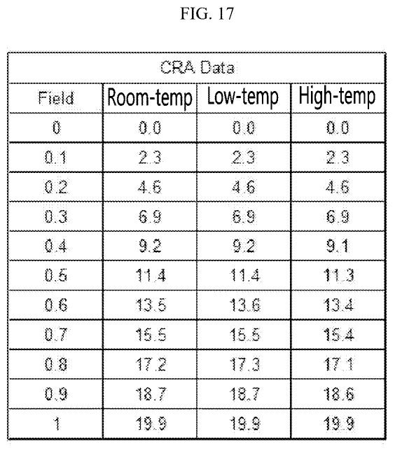

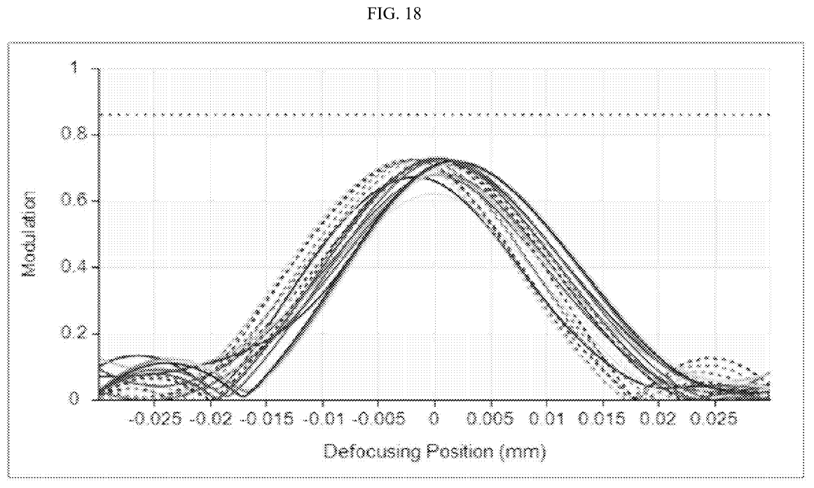

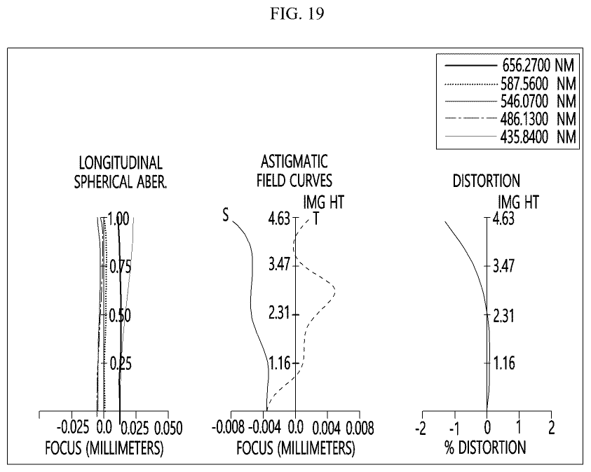

As shown in FIG. 17, the CRA in the optical system and camera module of FIG. 13 may be 10 degrees or more, for example, in the range of 10 to 35 degrees or in the range of 10 to 25 degrees. As shown in FIG. 20, a graph showing the peripheral light ratio or peripheral illuminance according to the image height in the optical system according to the embodiment may be seen that the peripheral light ratio is 70% or more, for example, 75% or more from the center of the image sensor to the diagonal end depending on the temperature change between low and high temperatures. FIG. 18 is a graph showing the diffraction MTF at room temperature in the optical system of FIG. 13, and is a graph showing the modulation according to the spatial frequency. In the second embodiment of the invention, the deviation of MTF with respect to low or high temperature with respect to room temperature may be less than 10%, that is, 7% or less. FIG. 19 is a graph showing aberration characteristics at room temperature in the optical system of FIG. 13. In the aberration graph of FIG. 19, spherical aberration (longitudinal spherical aberration), astigmatic field curves, and distortion are graphs measured from left to right. In FIG. 19, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatism and distortion are graphs for light in wavelength bands of about 546 nm. In the aberration diagram of FIG. 19, it may be interpreted that the closer each curve at room temperature is to the Y-axis, the better the aberration correction function is, and it may be seen that the optical system 1000 according to the embodiment has measurement values close to the Y-axis in almost all regions. That is, the optical system 1000 according to the embodiment has improved resolution and may have good optical performance not only in the center of the FOV but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature may be 85 degrees or higher, for example, in the range of 85 degrees to 105 degrees. Accordingly, it may be seen that the decrease in the luminance ratio (modulation) from the low temperature to the high temperature of FIGS. 10 to 12 is less than 10%, for example, 5% or lower, or is hardly changed. Therefore, it may be seen that the optical system according to the second embodiment has a change in optical characteristics due to a temperature change from a low temperature to a high temperature, for example, a change rate in the effective focal length (EFL), TTL, BFL, F number, and diagonal FOV of 10% or less, that is, 5% or less, for example, in the range of 0 to 5%. This makes it possible to prevent a decrease in the reliability of optical characteristics by designing so that temperature compensation for the aspherical lens is possible even when at least one or two or more aspherical lenses are used. The optical system of the embodiment disclosed above can effectively control aberration characteristics such as chromatic aberration and distortion aberration, and may have good optical performance not only at the center portion but also at the periphery portion of the FOV.

The optical system 1000 according to the embodiment disclosed above may satisfy at least one or two or more of the Equations described below. Accordingly, the optical system 1000 according to the embodiment may have improved optical characteristics. For example, when the optical system 1000 satisfies at least one Equation, the optical system 1000 can effectively control aberration characteristics such as chromatic aberration and distortion aberration, and may have good optical performance not only in the center of the FOV but also in the periphery. In addition, the optical system 1000 may have improved resolution. In addition, the thickness of the lens in the optical axis OA and the distance between adjacent lenses in the optical axis OA described in the Equations can refer to the embodiment disclosed above.

1<CT1/CT2<5 [Equation 1]

Equation 1 sets the difference in the center thickness of the first and second lenses, thereby improving the chromatic aberration of the optical system. Equation 1 may satisfy: 1<CT1/CT2<3. By making the thickness of the first lens 101 and 111 made of glass thicker than the center thickness of adjacent lenses, the optical characteristic change due to temperature change may be suppressed, and the optical performance of the center and periphery of the FOV may be improved.

(CT7*CA7)<(CT1*CA1) [Equation 2]

Equation 2 can set the center thickness and effective diameter of the first and seventh lenses. The effective diameter is the average of the effective diameters of the object-side surface and the sensor-side surface of each lens. In Equation 2, the following conditions may satisfy: CT7<CT1 and CA7<CA1. By setting the center thickness and effective diameter of the glass lens and the plastic lens, the optical system can improve spherical aberration, and a slim camera module may be provided.

Po1<0 [Equation 3]

In Equation 3, Po1 means the refractive power of the first lens 101, and may be set to have a short effective focal length F compared to TTL in the optical system for the performance of the optical system. Accordingly, TTL>F may be satisfied, and for example, TTL may be in the range of 1.5 times or more, for example, 1.5 times to 3 times the effective focal length F.

1.70<Nd5<2.2 [Equation 4]

Nd5 is the refractive index of the d-line of the fifth lens 105 and 115. Equation 4 sets the refractive index of the fifth lens high, so that it can control the factor affecting the reduction of the third-order aberration (Seidel aberration) of the optical system, and can reduce aberration that may occur when the TTL becomes somewhat longer. Equation 4 may preferably satisfy: 1.75≤Nd5<2.0. If designed to be lower than the lower limit of Equation 4, aberration may be reduced to obtain performance, and the refractive power of the fifth lens may be weakened so that light cannot be collected efficiently, which can deteriorate the performance of the optical system. If designed to be higher than the upper limit of Equation 4, there is a disadvantage in that it becomes difficult to obtain materials. In addition, if the refractive index of the fifth lens 105 and 115 is designed to be lower than the lower limit of Equation 4, the radius of curvature of the sixth and seventh lenses must be increased in order to increase the refractive power of the sixth and seventh lenses, and in this case, lens manufacturing becomes more difficult, the lens defect rate increases, and the yield can decrease.

1.60≤Aver(Nd1: Nd7)≤1.70 [Equation 4-1]

In Equation 4-1, Aver (Nd1: Nd7) is the average of the refractive index values of the d-line of the first to seventh lenses. When the optical system 1000 according to the embodiment satisfies the Equation 4-1, the optical system 1000 can set the resolution and suppress the influence on the TTL.

1.0<SSL_Nd_Aver/ASL_Nd_Aver<1.5 [Equation 4-2]

SSL_Nd_Aver is the average of the refractive indices of the spherical lenses in the lens portion 100 and 100A, and ASL_Nd_Aver is the average of the refractive indices of the aspherical lenses. By positioning the aspherical lenses having high refractive indices on both sides of the glass lenses, the color dispersion on both sides of the optical system may be controlled.

1.5≤Nd1<1.65 [Equation 4-3]

Nd1 is the refractive index of the d-line of the first lens 101 and 111. Equation 4-3 sets the refractive index of the first lens high, thereby reducing the color dispersion and increasing the distance between the first and second lenses.

20<FOV_H<40 [Equation 5]

In Equation 5, FOV_H means a horizontal field of view and can set the range of the vehicle optical system. Equation 5 preferably satisfies 25≤FOV_H≤35 or a range of 30 degrees #3 degrees, and at this time, the sensor length in the horizontal direction may be based on 8.064 mm±0.5 mm. In addition, when Equation 5 is satisfied, when the temperature changes from room temperature to high temperature, the change rate of the effective focal length and the change rate of the field of view may be set to 5% or less, for example, 0 to 5%. In addition, even if one or more aspherical lenses, for example, two or more aspherical lenses, are used in combination with spherical lenses in the optical system 1000, the deterioration of optical characteristics may be prevented through temperature compensation of the glass lens. Here, when the vertical field of view is FOV_V, the following condition may satisfy: 10<FOV_V<FOV_H.

L1R1<0 [Equation 6]

L1R1 is the radius of curvature of the first surface S1 of the first lens 101 on the optical axis, and may be set to be smaller than 0. When this Equation 6 is satisfied, the shape of the optical system may be limited. The object-side surface of the first lens 101 is formed concavely on the optical axis, so that when it comes into contact with an external structure, surface damage may be prevented, and the incident light may be refracted in a direction away from the optical axis. Accordingly, the edge thickness may be increased compared to the center thickness of the first lens 101 and 111, and the distance between the first lens 101 and 111 and the second lens 102 and 112 may be increased.

L3R1>0,L2R1>0 [Equation 6-1]

L3R1 is the radius of curvature of the object-side surface of the third lens 103 on the optical axis, and L2R1 is the radius of curvature of the object-side surface of the second lens on the optical axis. Since the second and third lenses have a convex shape on both sides of the optical axis, the distance between the first and second lenses may be increased, and the radius of curvature of the sensor-side surface of the second lens 102 and 112 may be increased to reduce the center distance between the second and third lenses. Since the effective diameters of the second to fourth lenses are large and the average radius of curvature is provided as spherical lenses, the assembling performance may be improved. This can reduce the influence on the optical characteristics of light passing through the second to fourth lenses. Since the following condition in absolute value satisfy: L3R2>L3R1, the light may be adjusted so that the effective diameter of the lenses arranged on the sensor side, i.e., the fourth to seventh lenses, is not larger than that of the third lens, and the TTL may be reduced. If the following condition in absolute value satisfy: L3R1>L3R2, there is a problem that aberration occurs between the object-side surfaces of the first lens and the second lens, or the effective diameter of the sensor-side lenses increases, or the TTL increases.

0.8<BFL/L7S2_max_sag to Sensor<3 [Equation 7]

BFL is the optical axis distance from the center of the sensor-side surface of the last lens, i.e., the seventh lens, to the surface of the image sensor. L7S2_max_sag to Sensor may be the distance in the optical axis direction from the maximum Sag value of the seventh lens 107 to the image sensor 300. When the optical system satisfies Equation 7, the TTL may be reduced and the conditions for manufacturing the camera module may be set. In addition, L7S2_max_sag to Sensor can set the space in which the optical filter 500 and the cover glass 400 located between the image sensor 300 and the seventh lens 107 and 117 may be placed. When the range of Equation 7 is smaller than the lower limit, the space for placing circuit structures such as the optical filter and the image sensor becomes more restricted, and the process of assembling the circuit structures such as the filter and the image sensor into the optical system can become difficult. When the range of Equation 7 is larger than the upper limit, the process of assembling the circuit structures such as the filter and the image sensor into the optical system is easy, but the TTL becomes longer, making it difficult to miniaturize the optical system. That is, Equation 7 can set the minimum distance between the image sensor 300 and the last lens. The BFL is the optical axis distance from the image sensor 300 to the center of the sensor-side surface of the last lens. In detail, if the following condition satisfy: 2<BFL/L7S2_max_sag to Sensor<3, the manufacturing convenience and TTL reduction are easier.

1<CT1/CT7<6 [Equation 8]

If Equation 8 is satisfied, the aberration characteristics may be improved and the influence on the reduction of the optical system may be set. Equation 8 may preferably satisfy: 2≤CT1/CT7<5. Equation 8 can set the center thickness of the first lens having an aspherical surface and the seventh lens having an aspherical surface, and limit the difference in their center thicknesses. Accordingly, the chromatic aberration of the optical system may be improved, and good optical performance may be achieved at the set field of view and TTL may be controlled.

0.1<CT1/CA11<0.5 [Equation 8-1]

In Equation 2, the center thickness CT1 of the first lens 101 and 111 and the effective diameter CA11 of the object-side surface S1 of the first lens 101 may be set, and if this is satisfied, the strength and optical characteristics of the glass lens may be prevented from being deteriorated. If it is lower than the range of Equation 1, the lens may be damaged or difficult to process, and if it is larger than the above range, the TTL may increase and the weight of the optical system may become heavy. Preferably, 0.15≤CT1/CA11≤0.3 may be satisfied.

1<CG1/CT1<5 [Equation 9]

CG1 is the center distance between the first and second lenses. In Equation 9, the center distance between the first and second lenses and the center thickness of the first lens having an aspherical surface may be set. When the optical system satisfies Equation 9, the influence of the heat transferred from the outside to the first lens may be reduced by the second to seventh lenses. Equation 9 preferably satisfies: 1.5<CG1/CT1<4.

1<CG1/CT45<3 [Equation 10]

In Equation 10, CT45 is the center thickness of the fourth and fifth lenses, for example, the center thickness of the cemented lens 145 and 145A. That is, CT45 is the optical axis distance from the center of the object-side surface of the fourth lens 104 and 114 to the center of the sensor-side surface of the fifth lens 105 and 115. When the optical system satisfies Equation 10, the aberration characteristics may be improved by setting the center distance between the cemented lens and the first and second lenses, and preferably, 1.5≤CG1/CT45<2 may be satisfied.

0<|L2R1/L4R2|<1 [Equation 11]

In Equation 11, L2R1 means the radius of curvature of the first surface S1 of the second lens 102 and 112, and L4R2 means the radius of curvature of the eighth surface S8 of the fourth lens 104 and 114. When the optical system 1000 according to the embodiment satisfies Equation 11, the optical system 1000 may have improved aberration characteristics.

0<CT45−ET45<2 mm [Equation 12]

In Equation 12, ET45 is an optical axis distance from the end of the effective region of the object-side surface of the fourth lens 104 and 114 to the end of the effective region of the sensor-side surface of the fifth lens 105 and 115. When the optical system satisfies Equation 12, the center thickness and the edge thickness of the cemented lens may be set to improve the aberration characteristics, and preferably, 1 mm≤CT45/ET45<1.5 mm may be satisfied. The ET45 may be greater than the edge thickness ET1-ET7 of each of the second to seventh lenses.

0<CA11/CA31<2 [Equation 13]

In Equation 13, CA11 means the effective diameter of the first surface S1 of the first lens 101 and 111, and CA31 means the effective diameter of the fifth surface S5 of the third lens 103 and 113. When Equation 13 is satisfied, the optical system 1000 can control the incident light and set the factor affecting the aberration, and preferably, 1<CA11/CA31<1.5 may be satisfied.

0<CA72/CA42<2 [Equation 14]

In Equation 14, CA42 means the effective diameter of the eighth surface S8 of the 4th lens (104, 114), and CA72 means the effective diameter of the fourteenth surface S14 of the seventh lens (107, 117). When Equation 14 is satisfied, the optical system 1000 can control the incident light path and set factors for performance changes according to CRA and temperature. Preferably, Equation 14 may satisfy: 0.5<CA72/CA42<1.0.

0<CA12/CA21<2 [Equation 15]

In Equation 15, CA12 means the effective diameter of the second surface S2 of the first lens 101 and 111, and CA21 means the effective diameter of the third surface S3 of the second lens 102 and 112. When the optical system 1000 according to the embodiment satisfies Equation 15, the optical system 1000 can control the light traveling to the first lens group LG1 and the second lens group LG2, and can set a factor affecting the decrease in lens sensitivity. Equation 15 may preferably satisfy: 1≤CA12/CA21<1.5.

1<CA1/CA6<2 [Equation 16]

CA1 means the effective diameter of the first lens 101 and 111, and CA6 means the effective diameter of the sixth lens 106. When the optical system 1000 according to the embodiment satisfies Equation 16, the size of the spherical lens(es) may be set. Equation 16 may preferably satisfy: 1<CA31/CA42<1.7.

1<CA41/CA52<2 [Equation 17]

CA42 means the effective diameter of the seventh surface S7 of the fourth lens 104 and 114, and CA52 means the effective diameter of the tenth surface S10 of the fifth lens 105 and 115. When the optical system 1000 according to the embodiment satisfies Equation 17, the optical system 1000 can improve chromatic aberration and set the size between the object-side surface and the sensor-side surface of the cemented lens 145 and 145A. Accordingly, by setting the effective diameter size of the cemented lens arranged closer to the object side than the aspherical lens, the light incident through the cemented lens may be effectively guided to the aspherical lens. Equation 17 may preferably satisfy: 1<CA41/CA42<1.6.

0<CA52/CA61<2 [Equation 18]

CA61 means the eleventh surface S11 of the sixth lens 106 and 116. When the optical system 1000 according to the embodiment satisfies Equation 18, the relationship between the effective diameter of the sensor-side surface of the cemented lens 145 and 145A and the effective diameter of the object-side surface of the adjacent lens may be set. Accordingly, the optical system 1000 can improve chromatic aberration and set the size and curvature radius between the sensor-side surfaces of the cemented lens. Accordingly, the effective diameter sizes of the aspherical lens and the spherical lens arranged on the object side more than the last lens may be set. Equation 18 preferably satisfies: 0.5<CA52/CA61<1.

CA41>(ImgH*2) [Equation 18-1]

CA51>(ImgH*2) [Equation 18-2]

CA52<(ImgH*2) [Equation 18-3]

CA62<(ImgH*2) [Equation 18-4]

In Equations 18-1 to 18-4, the effective diameter of the object-side surface and the sensor-side surface of the fifth lens 105 and 115, the effective diameter of the object-side surface of the fourth lens 104 and 114, and the effective diameter of the sensor-side surface of the sixth lens 106 and 116 may be used to set the light path to the region of the image sensor 300. In the embodiment, since the n-th lens is provided as an aspherical lens, the effective diameter ratio of the adjacent spherical lens and the cemented lens may satisfy Equations 18 to 18-3.

0<SSL_CA_Aver/ASL_CA_Aver<1 [Equation 19]

In Equation 19, SSL_CA_Aver means the average effective diameter of lenses having a spherical surface, and ASL_CA_Aver means the average effective diameter of lenses having an aspherical surface. In Equation 19, the effective diameter size of the aspherical lens placed on the object side is set to the maximum, so that the path of the incident light may be effectively guided. In addition, the difference in the effective diameters of the spherical lens and the aspherical lens may be set not to be large. Preferably, 0.5<SSL_CA_Aver/ASL_CA_Aver<1 may be satisfied. Here, nGL>nASL>nPL>0 may be satisfied. The nGL is the number of glass lenses, nPL is the number of plastic lenses, and nASL is the number of aspherical lenses.

0<SSL_Nd_Aver/ASL_Nd Aver<1.60 [Equation 20]

In Equation 19, SSL_Nd_Aver is the average of the refractive indices of the spherical material lenses, for example, the average of the refractive indices of the second to sixth lenses. ASL_Nd_Aver is the average of the refractive indices of the first and seventh lenses. Preferably, the refractive indices of the spherical lens and the refractive indices of the aspherical lens may be set to satisfy the condition: 1≤SSL_nd_Aver/ASL_nd_Aver<1.2.

0<ΣASL_Nd/ΣSSL_Nd<0.5 [Equation 20-1]

>ASL_Nd is the sum of the refractive indices of the aspherical lens, and ΣSSL_Nd is the sum of the refractive indices of the spherical lens. Preferably, 0.2<ΣASL_Nd/ΣSSL_Nd<0.5 may be satisfied. The optical system can control the resolution and color dispersion by setting the difference in refractive index between the spherical lens and the aspherical lens.

CA7<(ImgH*2)<CG1 [Equation 21]

In Equation 21, CA7 is the average effective diameter of the object-side surface and the sensor-side surface of the plastic lens, and CG1 is the center distance between the first and second lenses. Since the diagonal length of the image sensor satisfies Equation 21, a slim camera module may be provided.

(CT2+CT3+CT4)<CG1 [Equation 22]

Equation 22 can set the center distance between the first and second lenses to be greater than the sum of the center thicknesses of the three adjacent lenses. If Equation 22 is satisfied, the center thickness from the second lens to the fourth lens may be set, so that the optical performance of the peripheral part of the FOV may be improved.

G4<0.01 or CG4<0.01 [Equation 22-1]

In Equation 22-1, G4 and CG4 are the distance and the center distance between the fourth lens 104 and the fifth lens 105. If Equation 22-1 is satisfied, the fourth and fifth lenses may be set as cemented lenses.

0<CT7/CG6<1.5 [Equation 23]

In Equation 23, CG6 is the center distance between the sensor-side surface of the sixth lens 106 and the object-side surface of the seventh lens 107. In Equation 23, the center thickness CT7 of the seventh lens 107 and the center distance between the sixth and seventh lenses are set, thereby improving the optical performance at the periphery portion of the field of view. Equation 23 preferably satisfies: 0.5<CT7/CG6<1.5.

CT3<(CT2*2)<CG1<F [Equation 24]

The relationship between the maximum center distance CG1, the center thickness of the second and third lenses, and the total effective focal length F may be set. By Equation 24, the incident light may be guided by the thickness of the object-side glass lenses and the maximum center distance, and thermal compensation according to temperature change is possible and the assembly characteristics may be improved.

(CT7*3)<CG1<F [Equation 25]

If the center thickness of the seventh lens satisfies Equation 25, the light emitted by the thickness of the sensor-side aspherical lens may be refracted to the entire region of the image sensor, and the TTL may be reduced.

2<CT6/CT7<6 [Equation 26]

In Equation 26, by setting the center thickness CT6 of the sixth lens to be thicker than the center thickness CT7 of the seventh lens, the factors affecting the aberration may be controlled. Preferably, Equation 26 may satisfy: 3<CT6/CT7<5.

10<L7R1/CT7<40 [Equation 27]

L7R1 means the radius of curvature of the thirteenth surface of the seventh lens on the optical axis. In Equation 27, by setting the radius of curvature of the object-side surface of the seventh lens and the center thickness of the seventh lens, the refractive power of the seventh lens may be controlled. Accordingly, good optical performance may be achieved at the center and periphery portions of the field of view. Preferably, Equation 27 may satisfy: 10<L7R1/CT7<30.

0<L5R2/L7R1<1 [Equation 28]

L5R2 means the radius of curvature of the tenth surface of the fifth lens on the optical axis. In Equation 28, by setting the radius of curvature of the sensor-side surface of the fifth lens and the radius of curvature of the object-side surface of the seventh lens, the refractive powers of the fifth and seventh lenses may be controlled. Accordingly, it may have good optical performance in the center and periphery portions of the field of view. Preferably, Equation 28 may satisfy: 0<L5R2/L7R1<0.5.

L1R1*L1R2<0 [Equation 29]

L1R2 means the radius of curvature of the sensor-side surface of the first lens on the optical axis. If Equation 29 is satisfied, the refractive power of the first lens and the dispersion of the incident light may be adjusted, and the distance between the first and second lenses and the assemblability of the first lens may be improved.

0<L5R1/L4R2<2 [Equation 30]

L5R1 means the radius of curvature of the object-side surface of the fifth lens on the optical axis, and L4R2 means the radius of curvature of the sensor-side surface of the fourth lens on the optical axis. If Equation 30 is satisfied, the fourth and fifth lenses may be expressed as a joined lens. Preferably, L5R1/L4R2=1 may be satisfied.

0<L6R2/L6R1<3 [Equation 31]

L6R1 means the radius of curvature of the object-side surface of the sixth lens on the optical axis, and L6R2 means the radius of curvature of the sensor-side surface of the sixth lens on the optical axis. In Equation 31, the radius of curvature of the object-side surface and the sensor-side surface of the sixth lens may be set. Equation 31 may preferably satisfy: 1.5<L6R2/L6R1<3. The object-side surface and the sensor-side surface of the sixth lens, which is a glass lens, are spherical, and when the difference in the radius of curvature of the object-side surface and the sensor-side surface satisfies the above range, the assembling property of the sixth lens may be improved, and the influence on the optical characteristics due to temperature change may be suppressed.

1<L7R1/L7R2<3 [Equation 31-1]

L7R1 and L7R2 mean the curvature radii of the object-side surface and the sensor-side surface of the seventh lens on the optical axis. In Equation 31-1, by setting the curvature radii of the aspherical object-side surface and the aspherical sensor-side surface of the plastic lens, light may be refracted to the entire region of the image sensor through the seventh lens. Accordingly, if the difference in the curvature radii of the object-side surface and the sensor-side surface of the seventh lens satisfies the above range, the assemblability of the seventh lens may be improved, and the influence of the optical characteristics due to temperature change may be suppressed.

0<CG_Max/CT_Max<3 [Equation 32]

In Equation 32, the maximum center thickness CT_Max among the lenses and the maximum center distance CG_Max between adjacent lenses may be set. If Equation 32 is satisfied, the optical system may have good optical performance at the focal length at the set field of view and can reduce TTL. Preferably, the first embodiment may satisfy: 1<CG_Max/CT_Max<2.

1<ΣCT/ΣCG<5 [Equation 33]

ΣCT is the sum of the center thicknesses of the lenses, and ΣCG is the sum of the center distances between adjacent lenses. If Equation 33 is satisfied, the optical system may have good optical performance at the focal length at the set field of view and can reduce TTL. Preferably, 1<ΣCT/ΣCG<2 may satisfy.

8<ΣNd<30 [Equation 34]

ΣNd means the sum of the refractive indices at the d-line of each of the plurality of lenses. If Equation 34 is satisfied, the optical system 1000 in which aspherical lenses and spherical lenses are mixed can control TTL and have improved resolution. In addition, if the number of spherical lenses is greater than the number of aspherical lenses, heat compensation is possible by a spherical lens having a relatively thick thickness, and the sum of the TTL and refractive index of the lenses may be set. Equation 34 may preferably satisfy: 10<ΣNd<13.

10<ΣVd/ΣNd<50 [Equation 35]

ΣVd means the sum of the Abbe numbers of each of the plurality of lenses. If Equation 35 is satisfied, the optical system 1000 may have improved aberration characteristics and resolution. Equation 35 sets the sum of the Abbe number and the sum of the refractive index of the lenses to control the optical characteristics, and preferably satisfies: 20<ΣVd/ΣNd<35.

Distortion<2 [Equation 36]

Distortion means the maximum value of distortion or the absolute value of the maximum from the center 0.0F of the image sensor to the diagonal end 1.0F based on the optical characteristics detected by the image sensor 300. When the optical system 1000 satisfies Equation 36, the optical system 1000 can improve the distortion characteristics and set conditions for image processing. Preferably, Distortion<1 may be satisfied.

0<ΣCT/ΣET<2 [Equation 37]

ΣCT is the sum of the center thicknesses of the lenses, and ΣET is the sum of the edge thicknesses of the ends of the effective regions of the lenses. If Equation 37 is satisfied, the optical system may have good optical performance at the focal length at the set field of view and can reduce the TTL. Equation 37 preferably satisfies: 1<ΣCT/ΣET<1.5.

1<CA11/CA_Min<5 [Equation 38]

CA11 is the effective diameter of the object-side surface of the first lens, and CA_Min represents the minimum effective diameter among the object-side surfaces and the sensor-side surfaces of the lenses. If Equation 38 is satisfied, the relationship between the maximum effective diameter of the glass lens and the minimum effective diameter of the plastic lens may be set, thereby providing a slimmer module while maintaining incident light control and optical performance. Equation 38 preferably satisfies: 1<CA11/CA_Min<2.5.

1<CA_Max/CA_Min<5 [Equation 39]

CA_Max means the maximum effective diameter among the object-side surfaces and the sensor-side surfaces of the lenses. If Equation 39 is satisfied, the optical system can set a size for a slim and compact structure while maintaining optical performance. Equation 39 may preferably satisfy: 1.2<CA_Max/CA_Min<2.5.

1<CA_Max/CA_Aver<3 [Equation 40]

CA_Aver means an average of the effective diameters of the object-side surfaces and the sensor-side surfaces of the lenses. If Equation 40 is satisfied, the optical system can set a size for a slim and compact structure while maintaining optical performance. Equation 40 may preferably satisfy: 1<CA_Max/CA_Aver<1.7.

0.5<CA_Min/CA_Aver<2 [Equation 41]

If Equation 41 is satisfied, the optical system can set a size for a slim and compact structure while maintaining optical performance. Equation 41 may preferably satisfy: 0.5<CA_Min/CA_Aver<1.

1<CA_Max/(2*ImgH)<3 [Equation 42]

Equation 42 may be set to the maximum effective diameter CA_Max of lens surfaces and the diagonal length of the image sensor, and if it satisfies this, the optical system can maintain good optical performance and set the size for a slim and compact structure. Equation 42 may preferably satisfy: 1<CA_Max/(2*ImgH)<2.

1<TD/CA_Max<4 [Equation 43]

TD is the optical axis distance from the center of the object-side surface of the first lens to the center of the sensor-side surface of the last lens. If Equation 43 is satisfied, the total optical axis distance and the maximum effective diameter of the lenses may be set, and the size for good optical performance may be set. Equation 43 preferably satisfies: 2<TD/CA_Max<3.

TD>SD [Equation 43-1]

The SD is the distance from the position of the aperture to the center of the sensor side of the last lens.

1<F/CA61<10 [Equation 44]

F represents the effective focal length (EFL) of the optical system, and may be 10 mm or more, for example, in the range of 10 mm to 20 mm. In Equation 44, the relationship between the effective focal length and the effective diameter of the object-side surface of the last spherical lens is set, so that the influence on the optical system reduction, for example, TTL, may be controlled. Equation 44 may preferably satisfy: 1<F/CA61<2.

0<F/|L1R1|<1 [Equation 45]

In Equation 45, the effective focal length of the optical system and the radius of curvature of the object-side surface of the first lens on the optical axis may be set, so that the influence on the incident light and TTL may be controlled. Equation 45 may preferably satisfy: 0<F/|L1R1| <0.5.

Max(CT/ET)<3 [Equation 46]

Max (CT/ET) means the maximum value of the ratio of the center thickness and edge thickness of each lens. When Equation 46 is satisfied, the optical system can control the influence on the effective focal length. Equation 46 may preferably satisfy: 0.5<Max (CT/ET)<2.5. Accordingly, the assembly of the entire lenses may be improved.

0<EPD/|L1R1|<1 [Equation 47]

EPD means the size (mm) of the entrance pupil diameter of the optical system 1000, and L1R1 means the radius of curvature of the first surface S1 of the first lens on the optical axis. When the optical system 1000 according to the embodiment satisfies Equation 47, the optical system 1000 can control the incident light. Equation 47 preferably satisfies: 0<EPD/|L1R1|<0.5.

−10<F1/F3<0 [Equation 48]

F1 is the focal length of the first lens, and F3 is the focal length of the third lens. When Equation 48 is satisfied, the resolution may be improved by controlling the refractive power of the first and third lenses, and the TTL and effective focal length (EFL) may be affected. Preferably, −5<F1/F3<0 may be satisfied.

Po4*Po5<0 [Equation 49]

Po4 is the refractive power value of the fourth lens, and Po5 is the refractive power value of the fifth lens. That is, the refractive powers of the fourth and fifth lenses have opposite refractive powers, so that aberration may be improved, and light may be effectively guided by the aspherical lens. When the Po4*Po5 value is greater than 0, the effect of improving chromatic aberration as a cemented lens is not significant.

Po1(Po4*Po5)>0 [Equation 49-1]

F45<0 [Equation 49-2]

F4*F5<0 [Equation 49-3]

Po1 is the refractive power value of the first lens, F45 is the composite focal length of the fourth and fifth lenses, F4 is the focal length of the fourth lens, and F5 is the focal length of the fifth lens. When Equations 49-1 to 49-3 are satisfied, it is easy to improve the aberration of the optical system with the fourth lens and the fifth lens, which are cemented lenses, and the incident light may be effectively guided to the aspherical lens.

15<Vd4−Vd5<50 [Equation 50]

Vd4 is the Abbe number of the fourth lens, and Vd5 is the Abbe number of the fifth lens. If Equation 50 is satisfied, the difference in Abbe numbers of at least two lenses forming a cemented lens may be maintained at a certain value or more, and chromatic aberration may be improved. Equation 50 may preferably satisfy: 20<Vd4−Vd5<40. If the cemented lens is less than the lower limit of Equation 50, it may be insignificant in improving the aberration characteristics of the optical system.

0<|F1/F|<20 [Equation 51]

Equation 51 sets the relationship between the focal length F1 and the effective focal length F of the first lens having an aspherical surface, and can set the TTL of the optical system. Equation 51 may preferably satisfy: 1<|F1/F|<5.

0<|F5/F6|<1 [Equation 52]

In Equation 52, by setting the relationship between the focal lengths F5 and F6 of the fifth and sixth lenses, the refractive power and optical path of the spherical lens and its adjacent spherical lens may be adjusted, and the resolution may be improved. Equation 52 preferably satisfies: 0<|F5/F6|<0.5.

0<|F5/F7|<1 [Equation 53]

In Equation 53, by setting the relationship between the focal lengths F5 and F7 of the fifth and seventh lenses, the refractive power and optical path of the spherical lens and the last aspherical lens may be adjusted, and the resolution may be improved. Equation 53 preferably satisfies: 0<|F5/F7|<0.2.

0<|F6/F1|<2 [Equation 54]

In Equation 54, by setting the relationship between the focal lengths F1 and F6 of the first and sixth lenses, the refractive power and optical path of the first aspherical lens and the last spherical lens may be controlled, and the influence of TTL may be controlled to improve the resolution. Equation 54 preferably satisfies: 0<|F6/F1|<1.

0<|F37|/F12<3 [Equation 55]

In Equation 55, by setting the relationship between the composite focal lengths F37 of the third to seventh lenses and the composite focal lengths F12 of the first and second lenses, the refractive power of the object-side lens group and the sensor-side lens group based on the aperture stop may be controlled to improve the resolution, and the optical system may be provided in a slim and compact size. Equation 55 preferably satisfies: 0<F37/F12<1.5. Here, F12 is the focal length of the first lens group, F37 may be the focal length of the second lens group, and F37 may have positive refractive power.

0<F37/F6<1 [Equation 56]

In Equation 56, by setting the relationship between the composite focal length F37 of the third to seventh lenses and the focal length F6 of the sixth lens, the composite refractive power of the third to seventh lenses and the refractive power of the last spherical lens may be adjusted to improve the resolution, and the optical system may be provided in a slim and compact size. Equation 56 may preferably satisfy: 0.5<F37/F6<1.

0<|F37/F7|<1 [Equation 57]

In Equation 57, the relationship between the composite focal length F37 of the third to seventh lenses and the focal length F7 of the seventh lens is set, so that the composite refractive power of the third to seventh lenses and the refractive power of the plastic lens may be adjusted to improve the resolution, and the optical system may be provided in a slim and compact size. Equation 57 preferably satisfies: 0<|F37/F7|<0.7.

0<F6/F<5 [Equation 58]

In Equation 58, the relationship between the focal length F6 of the sixth lens and the effective focal length F is set, so that the refractive power of the last spherical lens and the entire focal length may be adjusted to improve the resolution, and the optical system may be provided in a slim and compact size. Equation 58 preferably satisfies: 1<F6/F<3.5.

F37<TTL [Equation 59]

In Equation 59, the relationship between the focal length F37 and the total length TTL of the second lens group may be set. The TTL may be reduced by the second lens group having an aspherical surface.

1<nGL/nASL<4 [Equation 60]

nGL is the number of glass lenses, and nASL means the number of aspherical lenses. In Equation 60, by arranging aspherical lenses in the above range, the thickness of the optical system may be reduced, and more diverse refractive powers may be provided through the aspherical surface.

5<nGL/nPL<7 [Equation 61]

nPL is the number of plastic lenses in the lens section. In Equation 61, by arranging the number of glass lenses and the number of plastic lenses in the above ratio, the thickness of the optical system may be reduced, and more diverse refractive powers may be provided through the aspherical surface.

CA3<CA2<CA1 [Equation 62]

By setting the relationship between the effective diameters CA1, CA2, and CA3 of the first, second, and third lenses, the optical paths of the front/rear lenses of the diaphragm may be controlled, and the optical paths of the entire lenses may be set.

0<ΣPL_CT/ΣGL_CT<0.5 [Equation 63]

ΣPL_CT is the sum of the center thicknesses of the plastic lenses, and ΣGL_CT is the sum of the center thicknesses of the glass lenses. If Equation 62 is satisfied, the overall TTL may be controlled by setting the relationship between the thickness of the plastic lens and the thickness of the glass lens compared to the TTL. Equation 62 may preferably satisfy: 0<ΣPL_CT/ΣGL_CT<0.1.

10 mm<TTL<50 mm [Equation 64]

TTL means the distance (mm) from the center of the first surface S1 of the first lens 101 to the surface of the image sensor 300 in the optical axis OA. In Equation 64, by making the TTL exceed 10 or exceed 20, a vehicle optical system may be provided. Equation 64 may preferably satisfy the condition: 30<TTL<45 or TD<TTL.

2 mm<ImgH [Equation 65]

Equation 65 can set the diagonal size (2*ImgH) of the image sensor 300 and provide an optical system having a vehicle sensor size. Equation 65 may preferably satisfy: 4 mm≤ImgH.

2 mm<BFL<7 mm [Equation 66]

In Equation 66, the BFL (Back focal length) is set to be more than 2 mm and less than 7 mm, thereby securing the installation space of the optical filter 500 and the cover glass 400, improving the assemblability of the components through the distance between the image sensor 300 and the last lens, and improving the joint reliability. Equation 66 may preferably satisfy: 2.5 ≤BFL≤3. If the BFL is less than the range of the Equation 66, some of the light that is transmitted to the image sensor may not be transmitted to the image sensor, which may cause a decrease in resolution. If the above BFL exceeds the range of the Equation 68, stray light may be introduced, which may deteriorate the aberration characteristics of the optical system.

3<CG1/BFL<5 [Equation 67]

In the Equation 67, the BFL is made smaller than the maximum interval between the lenses, and the installation space of the optical filter 500 and the cover glass 400 may be secured, and the assemblability of the components may be improved through the interval between the image sensor 300 and the last lens, and the joint reliability may be improved. Preferably, in the Equation 67, 3.2<CG1/BFL<4.5 may be satisfied.

CG6<BFL [Equation 68]

In Equation 68, the BFL is set to be larger than the center distance CG6 between the spherical lens and the aspherical lens, thereby securing the installation space of the optical filter 500 and the cover glass 400, improving the assemblability of the components through the distance between the image sensor 300 and the last lens, and improving the joint reliability. In addition, the seventh lens, which is the last lens, can disperse the incident light to the effective region of the image sensor, but if the BFL does not satisfy Equation 68, some of the emitted light may not be transmitted to the effective region of the image sensor, thereby lowering the resolution.

3<F<40 [Equation 69]

Equation 69 can set the total effective focal length F to suit the vehicle optical system. Equation 69 may satisfy: 10<F<30.

FOV<45 [Equation 70]

In Equation 70, FOV (Field of view) means the field of view (Degree) in the diagonal direction of the optical system 1000, and can provide a vehicle optical system of less than 45 degrees. The FOV may preferably satisfy: 20≤FOV≤40.

1<TTL/CA_Max<5 [Equation 71]

CA_Max means the largest effective diameter (mm) among the object-side and sensor-side surfaces of the plurality of lenses, and TTL means the distance (mm) from the apex of the first surface S1 of the first lens to the image surface of the image sensor 300 in the optical axis OA.

Equation 71 sets the relationship between the total optical axis length of the optical system and the maximum effective diameter, and can provide an improved vehicle optical system. Equation 71 may preferably satisfy: 1.5<TTL/CA_Max<4.

2<TTL/ImgH<15 [Equation 72]

Equation 72 can set the total optical axis length (TTL) of the optical system and the diagonal length (ImgH) from the optical axis of the image sensor 300. When the optical system 1000 according to the embodiment satisfies Equation 72, the optical system 1000 may have TTL for application to the vehicle image sensor 300, thereby providing improved image quality. Equation 72 may preferably satisfy: 4<TTL/ImgH≤10.

0.1<BFL/ImgH<2 [Equation 73]

Equation 73 can set the optical axis distance between the image sensor 300 and the last lens and the diagonal length from the optical axis of the image sensor 300. When the optical system 1000 according to the embodiment satisfies Equation 73, the optical system 1000 can secure the BFL for applying the size of the vehicle image sensor 300, can set the distance between the last lens and the image sensor 300, and may have good optical characteristics at the center and periphery of the FOV. Equation 73 may preferably satisfy: 0.3<BFL/ImgH<1.

5<TTL/BFL<20 [Equation 74]

Equation 74 can set (unit: mm) the total optical axis length (TTL) of the optical system and the optical axis distance (BFL) between the image sensor 300 and the last lens. When the optical system 1000 according to the embodiment satisfies Equation 55, the optical system 1000 can secure BFL. Equation 74 may preferably satisfy: 10<TTL/BFL<20.

1<TTL/F<3 [Equation 75]

Equation 75 can set the total focal length F and the total optical axis length (TTL) of the optical system 1000. Accordingly, an optical system for a driver assistance system may be provided. Equation 75 may preferably satisfy: 1.5≤TTL/F≤2.8. When the optical system 1000 according to the embodiment satisfies Equation 75, the optical system 1000 may have an appropriate focal length in a set TTL range, and provides an optical system that can form an image while maintaining an appropriate focal length even when the temperature changes from low to high. When it is below the lower limit of Equation 75, it is necessary to increase the refractive power of the lenses, so that correction of spherical aberration or distortion aberration becomes difficult, and when it exceeds the upper limit of Equation 75, the effective diameter or TTL of the lenses becomes long, which may cause a problem of the enlargement of the imaging lens system.

1<F/BFL<10 [Equation 76]

Equation 76 can set the total effective focal length F of the optical system 1000 and the optical axis distance (BFL) between the image sensor 300 and the last lens. When the optical system 1000 according to the embodiment satisfies Equation 76, the optical system 1000 may have a set field of view and an appropriate focal length, and a vehicle optical system may be provided. In addition, the optical system 1000 can minimize the distance between the last lens and the image sensor 300, and thus may have good optical characteristics in the periphery portion of the FOV. Equation 76 may preferably satisfy: 3<F/BFL<8.

1<F/ImgH<5 [Equation 77]

Equation 77 can set the total effective focal length F of the optical system 1000 and the diagonal length (ImgH) from the optical axis of the image sensor 300. This optical system 1000 may have improved aberration characteristics in the size of the vehicle image sensor 300. Equation 77 may preferably satisfy: 2<F/ImgH<4.1.

1<F/EPD<5 [Equation 78]

Equation 78 can set the total effective focal length F and the entrance pupil diameter of the optical system 1000. Accordingly, the overall brightness of the optical system may be controlled. Equation 78 can preferably set 1<F/EPD<3.

0<BFL/TD<0.3 [Equation 79]

Equation 79 can set the relationship between the optical axis distance (TD) and the BFL of the lenses of the optical system 1000. Accordingly, the resolution of the optical system may be maintained and the overall size may be controlled. Equation 79 preferably satisfies: 0<BFL/TD<0.2. When the condition value of BFL/TD is 0.2 or more, the BFL is designed to be large compared to the TD, so the size of the entire optical system becomes large, making it difficult to miniaturize the optical system, and the distance between the seventh lens and the image sensor becomes long, so that an unnecessary amount of light may increase between the seventh lens and the image sensor, resulting in a problem of lowering the resolution, such as deterioration of aberration characteristics.

0<EPD/ImgH/FOV<0.2 [Equation 80]

Equation 80 can set the relationship between the EPD, the length (ImgH) of half the diagonal length of the image sensor, and the diagonal field of view. Accordingly, the overall size and brightness of the optical system may be controlled. Preferably, Equation 80 may satisfy: 0<EPD/ImgH/FOV<0.1.

5<FOV/F#<40 [Equation 81]

Equation 81 can set the relationship between the diagonal field of view and the F number of the optical system. Preferably, Equation 81 may satisfy: 10<FOV/F #<30. Here, F # is provided to be 1.8 or less, so as to provide a bright image.

1<ΣGL_CT/F#<20 [Equation 82]

Equation 82 can set the relationship between the sum ΣGL_CT of the center thicknesses of the glass lenses of the optical system and the F number F #. Preferably, in Equation 82, 10<ΣSSL_CT/F #<20 may be satisfied.

0<ΣPL_CT/F#<2 [Equation 83]

Equation 83 can set the relationship between the sum ΣPL_CT of the center thicknesses of the plastic lenses of the optical system and the F number F #. Preferably, Equation 83 may satisfy: 0.5<ΣPL_CT/F #<1.

1<ΣGL_Nd/F#<10 [Equation 84]

Equation 84 can set the relationship between the sum ΣGL_Nd of the refractive indices of the glass lenses of the optical system and the F number F #. Equation 84 may preferably satisfy: 3<ΣGL_Nd/F #<8.

1<ΣPL_Nd/F#<2 [Equation 85]

Equation 84 can set the relationship between the sum ΣPL_Nd of the refractive indices of the plastic lenses and the F number F #. Equation 84 may preferably satisfy: 1<ΣPL_Nd/F #<1.5.

|Max_Sag62|<|Max_Sag52| [Equation 86]

Max_Sag62 is the maximum distance in the optical axis direction from a straight line perpendicular to the optical axis on the sensor-side surface of the sixth lens to the sensor-side surface of the sixth lens, and Max_Sag52 is the maximum distance in the optical axis direction from a straight line perpendicular to the optical axis on the sensor-side surface of the fifth lens to the sensor-side surface of the fifth lens. If Equation 86 is satisfied, light may be guided to the last spherical lenses by the radius of curvature of the sensor-side surface of the fifth lens, and the effective diameters of the fifth and sixth lenses may be adjusted.

|Max_Sag72|<|Max_Sag62| [Equation 87]

Max_Sag72 is the maximum distance in the optical axis direction from a straight line perpendicular to the optical axis on the sensor-side surface of the seventh lens to the sensor-side surface of the seventh lens. If Equation 87 is satisfied, light may be guided from the spherical lens to the aspherical lens by the radius of curvature of the sensor-side surface of the sixth lens, and the effective diameters of the sixth and seventh lenses may be adjusted.

|Max_Sag52|<|Max_Sag41| [Equation 87-1]

Max_Sag41 is the maximum distance in the optical axis direction from a straight line perpendicular to the optical axis on the object-side surface of the fourth lens to the object-side surface of the fourth lens. Max_Sag52 is the maximum distance in the direction of the optical axis from a straight line perpendicular to the optical axis on the sensor-side surface of the fifth lens to the sensor-side surface of the fifth lens.

The optical system 1000 according to the first and second embodiments may satisfy at least one or two or more Equations among Equations 1 to 44. At least one or two or more of Equations 1 to 44 may satisfy at least one or two or more of Equations 45 to 87. In this case, the optical system 1000 may have improved optical characteristics. In detail, when the optical system 1000 satisfies at least one of Equations 1 to 44 and/or at least one of Equations 45 to 87, the optical system 1000 may have improved resolution and improve aberration and distortion characteristics. In addition, the optical system 1000 can secure a BFL for applying a vehicle image sensor 300, compensate for the deterioration of optical characteristics due to temperature change, and minimize the distance between the last lens and the image sensor 300, thereby providing good optical performance at the center and periphery of the FOV.

Table 2 shows the items of the Equations described above in the optical system 1000 of the first and second embodiments, including the TTL (mm), BFL, effective focal length F (mm), ImgH (mm), effective diameter CA (mm), thickness (mm), TTL (mm), TD (mm), which is the optical axis distance from the first surface S1 to the fourteenth surface S14, the focal lengths F1-F7 (mm) of each of the first to seventh lenses, the sum of the refractive indices of each lens, the sum of the Abbe numbers of each lens, the sum of the center thicknesses of each lens (mm), the sum of the center distances between adjacent lenses, the effective diameter, the diagonal FOV (Degree), the edge thickness ET, the focal lengths of the first and second lens groups, and the F number, etc. of the optical system 1000.

TABLE 2

| Items | First embodiment | Second embodiment |
|---|---|---|
| F | 15.212 | 15.162 |
| F1 | −56.443 | −52.407 |
| F2 | 33.590 | 34.586 |
| F3 | 26.887 | 27.756 |
| F4 | 17.638 | 19.048 |
| F5 | −8.143 | −9.422 |
| F6 | 35.166 | 34.310 |
| F7 | −95.446 | −52.688 |
| F_LG1 | 55.547 | 60.070 |
| F_LG2 | 32.232 | 31.403 |
| F27 | 12.792 | 12.812 |
| F45 | −24.785 | −29.853 |
| ET1 | 6.678 | 4.069 |
| ET2 | 1.304 | 1.401 |
| ET3 | 1.304 | 1.204 |
| ET4 | 1.215 | 1.270 |
| ET5 | 4.595 | 4.342 |
| ET6 | 4.098 | 5.360 |
| ET7 | 1.447 | 1.561 |
| F-number | 1.604 | 1.604 |
| ΣNd | 11.609 | 11.609 |
| ΣVd | 370.999 | 370.999 |
| ΣCT | 22.334 | 20.775 |
| ΣCG | 14.066 | 15.625 |
| FOV | 34.343 | 34.358 |
| EPD | 9.485 | 9.454 |
| BFL | 2.600 | 2.600 |
| TD | 36.400 | 36.400 |
| ImgH | 4.626 | 4.626 |
| SD | 18.367 | 19.814 |
| TTL | 39.000 | 39.000 |

| | |
|---|---|
| Image sensor | 3840*2160 |

Table 3 shows the result values for the Equations 1 to 44 described above in the optical system 1000 of the embodiment. Referring to Table 3, it may be seen that the optical system 1000 satisfies at least one, two or more, or three or more of the Equations 1 to 44. In detail, it may be seen that the optical system 1000 according to the embodiment satisfies all of the Equations 1 to 44. Accordingly, the optical system 1000 may have good optical performance and excellent optical characteristics at the center and periphery of the FOV.

TABLE 3

| Equations | | First embodiment | Second embodiment |
|---|---|---|---|
| 1 | 1 < CT1/CT2 < 5 | 2.577 | 1.303 |
| 2 | (CT7*CA7) < (CT1*CA1) | Satisfaction | Satisfaction |
| 3 | Po1 < 0 | −0.018 | −0.019 |
| 4 | 1.7 < Nd5 < 2.2 | 1.866 | 1.866 |
| 5 | 20 < FOV_H < 40 | 30.00 | 30.00 |
| 6 | L1R1 < 0 | −115.192 | −58.512 |
| 7 | 0.8 < BFL/Max_Sag72 to Sensor < 3 | 2.537 | 2.462 |
| 8 | 1 < CT1/CT7 < 6 | 4.165 | 2.308 |
| 9 | 0 < CG1/CT1 < 3 | 1.761 | 3.695 |
| 10 | 1 < CG1/CT45 < 3 | 1.638 | 1.875 |
| 11 | 0 < \|L2R1/L4R2\| < 1 | 0.154 | 0.161 |
| 12 | 0 < (CT45 − ET45) < 2 | 1.051 | 1.053 |
| 13 | 0 < CA11/CA31 < 2 | 1.367 | 1.299 |
| 14 | 0 < CA72/CA42 < 2 | 0.848 | 0.817 |
| 15 | 0 < CA12/CA21 < 2 | 1.196 | 1.206 |
| 16 | 1 < CA1/CA6 < 2 | 1.796 | 1.737 |
| 17 | 1 < CA41/CA52 < 2 | 1.377 | 1.328 |
| 18 | 0 < CA52/CA61 < 2 | 0.930 | 0.948 |
| 19 | 1 < SSL_CA_Aver/ASL_CA_Aver < 1.5 | 0.879 | 0.905 |
| 20 | 0 < SSL_Nd_Aver/ASL_Nd_Aver < 1.60 | 1.023 | 1.023 |
| 21 | CA7 < (ImgH*2) < CG1 | Satisfaction | Satisfaction |
| 22 | (CT2 + CT3 + CT4) < CG1 | Satisfaction | Satisfaction |
| 23 | 0 < CT7/CG6 < 1 | 0.940 | 1.007 |
| 24 | CT3 < (CT2*2) < CG1 < F | Satisfaction | Satisfaction |
| 25 | (CT7*3) < CG1 < F | Satisfaction | Satisfaction |
| 26 | 2 < CT6/CT7 < 6 | 3.354 | 4.547 |
| 27 | 10 < L7R1/CT7 < 40 | 25.521 | 19.478 |
| 28 | 0 < L5R2/L7R1 < 1 | 0.192 | 0.304 |
| 29 | L1R1*L1R2 < 0 | −5549.309 | −3968.283 |
| 30 | 0 < L5R1/L4R2 < 2 | 1.000 | 1.000 |
| 31 | 0 < L6R2/L6R1 < 3 | 1.553 | 1.815 |
| 32 | 0 < CG_Max/CT_Max < 3 | 1.761 | 1.875 |
| 33 | 1 < ΣCT/ΣCG < 5 | 1.588 | 1.330 |
| 34 | 8 < ΣNd < 30 | 11.609 | 11.609 |
| 35 | 10 < ΣVd/ΣNd < 50 | 31.957 | 31.957 |
| 36 | Distotion < 2 | Satisfaction | Satisfaction |
| 37 | 0 < ΣCT/ΣET < 2 | 1.082 | 1.082 |
| 38 | 1 < CA11/CA_Min < 5 | 1.971 | 1.905 |
| 39 | 1 < CA_Max/CA_Min < 5 | 1.971 | 1.905 |
| 40 | 1 < CA_Max/CA_Aver < 3 | 1.481 | 1.419 |
| 41 | 0.5 < CA_Min/CA_Aver < 2 | 0.751 | 0.745 |
| 42 | 1 < CA_Max/(2*ImgH) < 3 | 1.772 | 1.737 |
| 43 | 1 < TD/CA_Max < 4 | 2.221 | 2.265 |
| 44 | 1 < F/CA61 < 10 | 1.696 | 1.608 |

Table 4 shows the result values for the Equations 45 to 87 described above in the optical system 1000 of the embodiment. Referring to Table 4, it may be seen that the optical system 1000 satisfies at least one, two or more, or three or more of the Equations 45 to 87. In detail, it may be seen that the optical system 1000 according to the embodiment satisfies all of the Equations 1 to 87. Accordingly, the optical system 1000 may have good optical performance and excellent optical characteristics at the center and periphery of the FOV.

TABLE 4

| | | First | Second |
|---|---|---|---|
| Equations | | embodiment | embodiment |
| 45 | 0 < F/\|L1R1\| < 1 | 0.132 | 0.259 |
| 46 | Max (CT/ET) < 3 | 0.850 | 0.737 |
| 47 | 0 < EPD/\|L1R1\| < 1 | 0.082 | 0.162 |
| 48 | −10 < F1/F3 < 0 | −2.099 | −1.888 |
| 49 | Po4 * Po5 < 0 | Satisfaction | Satisfaction |
| 50 | 15 < Vd4 − Vd5 < 60 | 33.398 | 33.398 |
| 51 | 0 < \|F1/F\| < 20 | 3.710 | 3.456 |
| 52 | 0 < \| F5/F6 \| < 1 | 0.232 | 0.275 |
| 53 | 0 < \| F5/F7 \| < 1 | 0.085 | 0.179 |
| 54 | 0 < \| F6/F1 \| < 2 | 0.623 | 0.655 |
| 55 | 0 < \|F37 \|/F12 < 3 | 0.580 | 0.523 |
| 56 | 0 < F37/F6 < 1 | 0.917 | 0.915 |
| 57 | 0 < \|F37/F7\| < 1 | 0.338 | 0.596 |
| 58 | 0 < F6/F < 5 | 2.312 | 2.263 |
| 59 | F37 < TTL | Satisfaction | Satisfaction |
| 60 | 1 < nGL/nASL < 4 | 3.000 | 3.000 |
| 61 | 5 < nGL/nPL < 7 | 6.000 | 6.000 |
| 62 | CA3 < CA2 < CA1 | Satisfaction | Satisfaction |
| 63 | 0 < ΣPL_CT/ΣGL_CT < 0.5 | 0.065 | 0.067 |
| 64 | 10 < TTL < 50 | 39.000 | 39.000 |
| 65 | 2 < ImgH | 4.626 | 4.626 |
| 66 | 2 < BFL < 7 | 2.600 | 2.600 |
| 67 | 0.1 < CG1/BFL < 1 | 3.846 | 4.263 |
| 68 | CG6 < BFL | Satisfaction | Satisfaction |
| 69 | 3 < F < 40 | 15.212 | 15.162 |
| 70 | FOV < 45 | 34.343 | 34.358 |
| 71 | 1 < TTL/CA_max < 5 | 2.379 | 2.426 |
| 72 | 2 < TTL/ImgH < 15 | 8.430 | 8.430 |
| 73 | 0.1 < BFL/ImgH < 2 | 0.562 | 0.562 |
| 74 | 5 < TTL/BFL < 20 | 15.000 | 15.000 |
| 75 | 1 < TTL/F < 3 | 2.564 | 2.572 |
| 76 | 1 < F/BFL < 10 | 5.851 | 5.832 |
| 77 | 1 < F/ImgH < 5 | 3.288 | 3.278 |
| 78 | 1 < F/EPD < 5 | 1.604 | 1.604 |
| 79 | 0 < BFL/TD < 0.3 | 0.0714 | 0.0714 |
| 80 | 0 < EPD/Imgh/FOV < 0.2 | 0.0142 | 0.0142 |
| 81 | 5 < FOV/F# < 40 | 21.413 | 21.423 |
| 82 | 1 < ΣGL_CT/F# < 20 | 13.075 | 12.143 |
| 83 | 0 < ΣPL_CT/F# < 2 | 0.850 | 0.811 |
| 84 | 1 < ΣGL_Nd/F# < 10 | 6.198 | 6.198 |
| 85 | 1 < ΣPL_Nd/F# < 2 | 1.040 | 1.040 |
| 86 | \|Max_Sag62\| < \|Max_Sag52\| | Satisfaction | Satisfaction |
| 87 | \|Max_Sag72\| < Max_Sag62 | Satisfaction | Satisfaction |

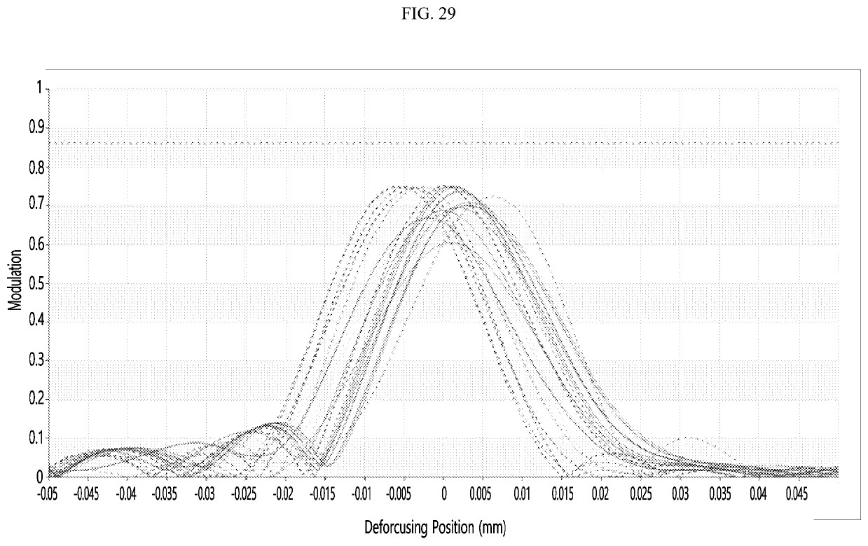

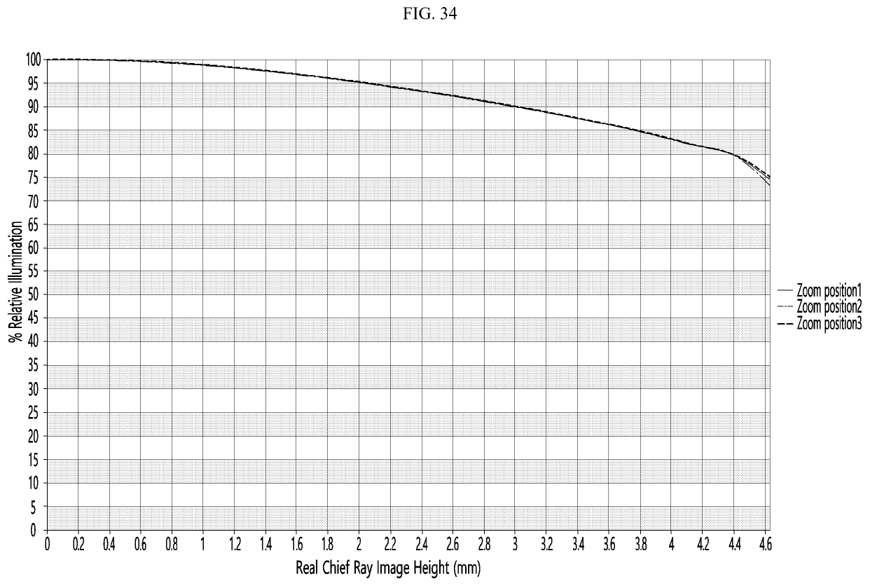

The optical system according to the third embodiment of the invention will be described with reference to FIGS. 21 to 35. The description of the third embodiment may include the description of the first and second embodiments in the same portions as the description and configuration of the first and second embodiments.

Referring to FIGS. 21 to 26, the optical system 1000 includes a lens portion 100B, and the lens portion 100B may include a first lens 121 to a seventh lens 127. The first lens group LG1 includes a first lens 121, and the second lens group LG2 includes a second to seventh lens 122-127. An aperture stop may be disposed on one of the peripheries of an object-side or sensor-side surface of the first lens 121 and the object-side or sensor-side surface of the second lens 122.

The first lens 121 may have positive (+) refractive power and may be formed of a glass material. The first surface S1 of the first lens 121 may be convex and the second surface S2 may be concave. The first lens 121 may be provided as an aspherical lens made of glass. The first and second surfaces S1 and S2 may be provided without a critical point. The effective radius r11 of the first surface S1 of the first lens 121 may be larger than the effective radius of the plastic lens. Since the first lens 121 has the largest effective diameter and the first surface S1 is convex and the second surface S2 is concave, light incident through the largest effective region may be refracted in the direction of the optical axis OA. In addition, since the first lens 121 has a meniscus shape convex toward the object side and has a center thickness thinner than the center thicknesses of the cemented lens 134 and the second and fifth lenses 122 and 125, the optical axis distance CG1 between the first and second lenses 121 and 122 may be increased. The optical axis distance CG1 between the first and second lenses 121 and 122 may be greater than the center thickness of the second lens 122 and smaller than the effective diameter of the second lens 122.

The second lens 122 may have negative (−) refractive power and may be provided with a glass material. The third surface S3 of the second lens 122 may be concave and the fourth surface S4 may be convex. The second lens 122 may be provided with a spherical lens made of glass. The third surface S3 and the fourth surface S4 of the second lens 122 may be spherical.

The third lens 123 may have negative (−) refractive power and may be provided with a glass material. The fifth surface S5 of the third lens 123 may be convex and the sixth surface S6 may be concave. The third lens 123 may be provided as a spherical lens made of glass. The fifth and sixth surfaces S5 and S6 of the third lens 123 may be spherical. The aperture stop ST may be disposed around the fourth surface S4 on the sensor side of the second lens 122. The composite focal length of the third to seventh lenses 123-127 disposed on the sensor side of the aperture may have a positive value, and may reduce the TTL within the field of view range.

The fourth lens 124 may have positive (+) refractive power and may be provided as a glass material. The object-side seventh surface of the fourth lens 124 may be convex, and the sensor-side eighth surface S8 may be convex. The fourth lens 124 may have a convex shape on both sides. Differently, the seventh surface may have a concave shape on the optical axis OA, and the eighth surface S8 may have a concave or convex shape. The fourth lens 124 may have a meniscus shape convex toward the object. The fourth lens 124 may be provided as a spherical lens made of glass. Both the seventh surface and the eighth surface S8 may be spherical.

The third lens 123 and the fourth lens 124 may be bonded. The bonded surface between the third lens 123 and the fourth lens 124 may be defined as the sixth surface S6. The fifth surface S5 may be the same surface as the seventh surface of the fourth lens 124. The distance G3 between the third and fourth lenses 123 and 124 may be less than 0.01 mm. The distance G3 between the third and fourth lenses 123 and 124 may be less than 0.01 mm from the optical axis OA to the end of the effective region. The third and fourth lenses 123 and 124 have opposite refractive powers, and the composite refractive power of the third and fourth lenses 123 and 124 may have positive refractive power.

The effective diameter of the third lens 123 may be larger than the diagonal length of the image sensor 300. The effective diameter of the third lens 123 is an average of the effective diameters of the seventh surface S7 and the eighth surface S8, and may be larger than the diagonal length of the image sensor 300. The effective diameter of the fourth lens 124 may be larger than the effective diameter of the third lens 123 and smaller than the effective diameter of the fifth lens 125. In the case where the third and fourth lenses 123 and 124 are glass lenses and the sixth and seventh lenses 126 and 127 are plastic lenses, the fourth lens 124 and the fifth lens 125 may be disposed in a convex shape on both sides to refract light without moving away from the passing optical axis.

The cemented lens 134 is bonded with glass lenses having different refractive indices and has a spherical refractive surface. If the lenses arranged on the sensor side than the cemented lens 134 are aspherical lenses or plastic lenses, spherical aberration may be compensated. In addition, since the lenses arranged on the sensor side than the cemented lens 134 are plastic lenses and are arranged as lenses with small effective diameters, the light traveling through the plastic lens to the image sensor 300 may be set to be effectively guided. Since the position of the cemented lens 134 is located in the middle or in front of the middle within the lens portion 100B, chromatic aberration correction may be more efficient.

The fifth lens 125 may have positive (+) refractive power and may be provided with a glass material. The ninth surface S9 of the fifth lens 125 may be convex and the tenth surface S10 may be convex. The fifth lens 125 may be provided with a spherical lens made of glass. The ninth surface S9 and the tenth surface S10 may be spherical. The sixth lens 126 may have negative (−) refractive power and may be provided with a plastic material. The eleventh surface S11 of the sixth lens 126 may be convex and the sensor-side twelfth surface S12 may have a concave shape. The sixth lens 126 may have a meniscus shape that is convex toward the object side. The sixth lens 126 may be made of a plastic material and may have aspherical surfaces on both sides. The eleventh surface S11 and the twelfth surface S12 of the sixth lens 126 may be aspherical. The eleventh surface S11 may be provided without a critical point from the optical axis OA to the end of the effective region. The twelfth surface S12 may have at least one critical point from the optical axis OA to the end of the effective region. When the twelfth surface S12 has a critical point, it may be located at 70% or more of the effective radius r62 from the optical axis OA, or in a range of 70% to 90%, or in a range of 75% to 85%. The thirteenth surface S13 may be provided without a critical point.

The seventh lens 127 may have negative (−) refractive power and may be made of a plastic material. The thirteenth surface S13 of the seventh lens 127 may be convex, and the fourteenth surface S14 may be concave. The seventh lens 127 may be made of a plastic material and may have aspherical surfaces on both sides. The thirteenth surface S13 and the fourteenth surface S14 may be aspherical. At least one or both of the thirteenth surface S13 and the fourteenth surface S14 may be provided without a critical point from the optical axis OA to the end of the effective radius r72. When the fourteenth surface S14 has a critical point, it may be located at 60% or less of the effective radius r72 from the optical axis OA, or in a range of 10% to 60%, or in a range of 10% to 50%.

By arranging at least two plastic lenses adjacent to the image sensor 300, it may be insensitive to the assembly tolerance compared to a glass lens. That is, being insensitive to assembly tolerance means that even if assembled with a slight difference compared to the design during assembly, it may not significantly affect the optical performance. In addition, by providing at least two lenses 126 and 127 adjacent to the image sensor 300 with plastic material, the optical performance may be improved by the lens surface having an aspherical surface, and for example, the aberration characteristic may be improved and the resolution may be prevented from being degraded.

In addition, the sixth and seventh lenses 126 and 127 have an aspherical surface, a convex shape toward the object side, and have negative refractive power, so that the light distribution irradiated to the entire region of the image sensor 300 may be guided.

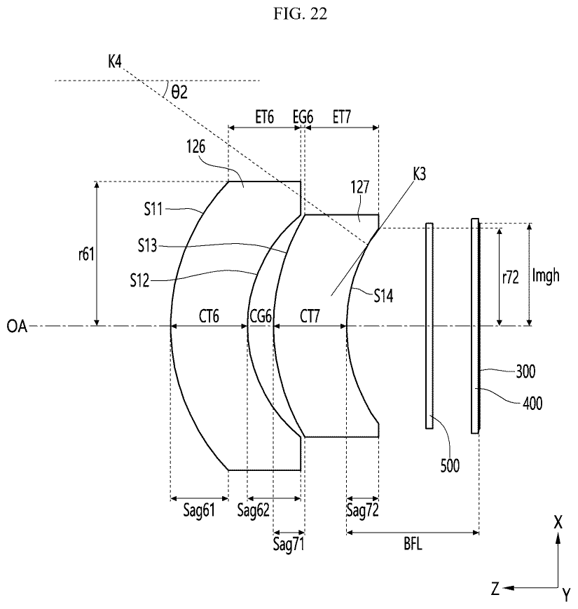

Referring to FIG. 22, a tangent line K3 passing through an arbitrary point of the fourteenth surface S14 of the seventh lens 127 and a normal line K4 perpendicular to the tangent line K3 may have a predetermined angle θ2 with an axis parallel to the optical axis OA. The maximum tangent angle θ2 on the fourteenth surface S14 in the first direction X may be 45 degrees or less, for example, in a range of 5 degrees to 43 degrees or in a range of 13 degrees to 40 degrees.

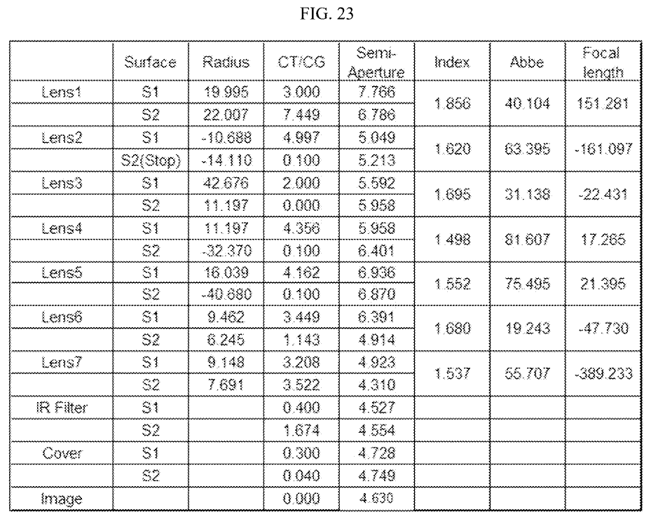

FIG. 23 is an example of lens data of the optical system of the embodiment of FIG. 21. Referring to FIG. 23, when expressed as an absolute value of the curvature radius, the curvature radius of the tenth surface S10 of the fifth lens 125 on the optical axis OA may be the largest among the lenses, and the curvature radius of the twelfth surface S12 of the sixth lens 126 may be the smallest among the lenses. The difference between the maximum radius of curvature and the minimum radius of curvature may be 5 times or more, for example, in the range of 5 to 15 times. The curvature radii of the plastic material sixth lens 126 and seventh lens 127 may be smaller than the curvature radii of the glass material first to fifth lenses 121, 122, 123, 124, and 125. Here, the curvature radii are the average of the curvature radii (absolute values) of the object-side surface and the sensor-side surface of each lens.

In terms of the center thickness CT of the lenses, the center thickness CT2 of the second lens 122 may be larger than the center thickness of the plastic lens(es), and may be the largest, for example, within the lens portion 100B. For example, the center thicknesses CT2, CT4, and CT5 of the second, fourth, and fifth lenses 122, 124, and 125 may be larger than the center thicknesses CT6 and CT7 of the sixth and seventh lenses. The center thickness of each of the first lens 121 and the third lens 123 may be smaller than the center thickness of each of the sixth and seventh lenses 126 and 127. The center thickness CT3 of the third lens 123 is the smallest among the lenses. The difference between the maximum center thickness and the minimum center thickness may be 2 mm or more. Even if the plastic lenses 126 and 127 provide a thin center thickness, the optical performance may not be degraded, and the thickness of the camera module may be slim. Here, the average of the center thicknesses of the first to seventh lenses 121-127 may be larger than the center thickness of each of the plastic lenses, for example, the sixth and seventh lenses 126 and 127. The average of the effective diameters of the first to seventh lenses 121-127 may be larger than the effective diameters of each of the plastic lenses, for example, the sixth and seventh lenses 126 and 127.

When describing the center distance between the lenses, the first center distance CG1 between the first lens 121 and the second lens 122 is the maximum. The first center distance CG1 is greater than the center thicknesses CT1 and CT2 of the first and second lenses 121 and 122, respectively, and may be no greater than twice the center thickness CT2 of the second lens 122. At least one of the second center distance CG2, the fourth center distance CG4, and the fifth center distance CG5 is the minimum spacing and may be no greater than 0.3 mm. Here, the minimum center distance excludes the bonding surface of the cemented lens 134. The difference between the maximum center distance and the minimum center distance may be 3.5 mm or more, for example, in the range of 3.5 mm to 5 mm. In addition, by providing the maximum center distance between the lenses to be 100% or more of the maximum center thickness, for example, in the range of 100% to 200%, the center thickness of the first lens 121 may be provided as a thin, object-side convex meniscus shape.

Regarding the effective diameter, the lens having the maximum effective diameter may be the first lens 121 closest to the object. The lens having the minimum effective diameter may be the seventh lens 127. The effective diameters of the lenses made of the glass material may be larger than the effective diameters of the lenses made of the plastic material. For example, the effective diameters of the first to fifth lenses 121-125 may be larger than the effective diameters of the sixth and seventh lenses 126 and 127. The effective diameters of the first to fifth lenses 121-125 may be larger than the diagonal length of the image sensor 300. The sixth lens 126 may have an effective diameter larger than the diagonal length of the image sensor 300, and the seventh lens 127 may have an effective diameter smaller than the diagonal length of the image sensor 300. Accordingly, the plastic lenses may guide light refracted through the glass lenses to the image sensor 300.

In terms of refractive indices, the refractive index of the first lens 121 is the largest among the lenses, and may be 1.75 or more or 1.8 or more. The refractive index of the fourth lens 124 is the smallest among the lenses. The difference between the maximum refractive index and the minimum refractive index may be 0.23 or more. The refractive index of the lens closest to the object is the largest, and by setting the refractive index of the fourth lens 124 of the cemented lens 134 to the smallest, the incidence efficiency may be increased, and the refractive power between the glass and plastic lenses may be adjusted to guide light to the image sensor 300.

In terms of the Abbe number, the Abbe number of the fourth lens 124 is the largest among the lenses and may be 65 or more. The Abbe number of the sixth lens 126 is the smallest among the lenses. The difference between the maximum refractive index and the minimum Abbe number may be 45 or more. By making the Abbe number of the fourth lens 124 arranged on the sensor side larger than the aperture stop and providing the Abbe number of the sixth lens 126 arranged between the image sensor 300 and the glass lens the smallest, the color dispersion of light traveling between the glass lenses may be controlled and the color dispersion between the glass and plastic lenses may be increased to guide it to the image sensor 300.

The focal lengths F2, F3, F6, and F7 of the second, fourth, sixth, and seventh lenses 122, 123, 126, and 127 may have negative refractive power, and the focal lengths F1, F4, and F5 of the first, fourth, and fifth lenses 121, 124, and 125 may have positive refractive power. The fifth lens 125 may have positive refractive power, and the sixth and seventh lenses 126 and 127 made of plastic may have negative refractive power. The refractive index of the fifth lens 125 may be smaller than that of the sixth lens 126, and the dispersion value of the fifth lens 125 may be larger than that of the sixth lens 125. Chromatic aberration occurring in the fifth lens 125 may be corrected by the plastic lenses. In addition, since the focal length of the seventh lens 127 is −300 or less, that is, the power is relatively low, and the Abbe number is provided large, the color correction effect can also be low. In addition, since the refractive index difference between the fifth and sixth lenses 125 and 126 arranged in succession is 0.1 or more and 0.15 or less, and the Abbe number difference is 20 or more and 60 or less, the chromatic aberration occurring in the glass material arranged on the object side of the plastic lens may be compensated for by the plastic lenses having negative refractive power.

The optical system 1000 causes chromatic aberration, and the chromatic aberration is corrected by using the cemented lens 134 or two lenses arranged in succession. The lens contracts and expands repeatedly as the temperature changes from low to high. Since the lens characteristics of the lenses of the same material change the same amount according to the temperature change, it is effective for the plastic lenses of the same material to correct the chromatic aberration of the fifth lens even if the temperature changes. Therefore, in the third embodiment of the invention, the chromatic aberration occurring in the glass material lens may be mutually compensated by the third lens 123 and the fourth lens 124, and the chromatic aberration occurring in the fifth lens 125 may be compensated by using the sixth and seventh lenses 126 and 127 made of plastic.

The refractive index difference between the third lens 123 and the fourth lens 124, which are the cemented lenses, is 0.1 or more and 0.2 or less, and the Abbe number difference is 20 or more and 60 or less, and the chromatic aberration occurring in the fifth lens made of glass may be compensated by the plastic lenses. The refractive index difference is rounded off to the third decimal place, and the Abbe number difference is rounded off to the first decimal place, and the values are compared. In addition, by arranging glass lenses having relatively high Abbe numbers on the object side of the plastic lenses, the chromatic dispersion may be reduced by the glass lenses, and the chromatic dispersion may be increased by the plastic lenses.

The focal lengths F1, F4, and F5 of the first, fourth, and fifth lenses 121, 124, and 125 have positive refractive power, and the focal lengths F2, F3, F6, and F7 of the second, third, sixth, and seventh lenses 122, 123, 126, and 127 may have positive refractive power. Here, the fourth and fifth lenses 124 and 125 adjacent to the plastic lenses have positive refractive power, and the sixth and seventh lenses 126 and 127 have negative refractive power, and aberrations occurring in the glass material and the plastic lens may be corrected. In addition, since the amount of change between the lenses of the same material is the same as the temperature changes from low temperature to high temperature, the aberration may be corrected by increasing the focal length difference between the lenses of the same material even when the temperature changes. In addition, by arranging glass lenses having a relatively high Abbe number on the object side of the plastic lenses, the color dispersion by the glass lenses may be reduced, and the color dispersion by the plastic lenses may be increased.

When the focal length is expressed as an absolute value, the focal length of the second lens 122 is the largest among the glass lenses and may be 100 or more. The focal length of the seventh lens 127 may be the largest within the lens portion 100B and may be 200 or more. The focal length of the fourth lens 124 is the smallest among the lenses. The difference between the maximum focal length and the minimum focal length may be 100 or more. By providing a large focal length of the two lenses adjacent to the object and providing the largest focal length of the plastic lens 127 adjacent to the image sensor 300, the optical system may have improved MTF characteristics, aberration control characteristics, resolution characteristics, etc. in the set field of view range, and may have good optical performance in the periphery portion of the field of view.

When expressed as an absolute value, the focal length of the glass lenses may be smaller than the focal length of the plastic lenses. For example, the composite focal length F15 of the first to fifth lenses 121-125 may be smaller than the composite focal length F67 of the sixth and seventh lenses 126 and 127. The composite focal length of the first to fifth lenses 121-125 are positive (+) values, and the composite focal lengths of the sixth and seventh lenses 126 and 127 are negative values.

In terms of the center thickness CT of the lenses, for example, at least two or more of the glass lenses may have a center thickness greater than the center thickness of the plastic lenses. If the average of the center thicknesses of the glass lenses in the lens portion 100B is GLCT_Aver, and the average of the center thicknesses of the plastic lenses is PLCT_Aver, the following condition may satisfy: GLCT_Aver>PLCT_Aver. In addition, the following condition may satisfy: 1<GLCT_Aver/PLCT_Aver<2.

In the lens portion 100B, the lens closest to the object may have the largest refractive index, and may be greater than 1.7, for example, 1.8 or more. The refractive index of the lens closest to the object may be greater than the refractive index of the plastic lens. The number of glass lenses having a lower refractive index than the average refractive index of the plastic material lenses in the lens portion 100B may be 2 or less, for example, 1. Here, the plastic material lenses have aspherical surfaces on both the object-side surface and the sensor-side surface, and may have a refractive index of less than 1.7.

In the lens portion 100B, when the average refractive index of the glass material lenses is Aver_GLn, and the average refractive index of the plastic lenses is Aver_PLn, the following condition may satisfy: PLn_Aver_PLn<Aver_GLn. In addition, the following condition may satisfy: 1<Aver_GLn/Aver_PLn<1.2. Lenses with high refractive index may be positioned on the object side of the plastic lens to increase color dispersion.

The average Abbe number of the glass material lenses may be greater than the average Abbe number of the plastic lenses. The average Abbe number of the glass lenses may be 50 or more, and the average Abbe number of the plastic lenses may be 45 or less. The number of glass lenses having a lower Abbe number than the average Abbe number of the plastic material lenses in the lens portion 100B may be 2 or less, for example, 1. Here, the largest Abbe number in the lens portion 100B may be possessed by the glass material lens, and the smallest Abbe number may be possessed by the plastic lens. The average Abbe number of the cemented lens 134 may be the largest among the lenses, for example, 70 or more. One of the lenses of the cemented lens 134 may have the largest Abbe number, for example, the object-side lens of the cemented lens 134 may have a larger Abbe number than the sensor-side lens. When the average Abbe number of the glass lenses is GLv_Aver and the average Abbe number of the plastic lenses is PLv_Aver, the following condition may satisfy: PLv_Aver<GLv_Aver. In addition, the following condition may satisfy: 1<GLv_Aver/Plv_Aver<1.8. Lenses with lower Abbe numbers may improve color dispersion at a location adjacent to the image sensor 300.

In the lens portion 100B, the number of lenses larger than the average effective diameter of the plastic lenses may be three or more, for example, four or more. When the average effective diameter of the lenses made of the plastic material is CA_PL_Aver and the average effective diameter of the lenses made of the glass material is CA_GL_Aver, the following condition may satisfy: CA_PL_Aver<CA_GL_Aver. In addition, the following condition may satisfy: 1<CA_GL_Aver/CA_PL_Aver<1.5. In addition, the relationship between the length of the image sensor 300 and the average effective diameter CA_PL_Aver of the plastic lens may satisfy the condition: 1≤(ImgH*2)/CA_PL_Aver<1.5. In addition, the relationship between the average effective diameter of the glass material and the length of the image sensor 300 may satisfy the condition: 1≤CA_GL_Aver/(ImgH*2)<1.5. The difference between the maximum length of the image sensor 300 and the effective diameter of the lenses made of the plastic material may be disposed not to be large. Accordingly, by arranging a plastic lens having a small effective diameter adjacent to the image sensor 300, the plastic lenses can disperse color from the center to the periphery of the image sensor 300.

The average effective diameter of the glass materials may be 10.5 mm or more, for example, in the range of 10.5 mm to 15 mm, and may be larger than the average effective diameter of the plastic lenses. The minimum effective diameter within the lens portion 100B may be in the range of 8 mm to 10 mm, and the maximum effective diameter may be the effective diameter of the lens closest to the object, and may be in the range of 12 mm to 20 mm. Accordingly, the optical system 1000 may improve the resolution and chromatic aberration control characteristics by controlling the incident light, and may improve the vignetting characteristics of the optical system 1000.

When the radius of curvature is described as an absolute value, the lens surface having the minimum radius of curvature based on the optical axis OA within the lens portion 100B may be disposed on the lens surfaces of the n−1 or n−2 lenses. For example, the lens surface having the minimum radius of curvature may be the sensor-side surface of the plastic lens closest to the glass lens. The lens surface having the maximum radius of curvature may be the lens surface of the glass lens. For example, the n−1th sensor-side surface may have the minimum radius of curvature within the lens portion 100B. When the lens surface having the minimum radius of curvature is the sensor-side surface of the plastic lens closest to the glass lens, light may be refracted into the effective region of the last plastic lens, which has a relatively small effective diameter. Here, the minimum radius of curvature may be 20 or less, for example, 10 or less. The maximum radius of curvature may be three times or more of the minimum radius of curvature.

When expressed in absolute values, when the average of the radii of curvature of the glass material lenses is Aver_GLr, the average of the radii of curvature of the plastic material lenses is Aver_PLr, and the following condition may satisfy: Aver_GLr>R_PL_Aver. In addition, the following condition may satisfy: 3<Aver_PLr/Aver_GLr<10. The average of the radii (absolute value) of curvature of the glass material lenses and the plastic lenses may satisfy the conditions: 15<Aver_GLr<50 and 5<Aver_PLr<15. Accordingly, by arranging plastic lenses having a small average radius of curvature adjacent to the image sensor 300, the light distribution traveling to the image sensor 300 may be controlled.

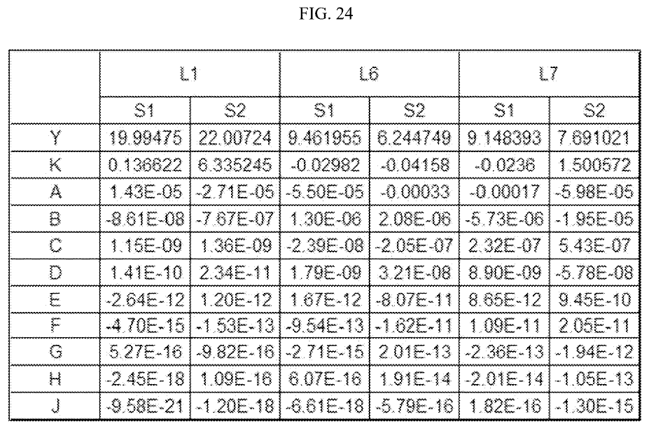

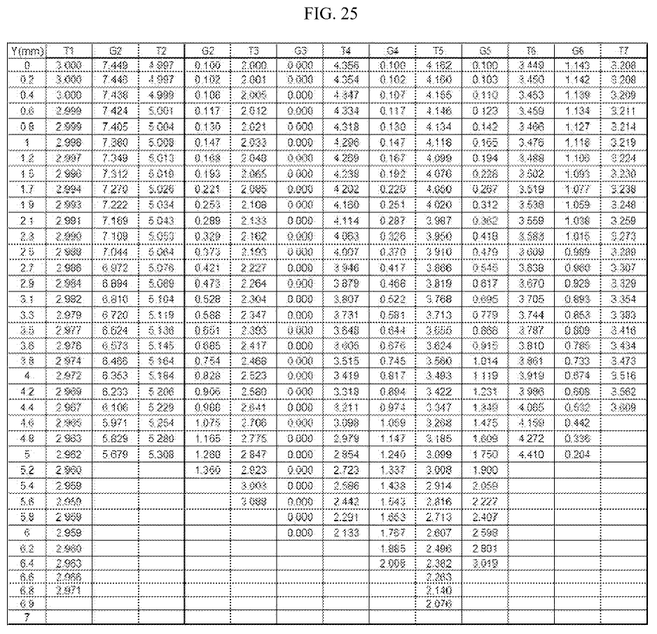

As shown in FIG. 24, among the lenses of the lens portion 100B in the embodiment, the lens surfaces S1, S2, S11, S12, S13, and S14 of the first, sixth, and seventh lenses 121, 126, and 127 may include aspherical surfaces having a 30th aspherical coefficient. As shown in FIG. 25, the thicknesses T1-T7 of the first to seventh lenses 121-127 and the distances G1-G6 between adjacent two lenses may be set. As shown in FIG. 5, the thicknesses T1-T7 of each lens in the Y-axis direction may be expressed at intervals of 0.1 mm or 0.2 mm or more from the optical axis, and the distances G1-G6 between each lens may be expressed at intervals of 0.1 mm or 0.2 mm or more from the optical axis. The thickness T1 of the first lens 121 may be 1.5 times or less of the difference between the maximum thickness and the minimum thickness, for example, in the range of 1 to 1.5 times, and the center thickness may be the maximum and the edge thickness may be the minimum. The thickness T2 of the second lens 122 may be 1.5 times or less of the minimum thickness, for example, in the range of 1.1 to 1.5 times. The center of the second lens 122 may be the minimum thickness and the edge may be the maximum thickness. The center thickness CT2 and the edge thickness ET2 of the second lens 122 may be greater than the center thickness CT5 of the fifth lens 125.

The thickness T3 of the third lens 123 may be minimum at the center and maximum at the edge. The center thickness CT3 of the third lens 123 may be the thinnest among the centers of the lenses. The edge thickness ET3 of the third lens 123 may be 1.8 times or less of the center thickness CT3, for example, in the range of 1.2 to 1.8 times. The center of the fourth lens 124 has a maximum thickness, and the edge has a minimum thickness, and the maximum thickness is 3 times or less of the minimum thickness, for example, in the range of 1.5 to 3 times. Here, the center thickness CT34 of the cemented lens 134 may be greater than the edge thickness ET34.

The center thickness CT5 of the fifth lens 125 may be maximum and greater than the edge thickness ET5. The center thickness CT5 of the fifth lens 125 may be greater than the center thickness CT1 of the first lens 121. The difference between the maximum thickness and the minimum thickness of the fifth lens 125 may be 3 times or less, for example, in the range of 1.5 to 3 times. The center thickness CT6 of the sixth lens 126 is minimum, the edge thickness ET6 is minimum, and the maximum thickness is less than or equal to twice the minimum thickness, for example, in the range of 1 to 2 times. The center thickness CT7 of the seventh lens 127 is minimum, the edge thickness ET7 is maximum, and the maximum thickness is less than or equal to twice the minimum thickness, for example, in the range of 1 to 2 times. As described above, the difference between the center thickness and the edge thickness of each of the first to seventh lenses 121 to 127 may be provided to be less than or equal to 3 times or less than or equal to 2.5 times, thereby reducing optical loss or design difficulties due to thickness differences from the optical axis to the edge.

Among the distances G1-G6 between the above lenses, the first distance G1 between the first and second lenses 121 and 122 may be maximum at the center and minimum at the edge, and the difference between the center distance CG1 and the edge distance EG1 may be 2 times or less. Among the distances G1 to G6, the distance with the largest difference between the center distance and the edge distance may be the fifth distance G5.

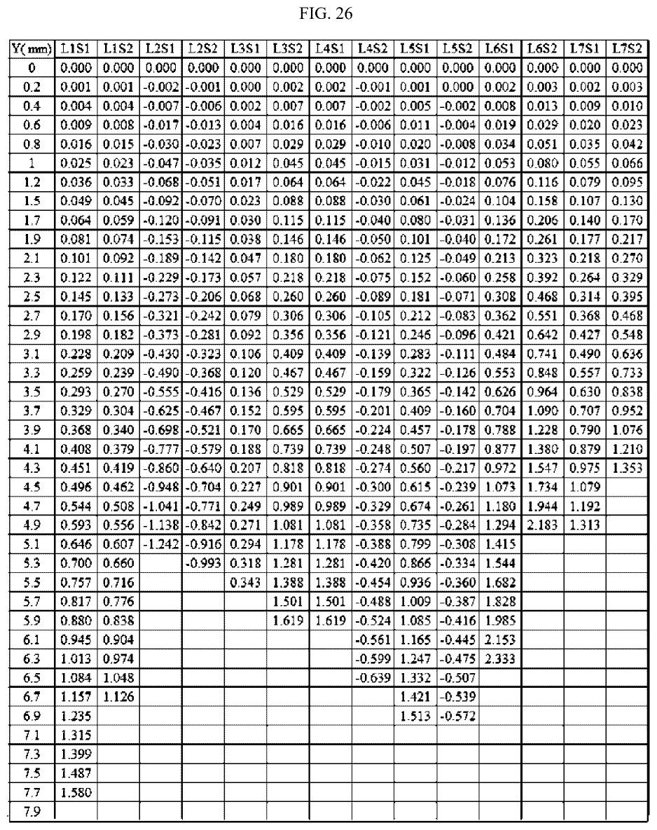

As shown in FIG. 22 and FIG. 26, Sag61 means the height from the center of the eleventh surface S11 of the sixth lens 126 to the lens surface in the direction X or Y orthogonal to the optical axis OA, and the maximum value of Sag61 may be the height at the edge of the eleventh surface S11. Sag62 means a height from the center of the twelfth surface S12 of the sixth lens 126 to the lens surface in the direction X or Y orthogonal to the optical axis OA, and the maximum value of Sag62 may be the height at the edge of the twelfth surface S12. Sag71 means a height from the center of the thirteenth surface S13 of the seventh lens 127 to the lens surface in the direction X or Y orthogonal to the optical axis OA, and the maximum value of Sag71 may be the height at the edge of the thirteenth surface S13. Sag72 is a height from the center of the fourteenth surface S14 of the seventh lens 127 to the lens surface in the direction X or Y orthogonal to the optical axis OA, and the maximum Sag value is the height at the edge. The maximum Sag values may satisfy the following. The following condition may satisfy: Max_Sag62<Max_Sag61, and the difference between them may be 0.5 or less. The following condition may satisfy: Max_Sag71<Max_Sag72<Max_Sag62, and the difference between Max_Sag71 and Max_Sag72 may be 0.5 or less. By setting the Sag values of the object-side and sensor-side surfaces of these plastic lenses, the light between the plastic lenses may be effectively refracted.

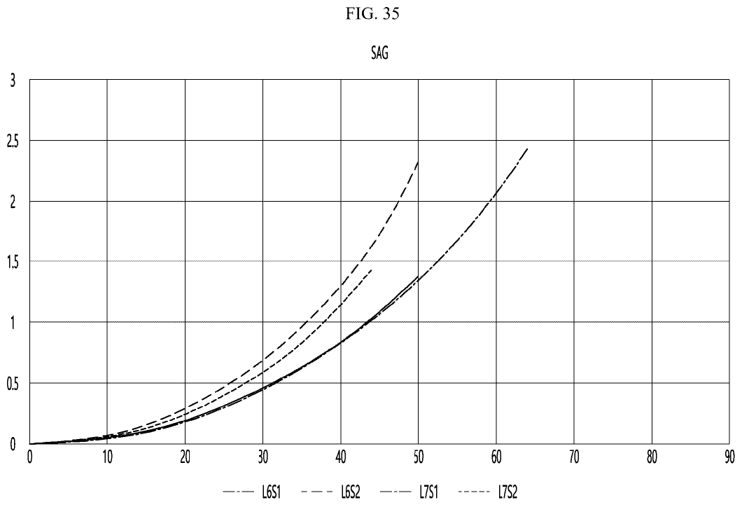

As shown in FIGS. 26 and 35, when the Sag values of the object-side and sensor-side surfaces of the sixth and seventh lenses are positive, the lens surface is located on the sensor side based on a straight line orthogonal to the optical axis OA, and when the Sag value is negative, the lens surface is located on the object side based on a straight line orthogonal to the optical axis OA. The Sag value of the lens surface of the seventh lens 127 may be extended to almost the same graph. In addition, since the difference between the Sag values or graphs of the object-side surfaces and the sensor-side surfaces of the sixth and seventh lenses 126 and 127 is not large, the light that goes to the image sensor 300 may be effectively guided. In FIG. 35, L6S1 is the eleventh surface of the sixth lens 126, L6S2 is the twelfth surface of the sixth lens 126, L7S1 is the thirteenth surface of the seventh lens 127, and L7S2 is the fourteenth surface of the seventh lens 127.

As shown in FIG. 23 and FIG. 35, the radius of curvature of the eleventh surface S11 of the sixth lens 126 is L6R1, the radius of curvature of the twelfth surface S12 is L6R2, the radius of curvature of the thirteenth surface S13 of the seventh lens 127 is L7R1, and the radius of curvature of the fourteenth surface S14 is L7R1, and at least one or two of the following conditions may be satisfied.
Condition 1:5<L6R1<15, Condition 2: 5<L7R1<15, Condition 3: 1<|L6R1-L7R1| <5, Condition 4:3<L6R2<14, Condition 5:3<L7R2<14.5, Condition 6: 1<|L7R2-L6R2| <5

By setting the difference in the radius (mm) of curvature between the eleventh to fourteenth surfaces S11-S14 of the sixth and seventh lenses 126 and 127 to a maximum of 5 mm or less, light passing through the plastic lenses may be guided to the effective region of the image sensor 300. The eleventh to fourteenth surfaces S11-S14 of the sixth and seventh lenses 126 and 127 may be 15 mm or less. The radius (mm) of curvature of each of the eleventh to fourteenth surfaces S11-S14 of the sixth and seventh lenses 126 and 127 may be smaller than the radius of curvature of the first and second surfaces S1 and S2 of the first lens 121. In addition, the difference in the radius of curvature of the first and second surfaces S1 and S2 of the first lens 121 may be 10 mm or less, for example, 7 mm or less. Accordingly, the difference in the radius of curvature of the object-side surface and the sensor-side surface of each of the first, sixth, and seventh lenses 121, 126, and 127 having an aspherical surface may be set to 5 mm or less.

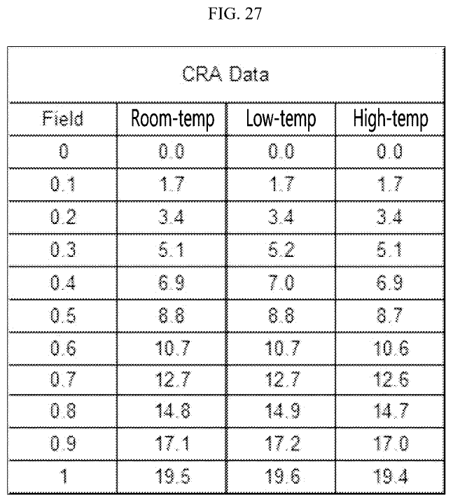

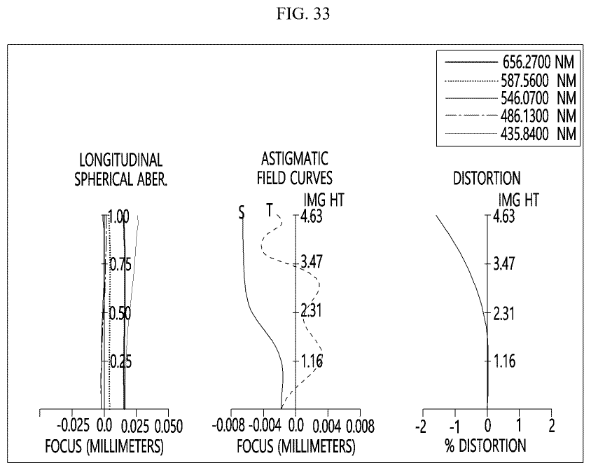

As shown in FIG. 27, the chief ray angle (CRA) in the optical system and camera module of FIG. 21 may be 10 degrees or more, for example, in a range of 10 degrees to 35 degrees or in a range of 10 degrees to 25 degrees. As shown in FIG. 33, it may be seen that the peripheral light ratio is 70% or more, for example, 75% or more, from the center of the image sensor to the diagonal end. That is, it may be seen that the difference in peripheral illuminance (Zoom position 1, 2, 3) from low temperature to high temperature is almost the same up to 4.4 mm from the optical axis depending on the temperature change from low temperature to high temperature.

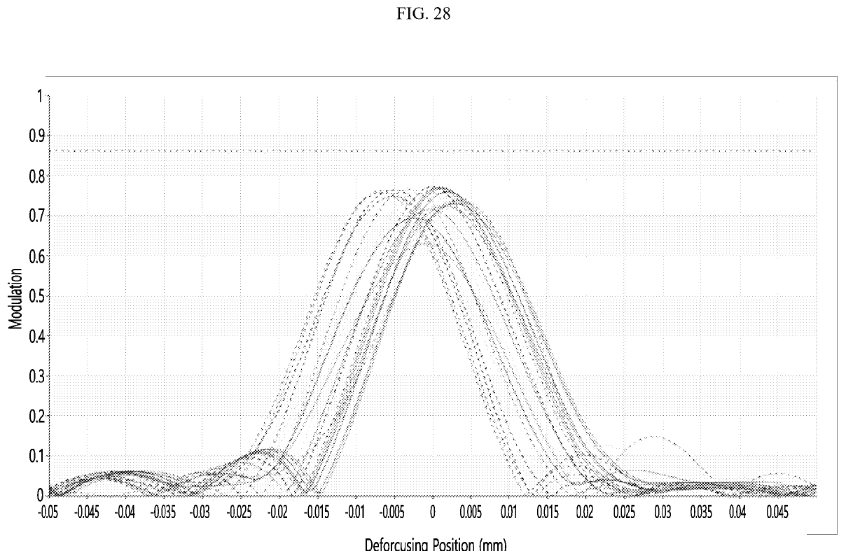

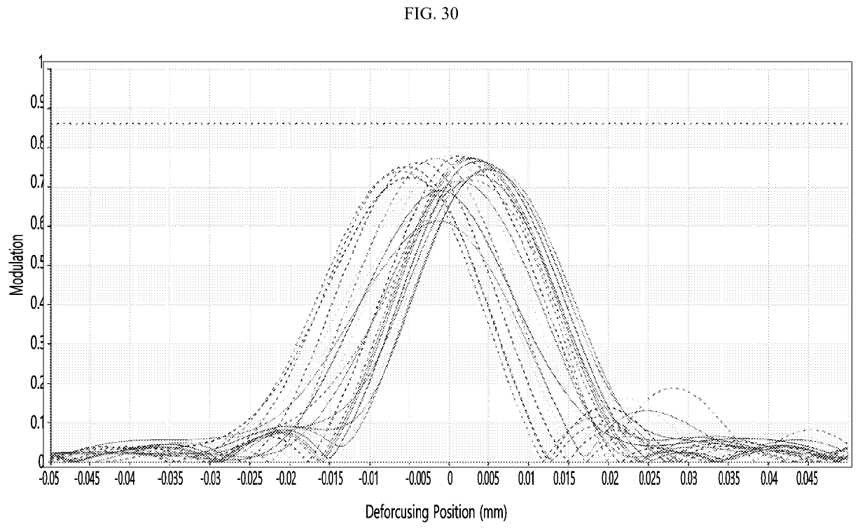

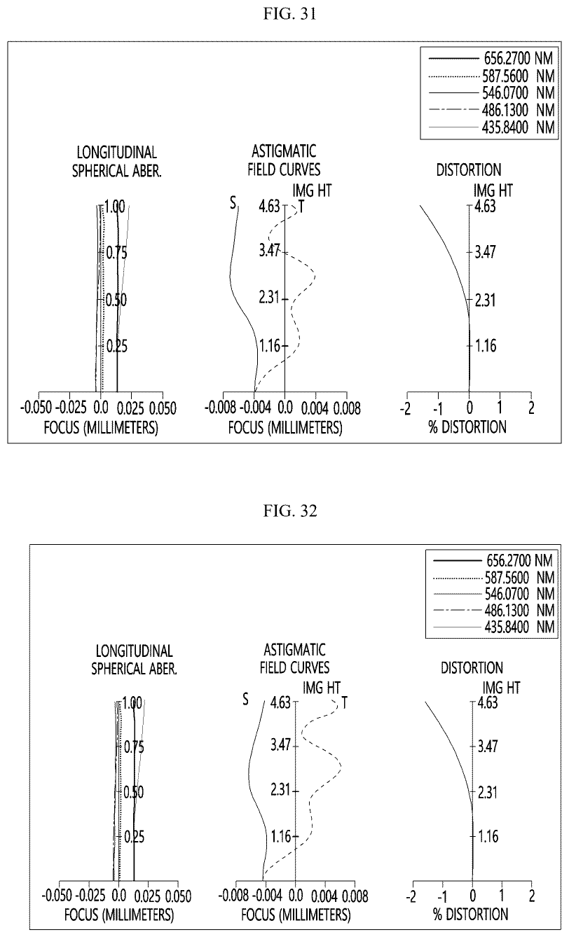

FIGS. 28 to 30 are graphs showing diffraction MTF at room temperature, low temperature, and high temperature in the optical system of FIG. 21, and are graphs showing modulation according to spatial frequency. As shown in FIGS. 27 to 29, in the third embodiment of the invention, the deviation of MTF at low temperature or high temperature based on room temperature may be less than 10%, that is, 7% or less. FIGS. 31 to 33 are graphs showing aberration characteristics at room temperature, low temperature, and high temperature in the optical system of FIG. 21. The graphs of FIGS. 31 to 33 are graphs measuring spherical aberration (Longitudinal spherical aberration), astigmatic field curves, and distortion from left to right. The graphs for spherical aberration are graphs for light having wavelength bands of about 435 nm, about 486 nm, about 546 nm, about 587 nm, and about 656 nm, and the graphs for astigmatism and distortion are graphs for light having a wavelength band of about 546 nm. In the aberration diagrams of FIGS. 31 to 33, it can be interpreted that the closer each curve at room temperature, low temperature, and high temperature is to the Y-axis, the better the aberration correction function is, and it can be seen that the optical system 1000 according to the third embodiment has measurement values close to the Y-axis in almost all regions. Accordingly, it may be seen that the decrease in the modulation from the low temperature to the high temperature of FIGS. 30 to 32 is less than 10%, for example, 5% or less, or is almost unchanged.

Table 5 compares the changes in optical characteristics such as EFL, BFL, F number, TTL, and FOV at room temperature, low temperature, and high temperature in the optical system according to the third embodiment, and it may be seen that the change rate of the optical characteristics at low temperature is 5% or less, for example, 3% or less, based on room temperature, and it may be seen that the change rate of the optical characteristics at low temperature is 5% or less, for example, 3% or less, based on room temperature.

TABLE 5

| | Room | Low | High | Low temperature/ | High temperature/ |
|---|---|---|---|---|---|
| | temperature | temperature | temperature | Room temperature | Room temperature |
| EFLF | 15.800 | 15.770 | 15.838 | 99.81% | 100.24% |
| BFL | 2.414 | 2.411 | 2.417 | 99.88% | 100.14% |
| F# | 1.600 | 1.597 | 1.604 | 99.82% | 100.23% |
| TTL | 40.000 | 39.941 | 40.069 | 99.85% | 100.17% |
| FOV | 32.418 | 32.454 | 32.374 | 100.11% | 99.86% |

Therefore, as shown in Table 5, the change in optical characteristics according to the temperature change from low temperature to high temperature, for example, the change rate of the EFL, TTL, BFL, F number, and the change rate of the FOV are 10% or less, that is, 5% or less, for example, in the range of 0 to 5%. This means that even if at least one or two or more plastic lenses are used, the temperature compensation for the plastic lenses may be designed to prevent the reliability of the optical characteristics from deteriorating.

The optical system 1000 according to the third embodiment may satisfy at least one or two or more of the Equations described below. When the optical system 1000 satisfies at least one Equation, the optical system 1000 can effectively control aberration characteristics such as chromatic aberration and distortion aberration, and may have good optical performance not only in the center of the FOV but also in the periphery. In addition, the optical system 1000 may have improved resolution. In addition, the thickness of the lens at the optical axis OA described in the Equations and the meaning of the spacing of the adjacent lenses at the optical axis OA may be referred to the above-described embodiments.

0.5<CT6/CT7<2 [Equation 84]

Equation 84 sets the difference in the center thickness of the plastic lenses, the sixth and seventh lenses, so that the chromatic aberration of the optical system may be improved, and preferably, 1≤CT6/CT7<1.5 may be satisfied. In addition, the manufacturing precision of the sixth and seventh lenses may be relaxed, and the optical performance of the center and periphery of the FOV may be improved.

0.5<CT1/ET1<2 [Equation 85]

In Equation 85, CT1 means the thickness (mm) in the optical axis OA of the first lens 121, and ET1 means the thickness at the edge of the effective region, that is, the end of the effective region of the first lens 121. Equation 85 sets the center thickness and edge thickness of the first lens, so that it can set the elements that affect the field of view of the optical system, and can set the elements that affect the effective focal length EFL, and preferably, 1≤CT1/ET1<1.25 may be satisfied.

Po1>0 [Equation 86]

In Equation 86, Po1 is represented by the positive refractive power of the first lens 121, and may be set to have a short effective focal length compared to TTL in the optical system for the performance of the optical system. Accordingly, the following condition may satisfy: TTL>F, and for example, TTL may be in the range of 1.5 times or more, for example, 1.5 times to 4 times the effective focal length F.

1.7<n1<2.2 [Equation 87]

In Equation 87, n1 is the refractive index of the d-line of the first lens 121. Equation 87 sets the refractive index of the first lens high, so that it can control the factor affecting the reduction of the third-order aberration (Seidel aberration) of the optical system, and can reduce the aberration that occurs when the TTL is slightly longer. Equation 4 preferably satisfies 1.75<n1<2.1. If it is designed to be lower than the lower limit of Equation 4, the performance of reducing aberration may be obtained, and since the refractive power of the first lens is weakened, light cannot be collected, so the performance of the optical system can deteriorate. If the value of Equation 87 is designed to be higher than the upper limit, there is a disadvantage in that it becomes difficult to obtain materials. In addition, if the refractive index of the first lens 121 is designed to be lower than the lower limit of Equation 87, in order to increase the refractive power of the first and second lenses, the radius of curvature of the first and second lenses must be increased, in which case lens manufacturing becomes more difficult, the lens defect rate increases, and the yield can decrease.

1.6≤Aver(n1: n7)≤1.7 [Equation 87-1]

In Equation 87-1, Aver (n1: n7) is the average of the refractive index values of the d-line of the first to seventh lenses. When the optical system 1000 according to the embodiment satisfies Equation 87-1, the optical system 1000 can set the resolution and suppress the influence on TTL.

1<GLn_Aver/PLn_Aver<1.2 [Equation 87-2]

GLn_Aver is the average of the refractive indices of the lenses made of the glass material in the lens portion 100B, and PLn_Aver is the average of the refractive indices of the plastic lenses. The lens(es) with a high refractive index are positioned on the object side of the plastic lens, which can increase the color dispersion.

20<FOV_H<40 [Equation 88]

In Equation 88, FOV_H represents a horizontal field of view, and can set the range of the vehicle optical system. Equation 88 preferably satisfies: 25≤FOV_H≤35, or a range of 29.8 degrees±3 degrees, and at this time, the sensor length in the horizontal direction may be based on 8.064 mm±0.5 mm. In addition, if Equation 88 is satisfied, when the temperature changes from room temperature to high temperature, the change rate of the effective focal length and the change rate of the field of view may be set to 5% or less, for example, 0 to 5%. In addition, even if one or more, for example, two or more, plastic lenses are mixed and used in the optical system 1000, the deterioration of the optical characteristics may be prevented through temperature compensation of the plastic lenses.

L1R1>0 [Equation 89]

If Equation 89 is satisfied, the shape of the optical system may be restricted. The object-side surface of the first lens 121 is formed convexly to prevent foreign substances from adhering to or accumulating on the surface. In addition, since the first lens 121 refracts the incident light in the direction of the optical axis, the effective diameter of the second lens 122 may be reduced. Accordingly, the distance between the first and second lenses 121 and 122 may be increased.

L1R2>0 [Equation 89-1]

L2R1<0 and L2R2<0 [Equation 89-2]

Since the first lens 121 has a meniscus shape convex toward the object side, it can refract light to the edge of the second lens 122 with a small effective diameter. In addition, since the second lens 122 has a convex meniscus shape toward the sensor side, the effective diameter of the cemented lens 134 may be stably secured. In addition, since the following condition satisfies: L3R1>|L2R2|, the light may be adjusted so that the effective diameter of the sensor-side lens, i.e., the sixth and seventh lenses 126 and 127, is not large, and the TTL may be reduced. If the following condition satisfies: L3R1<|L2R2|, there is a problem that aberration occurs, the effective diameter of the sensor-side lenses increases, or the TTL increases.

L5R1>0,L5R2<0 [Equation 89-3]

Since the fifth lens has a convex shape on both sides, the effective diameter of the sixth and seventh lenses 126 and 127 may be refracted so that the effective diameter is not large, and the TTL may be reduced and the number of lenses may be reduced. In addition, since the following condition satisfies: L5R1>L5R2, the light may be adjusted so that the effective diameter of the sensor-side lens, that is, the sixth and seventh lenses 126 and 127, is not large, and the TTL may be reduced. If the following condition satisfies: L3R1<L3R2, there is a problem that aberration occurs between the object-side surfaces of the first lens and the second lens, or the effective diameter of the sensor-side lenses increases, or the TTL increases.

2<L7S2_max_sag to Sensor<6 [Equation 90]

In Equation 90, L7S2_max_sag to Sensor may be a straight-line distance from the maximum Sag value of the seventh lens 127 to the image sensor 300, and if this is satisfied, the TTL may be reduced, and the conditions for manufacturing the camera module may be set. In addition, L7S2_max_sag to Sensor can set the space in which the filter 500 and the cover glass 400 located between the image sensor 300 and the seventh lens 127 may be placed. When the range of Equation 7 is smaller than the lower limit, the space in which the circuit structures such as the filter and the image sensor are placed becomes restricted, and the process of assembling the circuit structures such as the filter and the image sensor into the optical system may become difficult. When the range of Equation 90 is larger than the upper limit, the process of assembling the circuit structures such as the filter and the image sensor into the optical system is easy, but the TTL becomes long, making it difficult to miniaturize the optical system. That is, Equation 90 can set the minimum distance between the image sensor 300 and the last lens, and preferably satisfies: 4<L7S2 max_sag to Sensor<BFL. In addition, since the last lens has a concave radius of curvature on the sensor side, it can refract light into the effective region of the image sensor 300. The above BFL is the optical axis distance from the image sensor 300 to the center of the sensor side of the last lens. In detail, if the following condition may satisfy: 4.2<L7S2_max_sag to Sensor<5, the manufacturing convenience and TTL reduction are easier.

0.1<CT1/CT7<5 [Equation 91]

If Equation 91 is satisfied, the aberration characteristics may be improved and the influence on the reduction of the optical system may be set. Equation 91 may preferably satisfy: 0.5<CT1/CT7<1. Equation 91 can set the lenses on both sides of the optical system to be made of glass and plastic lenses, and limit the difference in their center thicknesses. Accordingly, the chromatic aberration of the optical system may be improved, and good optical performance may be achieved at the set field of view and the TTL (total track length) may be controlled.

0<CT1/CA11<1 [Equation 91-1]

In Equation 91, the center thickness CT1 of the first lens 121 and the effective diameter CA11 of the object-side surface S1 of the first lens 121 may be set, and if this is satisfied, the strength and optical characteristics of the injection-molded lens made of glass may be prevented from being deteriorated. If it is lower than the range of Equation 1, the lens may be damaged or injection molding may be difficult, and if it is larger than the above range, the TTL may increase and the weight of the optical system may become heavier. Preferably, 0<CT1/CA11<0.5 may be satisfied.

0<CT1/CT6<3 [Equation 92]

In Equation 92, CT6 means the center thickness of the sixth lens 126. If the optical system satisfies Equation 92, the aberration characteristics may be improved and the influence on the reduction of the optical system may be set. Equation 9 may preferably satisfy: 0<CT1/CT6<1. Equation 92 can improve the chromatic aberration of the optical system by setting the difference in the center thickness of the first and sixth lenses.

1<CT34/CT6<5 [Equation 93]

In Equation 93, CT34 is the center thickness of the third and fourth lenses. If the optical system satisfies Equation 93, the aberration characteristics may be improved by setting the thickness of the cemented lens and the sixth lens 126 made of plastic material, and may preferably satisfy: 1<CT34/CT6<4 or 1<CT34/CT6≤2.5. The CT34 may be greater than the center thickness of each of the first to seventh lenses. Here, the following condition may satisfy: CT34>ET34.

0<L2R1/L4R2<1 [Equation 94]

If the optical system 1000 according to the embodiment satisfies Equation 11, the optical system 1000 may have improved aberration characteristics.

0<CT34−ET34<2 [Equation 95]

In Equation 95, ET34 is an optical axis distance from the end of the effective region of the object-side surface of the third lens 123 to the end of the effective region of the sensor-side surface of the fourth lens 124. If the optical system satisfies Equation 95, the center thickness and the edge thickness of the cemented lens may be set to improve the aberration characteristics, and preferably, 0.5≤CT34/ET34<1.5 may be satisfied. The ET34 may be greater than the edge thickness of each of the first to seventh lenses.

0<CA11/CA31<2 [Equation 96]

If Equation 96 is satisfied, the optical system 1000 can control the incident light and set the elements that affect the aberration, and preferably, 1<CA11/CA31<1.8 may be satisfied.

0<CA72/CA42<2 [Equation 97]

If Equation 97 is satisfied, the optical system 1000 can control the incident light path and set the elements for the performance change according to the CRA and temperature. Preferably, Equation 97 may satisfy: 0.4<CA72/CA L4S2<1.0.

0<CA12/CA21<2 [Equation 98]

If Equation 98 is satisfied, the optical system 1000 can control the light traveling to the first lens group LG1 and the second lens group LG2, and can set a factor affecting the decrease in lens sensitivity. Equation 98 may preferably satisfy: 1<CA12/CA21<1.8.

0<CA31/CA42<2 [Equation 99]

If the optical system 1000 satisfies Equation 99, the effective diameter of the cemented lens may be set to a size smaller than the effective diameter of the first lens 121 and larger than the effective diameter of the seventh lens 127. Equation 99 may preferably satisfy: 0≤CA31/CA42<1.

0<CA31/CA32<2 [Equation 100]

When the optical system 1000 satisfies Equation 100, the optical system 1000 can improve chromatic aberration and set the size between the object-side surface and the sensor-side surface of the object-side third lens within the cemented lens. Accordingly, by setting a size of the effective diameter of the third lens arranged on the object side more than the plastic lens(es), the light incident through the cemented lens may be effectively guided to the plastic lens. Equation 100 may preferably satisfy: 0≤CA31/CA32<1. That is, a size of the effective diameter is designed to gradually decrease from the fourth lens to the sixth lens made of plastic, so that the light may be refracted and guided to the sixth and seventh lenses, which have relatively small effective diameters.

CA4>CA_PL1 [Equation 100-1]

In Equation 10-1, the CA4 is a size of the effective diameter (average effective diameter) of the fourth lens 124, and CA_PL1 may be a size of the effective diameter (average effective diameter) of the plastic lens closer to the object side than the sensor when two plastic lenses exist.

0<CA41/CA42<2 [Equation 101]

When the optical system 1000 satisfies Equation 18, the optical system 1000 can improve chromatic aberration, and can set the size between the object-side surface and the sensor-side surface of the fourth lens on the sensor side within the cemented lens 134. Accordingly, the effective diameter of the fourth lens closer to the object side than the plastic lens(es) may be set. Equation 101 may preferably satisfy: 0<CA51/CA52<1.5.

1.7<CA61−CA62<4 [Equation 101-1]

In Equation 101-1, the effective diameter difference between the object-side surface L6S1 and the sensor-side surface L6S2 of the sixth lens may exceed 1.7, may be greater than the effective diameter difference (mm) of other lenses, and may be the maximum within the optical system. Accordingly, by setting the effective diameter difference between the object-side surface and the sensor-side surface of the first plastic lens to the maximum, the light refracted through the sixth lens may be guided to the effective region of the last lens.

CA5>CA4>CA6 [Equation 101-2]

CA41>(Imgh*2) [Equation 101-3]

CA51>(Imgh*2) [Equation 101-4]

CA62<(Imgh*2) [Equation 101-5]

In Equations 101-2 to 101-5, the effective diameter of the fifth lens 125, the effective diameter of the object-side surface of the fourth lens 124, and the effective diameter of the object-side surface of the fifth lens 125 can set an optical path to the region of the image sensor 300.

In the embodiment, the fifth lens is a glass lens arranged on the object side of the plastic lens, and is arranged closest to the plastic lens, so that the effective diameter ratio of the object-side surface and the sensor-side surface of the fifth lens may satisfy Equation 101-2 or 101-4. In contrast, when the plastic lens closest to the object side is arranged in the n−3rd, n−4th, or n−5th position (n=6 to 8), the effective diameter ratio of the object-side surface GL1_S1 and the sensor-side surface GL1_S2 of the glass lens closest to the plastic lens while being arranged on the object-side surface of the n−3rd, n−4th, or n−5th plastic lens may satisfy: 1<CA_GL1_S1/CA_GL1_S2<2, or the effective diameter difference (mm) the object-side surface GL1_S1 and the sensor-side surface GL1_S2 of the glass lens may satisfy: 1.7<CA_GL1_S1−CA_GL_S2<3.

Equation 101 can further satisfy Equation 101-6.

1.1≤Last_GL_CAS1/Last_GL_CAS2≤1.5 [Equation 101-6]

In Equation 101-6, Last_GL_CAS1 means the effective diameter CAS1 of the object-side surface of the last glass lens Last_GL in the optical system, and Last_GL_CAS2 means the effective diameter CAS2 of the sensor-side surface of the last glass lens Last_GL in the optical system.

2<L5R1/(CA51/2)<5 [Equation 101-7]

When the fifth lens 125 having convex sides satisfies Equation 101-7, the optical system 1000 can improve chromatic aberration. If it is smaller than the lower limit value of Equation 101-7, the occurrence of aberration by the ninth surface increases, and if it is larger than the upper limit value, the occurrence of aberration on the ninth surface decreases, but since the radius of curvature of the tenth surface must be smaller, the occurrence of aberration on the tenth surface increases, and there is a problem that it affects the aberration of the sixth and seventh lenses. Preferably, if the range may satisfy: 2<L3R1/(CA31/2)<3, the radius of curvature of the sixth surface S6 may be designed to be large while reducing the aberration occurring on the fifth surface S5, making it easy to manufacture the third lens 123. The aberration occurring in the optical system may be reduced, and the production of the 3rd lens 123 may be made easier, thereby increasing the yield.

0.2<CA_GL_AVER/CA_PL_AVER<2.2 [Equation 102]

In Equation 102, CA_GL_AVER means the average effective diameter of glass lenses, and CA_PL_AVER means the average effective diameter of plastic lenses. In Equation 102, by setting the effective diameter size of the glass lens and the effective diameter size of the plastic lens, the path of the incident light may be effectively guided. Equation 102 preferably satisfies: 1.1<CA_GL_AVER/CA_PL_AVER<1.5. Here, nGL>nPL may be satisfied. The nGL is the number of lenses made of glass material, and nPL is the number of plastic lenses.

1.1≤GL_CAS1_AVER/PL_CAS1_AVER≤1.6 [Equation 103]

In Equation 103, GL_CAS1_AVER is an average of the effective diameters of the object-side faces of the glass lenses, for example, an average of the effective diameters of the object-side faces of the first to fifth lenses. PL_CAS1_AVER is an average of the effective diameters of the object-side faces of the plastic lenses, for example, an average of the effective diameters of the object-side faces of the sixth and seventh lenses. Since the effective diameter size of the plastic lens is designed to be relatively small compared to that of the glass lens, Equation 20 may be satisfied. This is because the effective diameter of the sensor-side face of the lens closest to the plastic lens, i.e., the fifth lens, is designed to be small, and the radius of curvature of the sixth lens is designed to be small, so that light may be guided to the effective region of the plastic lens, which has a relatively small effective diameter. Accordingly, the average of the object-side faces of the glass lens may be designed to be larger than the effective diameter of the object-side face of the plastic lens. Equation 103 preferably satisfies: 1.20≤GL_CAS1_AVER/PL_CAS1_AVER≤1.55.

CA6,CA7<CA5 [Equation 104]

If Equation 104 is satisfied, the optical system can guide light to the center and periphery of the image sensor 300 by setting the effective diameter of the plastic lens arranged between the fifth lens 125 and the image sensor 300 to be smaller than the effective diameter of the fifth lens 125, and improve chromatic aberration.

CG2<CG6<CG1 [Equation 105]

In Equation 105, CG2 may be the center distance between the second and third lenses, CG6 may be the center distance between the sixth and seventh lenses, and CG1 may be the center distance between the first and second lenses. If Equation 22 is satisfied, the center distance between the first, second, sixth, and seventh lenses may be set, so that the center distance may be reduced and the optical performance of the peripheral portion of the FOV may be improved.

G4<0.01 or CG4<0.01 [Equation 105-1]

In Equation 105-1, G4 and CG4 can set the distance and the center distance between the third lens 123 and the fourth lens 124. The G4 can include the distance in the optical axis or/and the distance in the edge. If Equation 105-1 is satisfied, the third and fourth lenses may be set as cemented lenses. Here, CT34=CT3+CT4+CG3 may be preferably satisfied. The center thickness CT3 and CT4 of the third and fourth lenses and the center distance CG3 of the third and fourth lenses may be set.

1<CT7/CG6<4 [Equation 106]

In Equation 106, CG6 is the center distance or optical axis distance between the sensor-side surface of the sixth lens 126 and the object-side surface of the seventh lens 127. In Equation 106, by setting the center thickness CT7 of the seventh lens 127 and the center distance between the sixth and seventh lenses, the optical performance at the periphery portion of the field of view may be improved. Equation 106 preferably satisfies: 2.5<CT7/CG6<3.

2*CT3<CT2<CG1 [Equation 107]

In Equation 107, by setting the center distance of the first and second lenses and the center thickness of the second lens to the maximum, the resolution and chromatic aberration may be improved, and the center distances between the third to seventh lenses may be reduced.

2*CT6<CG1<2*CT5 [Equation 108]

By setting the center thickness of the fifth and sixth lenses in Equation 108, chromatic aberration may be improved and the center distances between the sensor-side lenses, i.e., the third to seventh lenses, may be reduced.

0.3<(CT1+CG1+CT2)/TTL<0.45 [Equation 108-1]

Since the center thicknesses CT1 and CT2 of the first and second lenses and the center distance CT2 between the first and second lenses are arranged to exceed 30% of the TTL, the focal length of the light incident on the optical system may be designed so that the effective radius is not increased by each lens surface.

1<CT2/CT1<4 [Equation 109]

In Equation 109, by setting the center thickness CT2 of the second lens to be thicker than the center thickness CT1 of the first lens, factors affecting aberration may be controlled. Preferably, Equation 109 may satisfy: 1.1<CT2/CT1<2.

1<L7R1/CT7<20 [Equation 110]

In Equation 110, by setting the radius of curvature of the object-side surface of the seventh lens and the center thickness CT7 of the seventh lens, the refractive power of the seventh lens may be controlled. Accordingly, good optical performance may be achieved at the center and periphery portions of the field of view. Preferably, Equation 110 may satisfy: 1<L7R1/CT7<10.

0<|L5R2/L7R1|<10 [Equation 111]

In Equation 111, by setting the radius of curvature of the sensor-side surface of the fifth lens and the radius of curvature of the object-side surface of the seventh lens, the refractive power of the fifth and seventh lenses may be controlled. Accordingly, good optical performance may be achieved at the center and periphery portions of the field of view. Preferably, Equation 111 may satisfy: 1<|L5R2/L7R1|<7.

L3R1*L4R2<0 [Equation 112]

In Equation 112, L3R1 means the radius of curvature of the object-side surface of the third lens, and L4R2 means the radius of curvature of the sensor-side surface of the fourth lens. When Equation 112 is satisfied, the refractive power of the cemented lens may be controlled, thereby controlling the light path incident on the plastic lens. Equation 112 may satisfy the following condition: 100<|L4R1*L5R2|.

0<|L5R1/L4R2|<2 [Equation 113]

In Equation 113, L5R1 means the radius of curvature of the object-side surface of the fifth lens. In Equation 113, by setting the radius of curvature of the sensor-side surface of the fourth lens and the object-side surface of the fifth lens, light may be effectively refracted from the cemented lens toward the plastic lens. Equation 113 may preferably satisfy: 0<L5R1/L4R2<1.

|LR|Min<PL1_R1 [Equation 113-1]

Here, |LR|Min means the minimum radius of curvature among all lenses, and PL1_R1 means the radius of curvature of the object-side surface of the plastic lens closest to the object side. If Equation 113-1 is satisfied, the plastic lens is arranged closer to the sensor than the sensor-side surface of the glass lens having the minimum radius of curvature, so that light may be refracted toward the incident surface of the plastic lens.

0<L6R2/L6R1<2 [Equation 114]

In Equation 114, by setting the radius of curvature of the object-side surface and the sensor-side surface of the sixth lens, the plastic lens can effectively refract the incident light toward the image sensor. Equation 114 may preferably satisfy: 0<|L6R2/L6R1|<1. Here, the following conditions may satisfy: L6R1>0, L6R2>0, and L6R1<L6R2.

0<L7R1/L7R2<2 [Equation 114-1]

In Equation 114-1, L7R1 and L7R2 mean the radius of curvature of the object-side surface and the sensor-side surface of the seventh lens. In Equation 114-1, by setting the radius of curvature of the object-side surface and the sensor-side surface of the seventh lens, light may be refracted to the image sensor 300 through the plastic lens. Equation 114-1 preferably satisfies: 0<|L7R1/L7R2|<1. Here, the following conditions may satisfy: L7R1>0, L7R2>0, and L7R2<L7R1.

0.5<L6R1/L7R1<1.5 [Equation 114-2]

0.5<L7R2/L6R1<1.5 [Equation 114-3]

By reducing the difference in curvature radius between the lens surfaces of the sixth lens 126 and the seventh lens 127, light may be stably guided toward the image sensor 300.

0<CT_Max/CG_Max<5 [Equation 115]

In Equation 115, the maximum center thickness CT_Max among the lenses and the maximum distance CT_Max between adjacent lenses may be set. If Equation 115 is satisfied, the optical system may have good optical performance at the focal length at the set field of view and can reduce the TTL. Preferably, 0<CT_Max/CG_Max<1 may be satisfied.

1<ΣCT/ΣCG<5 [Equation 116]

Equation 16 may satisfy: 2<ΣCT/ΣCG<4.5.

8<ΣNd<30 [Equation 117]

Equation 117 may preferably satisfy: 10<ΣNd<20.

10<ΣVd/ΣNd<50 [Equation 118]

Equation 118 may satisfy: 10<ΣVd/ΣNd<40.

Distortion<2 [Equation 119]

Equation 119 may satisfy: Distortion≤1.5.

0<ΣCT/ΣET<2 [Equation 120]

Equation 120 may satisfy: 0.5<ΣCT/ΣET<1.5.

0.5<CA11/CA_min<2.5 [Equation 121]

Equation 121 may preferably satisfy: 1<CA11/CA_min<2.

0.5<CA_max/CA_min<2 [Equation 122]

Equation 122 may satisfy: 1<CA_max/CA_min<2. Here, the maximum effective diameter is the second surface S2 of the first lens 121, and the minimum effective diameter is the fourteenth surface S14 of the seventh lens 127.

1<CA_max/CA_Aver<3 [Equation 123]

Equation 123 may satisfy: 1<CA_max/CA_Aver<1.5.

0.5<CA_min/CA_Aver<2 [Equation 124]

Equation 124 may satisfy: 0.5<CA_min/CA_Aver<1.

1<CA_max/(2*ImgH)<3 [Equation 125]

Equation 125 may satisfy: 1<CA_max/(2*ImgH)<2.

1<TD/CA_max<4 [Equation 126]

Equation 126 may satisfy: 1.5<TD/CA_max<3.

1<F/CA61<10 [Equation 127]

In Equation 127, F may be 10 mm or more, for example, in the range of 10 mm to 20 mm. In Equation 127, the relationship between the effective focal length and the effective diameter of the object-side surface of the plastic lens is set, so that the influence on the optical system reduction, for example, TTL, may be controlled. Equation 127 may preferably satisfy: 1<F/CA61<5. Here, F1 is 121 mm or more, for example, in the range of 121 mm to 182 mm. F2 is −128 mm or less, for example, in the range of −128 mm to −193 mm. F3 is −17 mm or less, for example, in the range of −17 mm to 27 mm. F4 is 13 mm or more, for example, in the range of 13 mm to 21 mm. F5 is 17 mm or more, for example, in the range of 17 mm to 26 mm. F6 is −38 mm or less, for example, in the range of 38 mm to −57.5 mm. F7 is −311 mm or less, for example, in the range of −311 mm to −467 mm. The sum of the focal lengths of the first to sixth lenses may be set to 5 mm or more, for example, in the range of 5 mm to 8 mm. The balance of the respective focal lengths of the first to fifth lenses can suppress the difference in pint position due to temperature change. Accordingly, it is possible to suppress the optical characteristics of the imaging lenses from being degraded due to temperature changes.

The aperture stop is arranged on the object side of the second lens 122. The focal length of the lens arranged on the sensor side more than the aperture and closest to the aperture stop is greater than 0. In an embodiment of the invention, the focal length F1 of the first lens 121 should be designed to be greater than 0. In this case, the first lens 121 collects light, so that the effective diameter of the third to seventh lenses, which are lenses arranged closer to the sensor than the second lens 122, may be prevented from increasing. In addition, since the TTL may be prevented from becoming longer, miniaturization of the optical system is possible. The composite focal length of the lens arranged on the sensor side more than the aperture stop, that is, the lens arranged closer to the sensor than the aperture stop, is designed to be greater than 0. In an embodiment of the invention, the composite focal length of the third to seventh lenses may be designed to be greater than 0. In this case, the optical system may be miniaturized by reducing the TTL at a horizontal field of view FOV_H of 25 to 35 degrees.

0<F/L1R1<1 [Equation 128]

Equation 128 may satisfy: 0.2≤F/L1R1≤0.85.

Max_th/Min_th<3 [Equation 129]

In Equation 129, Max_th is the thickness of the thickest region of the lens, and Min_th is the thickness of the thinnest region of the lens. Max_th/Min_th is the ratio of the thickest thickness to the thinnest thickness of each lens. The thickest thickness Max_th of the lens may be the center thickness CT of the lens, and the thinnest thickness Min_th of the lens may be the edge thickness ET of the lens, but the opposite case is also possible. The thickest thickness Max_th of the lens may be the edge thickness ET of the lens, and the thinnest thickness Min_th of the lens may be the center thickness CT of the lens. The edge thickness ET means the thickness at the end of the effective lens. If Equation 129 is satisfied, the optical system can control the influence on the effective focal length. Equation 129 may preferably satisfy: 2<Max_th/Min_th≤2.8.

Here, the ratio of the maximum thickness and the minimum thickness of the plastic lenses may satisfy the following condition. Max_PL_th may be the thickness value of the thickest region of the plastic lens, and Min_PL_th may be the thickness value of the thinnest region of the plastic lens. Max_PL_th may be the center thickness CT of the plastic lens, and Min_PL_th may be the edge thickness ET of the plastic lens. The edge thickness ET means the thickness at the end of the effective lens. The opposite case is also possible. Max_PL_th may be the edge thickness ET of the plastic lens, and Min_PL_th may be the center thickness CT of the plastic lens. The edge thickness ET means the thickness at the end of the effective diameter.
Condition 1:1.0<Max_PL_th/Min_PL_th<2.5

If the value of the above condition 1 is smaller than the lower limit, it is difficult to manufacture the plastic lens. That is, it is manufactured by injecting high-temperature resin and hardening it at a low temperature, but if the thickness difference is large, the lens may shrink unevenly as it cools at a low temperature, which may result in a high surface defect rate. In addition, if it is larger than the range of condition 1, the plastic lens shrinks and expands as the temperature changes from −40 degrees to 105 degrees, and during this process, the rate of change in the lens shape appears significantly, which may deteriorate the optical performance. Preferably, the following condition may satisfy: 1.0<PL_CT/PL_ET<2 or 1.1<PL_Max_CT/PL_Min_CT<1.5.

3<Max(EG/CG)<50 [Equation 129-1]

In Equation 129-1, Max (EG/CG) can set a value at which the ratio of the center distance CG and the edge thickness EG between adjacent lenses is the maximum. When Equation 129-1 is satisfied, the optical system can adjust the influence on the effective focal length. Equation 129-1 may preferably satisfy: 10<Max (EG/CG)≤40. The condition of Max (EG/CG) may be the distance between the fifth and sixth lenses.

1<Min(CT/ET)<1.5 [Equation 129-2]

In Equation 129-2, Min (CT/ET) can set a value that has a minimum ratio of the center thickness and edge thickness of each lens. If Equation 129-2 is satisfied, the optical system can control the influence on the effective focal length. Equation 129-2 may preferably satisfy: 1<Min (CT/ET)≤1.1.

0<EPD/L1R1<1 [Equation 130]

If Equation 130 is satisfied, the optical system 1000 can control the incident light. Equation 47 may preferably satisfy: 0<EPD/L1R1≤0.8.

−10<F1/F3<0 [Equation 131]

If Equation 131 is satisfied, the resolution may be improved by controlling the refractive power of the first and third lenses, and the TTL and EFL may be affected.

|F3|>F4 [Equation 131-1]

|F3|<F6 [Equation 131-2]

F5<|F7| [Equation 131-3]

In Equations 131-1 to 131-3, the focal length of the fifth lens closest to the plastic lens may be greater than the focal length of the fourth lens and less than the focal lengths of the sixth and seventh lenses. Accordingly, the refractive power of the last glass lens may be controlled to effectively guide the plastic lens.

Po3*Po4<0 [Equation 132]

Po3 is the refractive power value of the third lens, and Po4 is the refractive power value of the fourth lens. That is, the refractive powers of the third and fourth lenses have opposite refractive powers, so that aberration may be improved and light may be effectively guided by the plastic lens. If a value of Po4*Po5 is greater than 0, the effect of improving chromatic aberration as a cemented lens may be minimal.

Po1(Po4*Po5)<0 [Equation 132-1]

F34>0 [Equation 132-2]

F3*F4<0 [Equation 132-3]

Po1 is the refractive power value of the first lens, and F34 is the composite focal length of the third and fourth lenses. When Equations 132-1 to 132-3 are satisfied, it is easy to improve the aberration of the optical system with a cemented lens, and the incident light may be effectively guided to the plastic lens. Here, the first and second lenses 121 and 122 have opposite focal lengths and the dispersion value difference is arranged between 20 and 60, so that chromatic aberration may be compensated for each other.

15<v4−v3<60 [Equation 133]

In Equation 13, v3 is the Abbe number of the third lens, and v4 is the Abbe number of the fourth lens. When Equation 133 is satisfied, the difference in Abbe numbers of at least two lenses forming the cemented lens may be maintained at a certain value or more, and chromatic aberration may be improved. Equation 133 preferably satisfies: 20≤v4−v3≤55. If the cemented lens is less than the lower limit of Equation 133, it may be insignificant in improving the aberration characteristics of the optical system. Accordingly, if the difference in Abbe numbers between the object-side lens and the sensor-side lens in the cemented lens is 20 or more and 55 or less, the aberration characteristics may be improved.

0<F1/F<20 [Equation 134]

Equation 134 sets the relationship between the focal length F1 of the first lens and the effective focal length F, thereby setting the TTL of the optical system. Equation 134 preferably satisfies: 5<F1/F<15.

0<|F5/F6|<1 [Equation 135]

Equation 135 may preferably satisfy: 0<|F5/F6|<0.7.

0<|F5/F7|<1 [Equation 136]

Equation 136 may preferably satisfy: 0<|F5/F7|<0.2.

0<|F6/F1|<1 [Equation 137]

Equation 137 may preferably satisfy: 0.5<|F6/F1|<0.5.

0<F27/F<2 [Equation 138]

In Equation 138, the relationship between the composite focal length F27 of the second to seventh lenses and the effective focal length F is set, so that the refractive power of the second to seventh lenses may be controlled to improve the resolution, and the optical system may be provided in a slim and compact size. Equation 138 preferably satisfies: 0.5<F27/F<1.5.

0<|F27<F6|<1 [Equation 139]

In Equation 139, the relationship between the composite focal length F27 of the second to seventh lenses and the focal length F6 of the sixth lens is set, so that the composite refractive power of the second to seventh lenses and the refractive power of the plastic lens may be controlled to improve the resolution, and the optical system may be provided in a slim and compact size. Equation 139 preferably satisfies: 0<|F27<F6|<0.8.

0<|F27<F7|<1 [Equation 140]

In Equation 140, the relationship between the composite focal length F27 of the second to seventh lenses and the focal length F7 of the seventh lens is set, so that the refractive power of the second to seventh lenses and the refractive power of the last plastic lens may be adjusted to improve the resolution, and the optical system may be provided in a slim and compact size. Equation 140 preferably satisfies: 0<|F27<F7|<0.5.

0<|F6/F|<5 [Equation 141]

Equation 141 preferably satisfies: 1<|F6/F|<4.

F_LG1/F_LG2>0 [Equation 142]

In Equation 142, the relationship between the focal length F_LG1 of the first lens group LG1 and the focal length of the second lens group F_LG2 may be set. The focal length of the first lens group may have a negative value, and the focal length of the second lens group may have a positive value. When Equation 59 is satisfied, the optical system 1000 can improve aberration characteristics such as chromatic aberration and distortion aberration. Equation 142 may preferably satisfy: 2<F_LG1/F_LG2<20.

1<nGL/nPL<4 [Equation 143]

In Equation 60, by arranging the number of lenses nPL made of plastic material to be 1 time more than the number nGL of glass lenses, the thickness of the optical system may be reduced and a wider range of refractive powers may be provided through the aspherical surface. Equation 143 preferably satisfies: 1<nGL/nPL<3.

CA2<CA5<CA1 [Equation 144]

In Equation 144, the size relationship of the average effective diameters CA1, CA2, and CA5 of the object-side surface and the sensor-side surface of the first, second, and fifth lenses may be set. If Equation 144 is satisfied, the first and second lens groups may be set, and aberration may be improved through the first lens of the second lens group LG2. The CA1 may have the maximum effective diameter in the optical system.

0<ΣPL_CT/ΣGL_CT<1 [Equation 145]

Equation 145 preferably satisfies: 0<ΣPL_CT/ΣGL_CT<0.5.

0<ΣPL_Nd/ΣGL_Nd<1 [Equation 146]

In Equation 146, ΣPL_Nd is the sum of the refractive index thicknesses of the plastic lens(es) at the d-line, and ΣGL_Nd is the sum of the refractive indices of the glass lenses at the d-line. If Equation 146 is satisfied, the overall resolution may be controlled by setting the refractive index relationship of the plastic lens and the glass lens. Equation 146 may preferably satisfy: 0<ΣPL_Nd/ΣGL_Nd<0.5.

10 mm<TTL<50 mm [Equation 147]

In Equation 147, the TTL may be set to exceed 10 mm or 20 mm, thereby providing an optical system for a vehicle. Equation 147 may preferably satisfy: 35 mm<TTL<45 mm or the condition of TD<TTL.

2 mm<ImgH [Equation 148]

Equation 148 can set the diagonal size (2*ImgH) of the image sensor 300 and can provide an optical system having a vehicle sensor size. Equation 148 may preferably satisfy: 4 mm≤ImgH<8 mm.

2 mm<BFL<7 mm [Equation 149]

Equation 149 may preferably satisfy: 2.5 mm<BFL≤6.5 mm. If the BFL is less than the range of Equation 149, some of the light that proceeds to the image sensor may not be transmitted to the image sensor, which may be a cause of resolution degradation. If the BFL exceeds the range of Equation 149, stray light may be introduced, which may deteriorate the aberration characteristics of the optical system.

0.5<BFL/CG1<2 [Equation 150]

In Equation 150, BFL is set to be smaller than the distance between the lenses, for example, the center distance CG1 between the first and second lenses, so that the installation space of the filter 500 and the cover glass 400 may be secured, and the assemblability of the components may be improved and the joint reliability may be improved through the distance between the image sensor 300 and the last lens. Equation 150 may satisfy: 0.5<BFL/CG1≤1.

CG4,CG5,CG6<BFL [Equation 151]

In Equation 151, BFL is set to be larger than the spacing between the lenses, for example, the center distance CG4 between the fourth and fifth lenses, the center distance CG5 between the fifth and sixth lenses, and the center distance CG6 between the sixth and seventh lenses, so that the installation space for the filter 500 and the cover glass 400 may be secured, and the assemblability of the components may be improved and the bonding reliability may be improved through the spacing between the image sensor 300 and the last lens. In addition, the last lens, the seventh lens, can disperse the incident light to the effective region of the image sensor, but if the BFL does not satisfy Equation 151, some of the emitted light may not be transmitted to the effective region of the image sensor, which may deteriorate the resolution.

3 mm<F<40 mm [Equation 152]

Equation 152 can set the total focal length F to suit the vehicle optical system. Equation 152 may satisfy: 5 mm<F<30 mm.

FOV<45 degrees [Equation 153]

It may satisfy: 20 degrees≤FOV≤40 degrees.

1<TTL/CA_max<5 [Equation 154]

Equation 154 may preferably satisfy: 1.5<TTL/CA_max≤4.

2<TTL/ImgH<15 [Equation 155]

Equation 155 may preferably satisfy: 4<TTL/ImgH<10.

0.1<BFL/ImgH<2 [Equation 156]

Equation 156 may preferably satisfy: 1<BFL/ImgH<1.5.

1<TTL/BFL<20 [Equation 157]

Equation 157 may preferably satisfy: 4<TTL/BFL<10.

1.5<TTL/F<4 [Equation 158]

Equation 158 can set the total focal length F and the total optical axis length TTL of the optical system 1000. Accordingly, an optical system for a driver assistance system may be provided. Equation 158 may preferably satisfy: 2≤TTL/F≤3 or 2.2≤TTL/F≤2.8. When the optical system 1000 according to the embodiment satisfies the Equation 158, the optical system 1000 may have an appropriate focal length in the set TTL range, and can provide an optical system that can maintain an appropriate focal length and form an image even when the temperature changes from low to high. When it is less than the lower limit of the Equation 75, it is necessary to increase the refractive power of the lenses, so that correction of spherical aberration or distortion aberration becomes difficult, and when it exceeds the upper limit of the Equation 75, the effective diameter or TTL of the lenses becomes longer, which may cause a problem of the enlargement of the imaging lens system.

1<F/BFL<10 [Equation 159]

Equation 159 may preferably satisfy: 1<F/BFL<3.

1<F/ImgH<5 [Equation 160]

Equation 160 may preferably satisfy: 2<F/ImgH<4.1.

1<F/EPD<5 [Equation 161]

Equation 161 can preferably satisfy: 1<F/EPD<3.

0<BFL/TD<0.3 [Equation 162]

Equation 162 may preferably satisfy: 0<BFL/TD<0.2. When the condition value of BFL/TD is 0.2 or more, since the BFL is designed to be large compared to the TD, the size of the entire optical system becomes large, making it difficult to miniaturize the optical system, and the distance between the seventh lens and the image sensor becomes long, which may increase the amount of unnecessary light through the seventh lens and the image sensor, resulting in a problem of lowering the resolution such as deterioration of aberration characteristics.

0<EPD/Imgh/FOV<0.2 [Equation 163]

Equation 163 may preferably satisfy: 0<EPD/Imgh/FOV<0.1.

5<FOV/F#<40 [Equation 164]

Equation 164 may preferably satisfy: 10<FOV/F #<30. Here, F # is provided to be 1.6 or less to provide a bright image.

1<ΣGL_CT/F#<20 [Equation 165]

Equation 165 may preferably satisfy: 5<ΣGL_CT/F #<10.

1<ΣPL_CT/F#<20 [Equation 166]

Equation 166 may preferably satisfy: 5<ΣPL_CT/F #<10.

1<ΣGL_Nd/F#<20 [Equation 167]

Equation 167 can set the relationship between the sum ΣGL_Nd of refractive indices of glass lenses of the optical system and the F number (F #). Equation 167 may preferably satisfy: 1<ΣGL_Nd/F #<10.

1<ΣPL_Nd/F#<10 [Equation 168]

Equation 168 can set the relationship between the sum ΣPL_Nd of refractive indices of plastic lenses of the optical system and the F number (F #). Equation 168 preferably satisfies: 1<ΣPL_Nd/F #<5.

0.5<0<Max_Sag61/Max_Sag62<0.5<1.5 [Equation 169]

In Equation 169, Max_Sag61 is the maximum Sag value on the object-side surface of the sixth lens, and Max_Sag62 is the maximum Sag value on the sensor-side surface of the sixth lens. When Equation 169 is satisfied, the refractive power may be improved by adjusting the thickness and curvature radius of the sixth lens. Equation 169 preferably satisfies: 0.8<Max_Sag61/Max_Sag62<1.2.

0.5<Max_Sag71/Max_Sag72<1.5 [Equation 170]

In Equation 170, Max_Sag71 is the maximum Sag value on the object-side surface of the seventh lens, and Max_Sag72 is the maximum Sag value on the sensor-side surface of the seventh lens. If Equation 170 is satisfied, the thickness and curvature radius of the seventh lens may be adjusted to improve the refractive power. Equation 170 may preferably satisfy: 0.8<Max_Sag71/Max_Sag72<1.2.

Here, the maximum Sag values of the sixth and seventh lenses may satisfy the following conditions.
1) Max_Sag61>Max_Sag71
2) Max_Sag62>Max_Sag72

0<CG6/G6_min<10 [Equation 171]

In Equation 171, CG6 is the center distance between the sixth and seventh lenses, and G6 Min is the minimum distance between the sixth and seventh lenses. Accordingly, the distance between the two lenses made of plastic may be set. Preferably, the following condition may satisfy: 3<CG6/G6_min<7.

0.05<|Sag_i/(CA_i/2)|<0.2(i=S1,S2,S3,S4) [Equation 172]

Equation 172 can set the relationship between the Sag value of the first to fourth surfaces S1,S2,S3, and S4 of the first and second lenses and the effective diameter CA, and if it satisfies this, the refractive power of the lenses may be improved. Here, if Equation 172 further satisfies the condition of n1>1.7, it is possible for the first and second lenses 121 and 122 to gather light with sufficient power without designing the curvature radius of the first and second lenses sharply within the effective diameter.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + … \qquad [ Equation 173 ]$$

In the Equation 173, Z may mean a distance in the direction of the optical axis from an arbitrary position on the aspherical surface to the vertex of the aspherical surface. The Y may mean a distance in the direction perpendicular to the optical axis from an arbitrary position on the aspherical surface to the optical axis. The c may mean the curvature of the lens, and K may mean the conic constant. In addition, A, B, C, D, E, and F may mean aspheric coefficients.

The optical system 1000 according to the third embodiment may satisfy at least one or two or more of the Equations, and may have improved optical characteristics, improved resolution, and improved aberration and distortion characteristics. In addition, the optical system 1000 can secure BFL for applying a vehicle image sensor 300, compensate for the deterioration of optical characteristics due to temperature change, and minimize the distance between the last lens and the image sensor 300, thereby providing good optical performance at the center and periphery portions of the FOV.

Table 6 shows the items of the Equations described above in the optical system 1000 of the embodiment, including the TTL, BFL, effective focal length F, ImgH (mm), effective diameter CA (mm), thickness (mm), TD (mm), which is the optical axis distance from the first surface S1 to the fourteenth surface S14, the focal length F1-F7 (mm) of each of the first to seventh lenses, the sum of refractive indices, the sum of Abbe numbers, the sum of thicknesses (mm), the sum of distances between adjacent lenses, the effective diameter characteristic, the sum of refractive indices of glass lenses, the sum of refractive indices of plastic materials, the FOV (Degree), the edge thickness ET, the focal lengths of the first and second lens groups, and the F number, etc. of the optical system 1000.

TABLE 6

| Items | Values | Items | Values |
|---|---|---|---|
| F | 15.8000 | ET1 | 2.544 |
| F1 | 151.281 | ET2 | 5.266 |
| F2 | −161.097 | ET3 | 3.256 |
| F3 | −22.431 | ET4 | 2.140 |
| F4 | 17.265 | ET5 | 2.224 |
| F5 | 21.395 | ET6 | 3.327 |
| F6 | −47.730 | ET7 | 3.271 |
| F7 | −389.233 | F-number | 1.600 |
| F_LG1 | 151.281 | FOV | 32.418 |
| F_LG2 | 15.257 | EPD | 9.875 |
| ΣIndex | 11.739 | BFL | 5.936 |
| ΣAbbe | 11.439 | TD | 34.064 |
| ΣCT | 366.689 | ImgH | 4.630 |
| ΣCG | 25.171 | SD | 18.618 |
| CA_max | 15.533 | TTL | 32.418 |
| CA_min | 8.621 | ΣGL_Nd | 8.222 |
| CA_Aver | 11.867 | ΣPL_Nd | 3.217 |
| CT_max | 4.997 | Image sensor | 3840*2160 |
| CT_min | 2.000 | F15 | 16.418 |
| CT_Aver | 3.596 | F67 | −38.086 |

Table 7 shows the result values for the Equations 84 to 133 described above in the optical system 1000 of the embodiment. Referring to Table 7, it may be seen that the optical system 1000 satisfies at least one, two or more, or three or more of the Equations 84 to 133. Accordingly, the optical system 1000 may have good optical performance and excellent optical characteristics at the center and periphery of the FOV.

TABLE 7

| Equations | | Values |
|---|---|---|
| 84 | 0.5 < CT6/CT7 < 2 | 1.075 |
| 85 | 0.5 < CT1/ET1 < 2 | 1.179 |
| 86 | Po1 < 0 | 0.007 |
| 87 | 1.7 < n1 < 2.2 | 1.856 |
| 88 | 20 < FOV_H < 40 | 29.800 |
| 89 | L1R1 > 0 | 19.995 |
| 90 | 2 < L7S2_max_sag to Sensor < 6 | 4.509 |
| 91 | 0.1 < CT1/CT7 < 5 | 0.935 |
| 92 | 0 < CT1/CT6 < 3 | 0.870 |
| 93 | 1 < CT34/CT6 < 5 | 1.843 |
| 94 | 0 < L2R1/L4R2 < 1 | 0.330 |
| 95 | 0 < (CT45 − ET45) < 2 | 1.952 |
| 96 | 0 < CA11/CA31 < 2 | 1.389 |
| 97 | 0 < CA72/CA42 < 2 | 0.673 |
| 98 | 0 < CA12/CA21 < 2 | 1.344 |
| 99 | 0 < CA31/CA42 < 2 | 0.874 |
| 100 | 0 < CA31/CA32 < 2 | 0.938 |
| 101 | 0 < CA41/CA42 < 2 | 0.931 |
| 102 | 0.2 < CA_GL_AVER/CA_PL_AVER < 2.2 | 1.218 |
| 103 | 1.10 < GL_CAS1_AVER/PL_CAS1_AVER < | 0.000 |
| | 1.60 | |
| 104 | CA6, CA7 < CA5 | Satisfaction |
| 105 | CG2 < CG6 < CG1 | Satisfaction |
| 106 | 1 < CT7/CG6 < 4 | 2.805 |
| 107 | (2*CT3) < CT2 < CG1 | Satisfaction |
| 108 | 2*CT6 < CG1 < 2*CT5 | Satisfaction |
| 109 | 1 < CT2/CT1 < 4 | 1.666 |
| 110 | 1 < L7R1/CT7 < 20 | 2.852 |
| 111 | 0 < \| L5R2/L7R1 \| < 10 | 4.447 |
| 112 | L3R1*L4R2 < 0 | −1381.423 |
| 113 | 0 < \| L5R1/L4R2 \| < 2 | 0.495 |
| 114 | 0 < L6R2/L6R1 < 2 | 0.660 |
| 115 | 0 < CT_Max/CG_Max < 5 | 0.671 |
| 116 | 1 < ΣCT/ΣCG < 5 | 2.831 |
| 117 | 8 < ΣIndex < 30 | 11.439 |
| 118 | 10 < ΣAbb/ΣIndex < 50 | 32.057 |
| 119 | Distortion < 2 | 0.478 |
| 120 | 0 < ΣCT/ΣET < 2 | 1.143 |
| 121 | 0.5 < CA11/CA_min < 2.5 | 1.802 |
| 122 | 1 < CA_max/CA_min < 5 | 1.802 |
| 123 | 1 < CA_max/CA_Aver < 3 | 1.309 |
| 124 | 0.5 < CA_min/CA_Aver < 2 | 0.726 |
| 125 | 1 < CA_max/(2*ImgH) < 3 | 1.677 |
| 126 | 1 < TD/CA_max < 4 | 2.193 |
| 127 | 1 < F/CA61 < 10 | 1.236 |
| 128 | 0 < F/L1R1 < 1 | 0.790 |
| 129 | Max_th/Min_th < 3 | 2.661 |
| 130 | 0 < EPD/L1R1 < 1 | 0.494 |
| 131 | −10 < F1/F3 < 0 | −6.744 |
| 132 | Po3 * Po4 < 0 | Satisfaction |
| 133 | 15 v4 − v3 < 60 | 6.112 |

Table 8 shows the result values for the Equations 134 to 172 described above in the optical system 1000 of the fourth embodiment. Referring to Table 6, it may be seen that the optical system 1000 satisfies at least one, two or more, or three or more of the Equations 134 to 172. Accordingly, the optical system 1000 may have good optical performance and excellent optical characteristics at the center and periphery of the FOV.

TABLE 8

| | |
|---|---|
| Equations | Values |

| | | |
|---|---|---|
| 134 | 0 < F1/F < 20 | 9.575 |
| 135 | 0 < \| F5/F6 \| < 1 | 0.448 |
| 136 | 0 < \| F5/F7 \| < 1 | 0.055 |
| 137 | 0 < \| F6/F1 \| < 1 | 0.316 |
| 138 | 0 < F27/F < 2 | 0.966 |
| 139 | 0 < \| F27 < F6 \| < 1 | 0.320 |
| 140 | 0 < \| F27 < F7 \| < 1 | 0.039 |
| 141 | 0 < \| F6/F \| < 5 | 3.021 |
| 142 | F_LG1/F_LG2 > 0 | 9.916 |
| 143 | 1 < nGL/nPL < 4 | 2.500 |
| 144 | CA_L2 < CA_L3 > CA_L4 | Satisfaction |
| 145 | 0 < ΣPL_CT/ΣGL_CT < 1 | 0.360 |
| 146 | 0 < ΣPL_Nd/ΣGL_Nd < 1 | 0.391 |
| 147 | 10 < TTL < 50 | 40.000 |
| 148 | 2 < ImgH | 4.630 |
| 149 | 2 < BFL < 7 | 5.936 |
| 150 | 0.5 < BFL/CG1 < 2 | 0.797 |
| 151 | CG2, CG3, CG5, CG6 < BFL | Satisfaction |
| 152 | 3 < F < 40 | 15.800 |
| 153 | FOV < 45 | 32.418 |
| 154 | 1 < TTL/CA_max < 5 | 2.575 |
| 155 | 2 < TTL/ImgH < 15 | 8.639 |
| 156 | 0.1 < BFL/ImgH < 2 | 1.282 |
| 157 | 1 < TTL/BFL < 20 | 6.738 |
| 158 | 1.5 < TTL/F < 4 | 2.532 |
| 159 | 1 < F/BFL < 10 | 2.662 |
| 160 | 1 < F/ImgH < 5 | 3.413 |
| 161 | 1 < F/EPD < 5 | 1.600 |
| 162 | 0 < BFL/TD < 0.3 | 0.1743 |
| 163 | 0 < EPD/Imgh/FOV < 0.2 | 0.0658 |
| 164 | 5 < FOV/F# < 40 | 21.355 |
| 165 | 1 < ΣGL_CT/F# < 20 | 7.816 |
| 166 | 1 < ΣPL_CT/F# < 20 | 6.418 |
| 167 | 1 < ΣGL_Nd/F# < 20 | 5.139 |
| 168 | 1 < ΣPL_Nd/F# < 10 | 2.010 |
| 169 | 0 < Max_Sag61/Max_Sag62 < 0.5 | 1.049 |
| 170 | 0 < Max_Sag71/Max_Sag72 < 0.5 | 0.964 |
| 171 | 0 < CG6/G6_min < 1 | 0.204 |
| 172 | 0.05 < \| Sag_i/(CA_i/2) \| < | Satisfaction |
| | 0.2 (i = S1, S2, S3, S4) | |

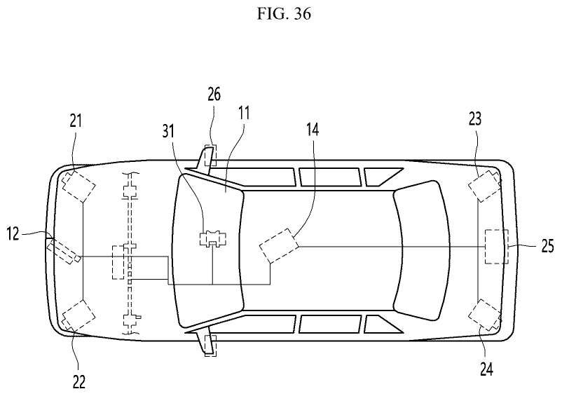

FIG. 36 is an example of a plan view of a vehicle to which a camera module or optical system according to an embodiment of the invention is applied. Referring to FIG. 36, a vehicle camera system according to an embodiment of the invention includes an image generating unit 11, a first information generating unit 12, a second information generating unit 21, 22, 23, 24, 25, and 26, and a control unit 14. The image generating unit 11 may include at least one camera module 31 disposed in the vehicle, and may capture images of the front of the vehicle and/or the driver to generate images of the front or interior of the vehicle. The image generating unit 11 may capture images of the front of the vehicle as well as the surroundings of the vehicle in one or more directions using the camera module 31, to generate images of the surroundings of the vehicle. Here, the front and surrounding images may be digital images, and may include color images, black and white images, and infrared images. In addition, the front and surrounding images may include still images and moving images. The image generating unit 11 provides the driver image, the front image, and the surrounding image to the control unit 14. Next, the first information generating unit 12 may include at least one radar and/or camera placed in the own vehicle, and detects the front of the own vehicle to generate the first detection information. Specifically, the first information generating unit 12 is placed in the own vehicle and detects the position and speed of vehicles located in front of the own vehicle, whether there is a pedestrian, and the position, etc. to generate the first detection information.

Using the first detection information generated by the first information generating unit 12, the distance between the own vehicle and the vehicle in front may be controlled to be maintained at a constant level, and the stability of vehicle operation may be increased in specific cases set in advance, such as when the driver wants to change the driving lane of the own vehicle or when parking in reverse. The first information generating unit 12 provides the first detection information to the control unit 14. The second information generating unit 21, 22, 23, 24, 25, and 26 detects each side of the own vehicle based on the front image generated by the image generating unit 11 and the first detection information generated by the first information generating unit 12 to generate the second detection information. Specifically, the second information generating unit 21, 22, 23, 24, 25, and 26 may include at least one radar and/or camera disposed on the own vehicle, and may detect the position and speed of vehicles located on the side of the own vehicle or capture images. Here, the second information generating unit 21, 22, 23, 24, 25, and 26 may be disposed on each of the front corners, side mirrors, and the rear center and rear corners of the own vehicle.

At least one information generating unit of these vehicle camera systems may be equipped with an optical system and a camera module having the same as described in the above-described embodiments, and may provide or process information acquired through the front, rear, each side, or corner region of the vehicle to a user to enable autonomous driving or to protect the vehicle and objects from surrounding safety. The optical system of the camera module according to the embodiment of the invention may be mounted in multiple units in the vehicle to enhance safety regulations, autonomous driving functions, and increase convenience.

In addition, the optical system of the camera module is applied in a vehicle as a component for control such as a lane keeping assistance system (LKAS), a lane departure warning system (LDWS), and a driver monitoring system (DMS). This vehicle camera module can implement stable optical performance even under ambient temperature changes and can provide a module with price competitiveness, thereby ensuring the reliability of vehicle components.

Features, structures, effects, etc. described in the embodiments are included in at least one embodiment of the invention, and are not necessarily limited to only one embodiment. Furthermore, features, structures, effects, etc. illustrated in each embodiment may be combined or modified for other embodiments by those of ordinary skill in the art to which the embodiments belong. Accordingly, the contents related to such combinations and modifications should be interpreted as being included in the scope of the invention. In addition, although the embodiment has been described above, it is only an example and does not limit the invention, and those of ordinary skill in the art to which the invention pertains are exemplified above in a range that does not depart from the essential characteristics of the present embodiment. It may be seen that various modifications and applications that have not been made are possible. For example, each component specifically shown in the embodiment may be implemented by modification. And the differences related to these modifications and applications should be construed as being included in the scope of the invention defined in the appended claims.

1. An optical system comprising:
first to seventh lenses aligned along an optical axis from an object side toward a sensor side,
wherein a refractive power of the first lens is negative,
wherein a composite refractive power of the third to seventh lenses is positive,
wherein the first lens has a shape in which both sides are concave on the optical axis,
wherein a center distance between the first lens and the second lens is greater than a center thickness of each of the first to seventh lenses,
wherein the first to seventh lenses include a plurality of spherical lenses and a plurality of aspherical lenses,
wherein each spherical lens is a lens whose object-side and sensor-side surfaces are spherical on the optical axis,
wherein each aspherical lens is a lens whose object-side and sensor-side surfaces are aspherical on the optical axis, and
wherein at least one of the plurality of aspherical lenses is made of a different material from the spherical lenses.

2. The optical system of to claim 1, wherein a number of spherical lenses is at least twice a number of aspherical lenses.

3. The optical system on claim 1, wherein at least one of the plurality of aspherical lenses is made of a same glass material as the spherical lenses, and at least one other of the plurality of aspherical lenses is made of plastic.

4. The optical system of claim 1, wherein the first to sixth lenses are made of glass, and
wherein the seventh lens is made of a plastic material.

5. The optical system of claim 4, wherein the second to sixth lenses are spherical lenses,
wherein the first and seventh lenses are the aspherical lenses, and
wherein an effective diameter of the first lens is larger than an effective diameter of each of the fourth to seventh lenses.

6. The optical system of claim 1, comprising:
an aperture stop disposed on a periphery between the second lens and the third lens.

7. The optical system of claim 1,
wherein the sensor-side surface of the fourth lens and the object-side surface of the fifth lens are bonded, and
wherein a center distance between the fourth lens and the fifth lens is 0.01 mm or less.

8. The optical system of claim 1,
wherein a center distance between an i-th lens and an i+1 lens is CGi,
wherein a center thickness of the i-th lens is CTi,
wherein a value of CTi/CGi is minimum when i is 1, and
wherein a value of CTi/CGi is maximum when i is 3.

9. The optical system of claim 1,
wherein a center distance between the first and second lenses is greater than a sum of center thicknesses of two adjacent lenses among the first to seventh lenses,
wherein an Abbe number of the first to fourth lenses is 50 or more, and
wherein a lens among the first to seventh lenses having a maximum refractive index is the fifth lens.

10. An optical system comprising:
a first lens group having lenses of a first material aligned along an optical axis from an object side toward a sensor side;
a second lens group having lenses of a second material arranged on a sensor side of the lenses of the first material and aligned along the optical axis,
wherein a number of lenses of the first material is at least twice a number of lenses of the second material,
wherein a first lens closest to the object in the first lens group has a convex object-side surface and a concave sensor-side surface,
wherein the first lens has positive refractive power,
wherein a last lens closest to an image sensor in the second lens group has a convex object-side surface and a concave sensor-side surface,
wherein the last lens has negative refractive power,
wherein the first material and the second material are different materials, and
wherein a center distance between the first lens and a second lens adjacent to the first lens is a largest among center distances between adjacent lenses.

11. The optical system of claim 10,
wherein the first material is a glass material,
wherein the second material is a plastic material,
wherein the object-side surface and the sensor-side surface of the first lens have aspherical surfaces, and
wherein an object-side surface and a sensor-side surface of each of the lenses of the second material has an aspherical surface.

12. The optical system of claim 10,
wherein a refractive index of the first lens is greater than 1.75,
wherein an optical axis distance from a center of the object-side surface of the first lens to an image surface of the image sensor is TTL,
wherein an optical axis distance from a center of the object-side surface of the last lens to the image surface of the image sensor is BFL, and
wherein the following Equation satisfies: 4<TTL/BFL<10.

13. The optical system of claim 10,
wherein an optical axis distance from a center of the object-side surface of the last lens to an image surface of the image sensor is BFL,
wherein 1/2 of a diagonal length of the image sensor is ImgH, and
wherein the following Equation satisfies: 1<BFL/ImgH<1.5.

14. The optical system of claim 10,
wherein an effective focal length of the optical system is F,
wherein an optical axis distance from a center of the object-side surface of the first lens to an image surface of the image sensor is TTL,
wherein an optical axis distance from a center of the object-side surface of the last lens to the image surface of the image sensor is BFL,
wherein the following Equation 1 satisfies: 2≤TTL/F≤3, and
wherein the following Equation 2 satisfies: 1<F/BFL<3.

15. The optical system of claim 10,
wherein the first lens group includes first to fifth lenses,
wherein the second lens group includes sixth to seventh lenses,
wherein the seventh lens is the last lens, and
wherein a focal length of the first lens is greater than a composite focal length of the second to seventh lenses.

16. The optical system of claim 15,
wherein a center thickness of the second lens is a largest among center thicknesses of the first to seventh lenses, and
wherein a center distance between the first lens and the second lens is greater than the center thickness of the second lens.

17. A camera module comprising:
an image sensor;
first to seventh lenses aligned along an optical axis from an object side toward a sensor side;
an aperture stop disposed between spherical lenses among the first to seventh lenses; and
an optical filter between the seventh lens and the image sensor,
wherein the first lens and the seventh lens are made of a same material, and a material of a lens disposed on an object side of the aperture stop and a material of a lens disposed on a sensor side of the aperture stop are different,
wherein a refractive power of the seventh lens is negative,
wherein a cemented lens is arranged between the aperture stop and the image sensor among the first to seventh lenses, in which two different lenses are bonded,
wherein a center distance between the fourth lens and the fifth lens is 0.01 mm or less, and
wherein at least one of the lenses between the cemented lens and the image sensor is an aspherical lens.

18. The optical system of claim 7,
wherein the object-side surface of the fourth lens has a convex shape on the optical axis, and
wherein the sensor-side surface of the fifth lens has a concave shape on the optical axis.

19. The optical system of claim 7,
wherein a distance between an end of an effective region of the sensor-side surface of the fourth lens and an end of an effective region of the object-side surface of the fifth lens is 0.01 mm or less.

20. The optical system of claim 18,
wherein a center thickness of the fifth lens is greater than a center thickness of the fourth lens.
